(19) United States
(12) Patent Application Publication
(10) Pub. No.: US 2005/0288986 A1
(43) Pub. Date: Dec. 29, 2005

(54) Delivery system and method for vehicles and the like

(75) Inventors: Dennis Barts, Alpharetta, GA (US); Jay Woodley, Cumming, GA (US); Keith Kimura, Rowland Height, CA (US); James Melwing, Crestwood, KY (US); Charles Sallusti, Alpharetta, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 11/023,045

(22) Filed: Dec. 23, 2004

Related U.S. Application Data
(63) Continuation of application No. 09/797,168, filed on Feb. 28, 2001, now abandoned.
(62) Division of application No. 10/650,960, filed on Aug. 27, 2003, now abandoned.
(62) Division of application No. 10/650,141, filed on Aug. 27, 2003.
(62) Division of application No. 10/650,142, filed on Aug. 27, 2003, now abandoned.
(62) Division of application No. 10/650,224, filed on Aug. 27, 2003, now abandoned.
(62) Division of application No. 10/650,244, filed on Aug. 27, 2003, now abandoned.
(60) Provisional application No. 60/185,607, filed on Feb. 29, 2000.

(51) Int. Cl. G06F 17/60

(52) U.S. Cl. 705/9; 705/8

(57) ABSTRACT

A product delivery system that moves products from manufacturing plant to destination. Particularly applicable to the delivery of vehicles from vehicle assembly plants to dealerships, the system utilizes a centralized management organization overseeing independent entities in a delivery network, and provides a management team with improved visibility of and improved tools for operating the network, such as a tracking system by which managers in many parts of the network have access to the status of individual products and network facilities, a simulation tool by which managers can test scenarios for the purpose of changing product routing plans based on predicted capacity and bottlenecks, and a planning tool that can facilitate preparation of product routing plans in response to information from the other tools. The system also uses feedback from the delivery network to influence the sequence in which the products are manufactured.

### CROSS REFERENCE TO RELATED APPLICATION

The present application is a continuation application of parent application Ser. No. 09/797,168 filed Feb. 28, 2001, divisional application Ser. No. 10/650,960 filed Aug. 27, 2003, divisional application Ser. No. 10/650,141 filed Aug. 27, 2003, divisional application Ser. No. 10/650,142 filed Aug. 27, 2003, divisional application Ser. No. 10/650,224 filed Aug. 27, 2003, and divisional application Ser. No. 10/650,244 filed Aug. 27, 2003, all of which claim the benefit and priority of Provisional Application Ser. No. 60/185,607 filed Feb. 29, 2000. The present application claims the benefit and priority of all of these application Ser. Nos. 09/797,168, 10/650,960, 10/650,141, 10/650,142, 10/650,224, 10/650,244 and 60/185,607, to the fullest extent provided by law, and incorporates by reference the contents of each application.

### TECHNICAL FIELD

The present invention relates to the logistics of delivering a product, such as a vehicle, upon release from a manufacturing plant, to a destination, and further relates to providing feedback from a delivery network to influence manufacturing processes and scheduling.

### BACKGROUND OF THE INVENTION

Worldwide production of automobiles to a level of 38 million vehicles in 1998 and beyond in subsequent years. A vehicle manufacturer must transport each of these large, heavy items from a manufacturing plant to a dealer for retail sale. Transportation of vehicles will become even more complex if Internet commerce results in substantial direct delivery from factory to a purchaser's home or place of business.

A typical known solution for vehicle transportation involves the manufacturer, one or more railroad carriers, one or more car hauler carriers, and a dealer. Generally described, vehicles begin their journey at an origin ramp at an assembly plant, where they are loaded on rail cars, travel to mixing centers, where they are unloaded and then re-loaded on rail cars, travel to destination ramps, where they are unloaded and re-loaded onto car hauler trailers, and travel to dealer locations for final unloading. The transport of each vehicle involves a unique combination of origin and destination points, modes of transport, and transit times, referred to as a “lane.” Lanes consist of a combination of segments, each of which is a portion of a lane defined by a specific origin and destination location. In the United States the delivery process may take about twelve days or longer, because of various delays and bottlenecks that can arise.

In general, delays are caused by problems with equipment and labor shortages or unavailability, damage to vehicles, accidents or breakdowns affecting carrier transports, and unreliable information about the status of vehicles moving along lanes. Individual carriers generally take responsibility for providing sufficient labor and equipment at the right places at the right times to move the large volume of vehicles. Carriers have collected and reported information from along lanes mainly for the purpose of submitting documentation to be paid for jobs completed. They have provided such information to vehicle manufacturers in varying formats via various modes of communication. When delays and bottlenecks have arisen, they have been difficult to resolve. Damaged vehicles, for example, may be difficult to locate, and payments to carriers often are delayed. Car haulers and rail carriers have not sufficiently coordinated their efforts.

Turning more specifically to practices at origin ramps at assembly plants, the manufacturer must coordinate with rail (and for nearby dealers, car hauler) carriers to obtain and load a correct number of transport devices to transport the plant's production. This is a difficult goal, because production schedules change and the manufacturer places varying numbers of vehicles exiting the production line on quality hold for varying periods of time. The information shared on the status of vehicles in production and on hold has been unreliable.

To even out deliveries to a group of dealers spread around the country, at least one manufacturer has scheduled production with this goal in mind. However, such attempts have not had a dramatic effect on delivery efficiency, and large daily fluctuations in the volume of vehicles for distribution are not uncommon.

With regard to present use of mixing centers, unloading and loading massive numbers of vehicles consumes much time. Again, carriers face the challenge of providing sufficient labor and equipment when needed without leaving loaders and rolling stock idle. Carriers have insufficient information to accurately estimate arrival times of trains or knowledge of their contents and the vehicle destinations to project labor and equipment needs. Therefore the phenomena of “dwell” occur; for example, transit dwell occurs when rail cars cannot be unloaded, and a process dwell occurs when railcars are not available to load outbound vehicles. Damaged vehicles sometimes are set aside and become “lost” at a facility because their status and location were not accurately reported. Usually, car haulers are needed to transport some vehicles to dealers within a set distance from the mixing center, adding increased complexity to the unloading, sorting, and loading process.

At destination ramps, respective employees unload railcars and load car hauler trailers with vehicles bound for dealers along their route. Here, dwell again occurs because of inaccurate projections or unavailability of labor and equipment on the part of both rail and car hauler carriers, who must coordinate their activities. Dealers sometimes put holds on vehicles, or are not available for unloading vehicles at the time of day when a car hauler can most efficiently deliver the vehicles. These situations cause vehicles to occupy space at destination ramps prior to being accepted by a dealer, extending the total delivery time.

Stated in another way, a bottleneck occurs whenever there are more vehicles at a point in the vehicle distribution network than what the resources at that point are capable of handling. These bottlenecks are what extend the transit time of vehicles to dealers. Bottlenecks occur primarily at three specific locations in the system for the following reasons:

At a manufacturing plant:
a) too many vehicles (parking constraint)
b) vehicles not loaded fast enough (resource constraint)
c) not enough empty railcars or car haulers (carrier constraint)

At a mixing center:
a) too many railcars or car haulers (mixing center constraint)
b) too many vehicles (parking constraint)
c) not enough empty railcars or car haulers (carrier constraint)
d) vehicles not loaded or unloaded fast enough (resource constraint)
e) too many railcars to unload (mixed loads vs. LTD (load to destination) railcars constraint)

At a destination ramp:
a) too many railcars or car haulers (ramp constraint)
b) vehicles not unloaded fast enough (resource constraint)
c) too many vehicles (parking constraint)

Thus, present vehicle delivery methods are cumbersome and relatively inefficient. Present procedures and levels of communication between the various participants have made it difficult to move vehicles efficiently through bottlenecks, to resolve exceptions because of unexpected problems. As a result, there has been a need for a vehicle transportation system that can move vehicles from assembly plant to dealer more quickly and reliably.

### SUMMARY OF THE INVENTION

The present invention seeks to provide a product delivery system that can move products from manufacturing plant to destination more quickly and reliably. In furtherance of this goal, the invention seeks to improve the delivery process as far upstream in the process as possible, to minimize handling of products, to bypass intermediate sites and facilities wherever possible, and to move products in larger volumes or batches. These goals apply particularly to the application of the invention to the delivery of vehicles from vehicle assembly plants to dealerships.

The present invention accomplishes these objects by providing improved visibility of and improved tools for operating a delivery network to a centralized management organization overseeing a number of separate parts of the network. In one aspect, the invention relates to delivery of products upon release of the products from the plant in which they are manufactured. In another aspect, the invention relates to influencing the sequence in which the products are manufactured in response to conditions and capacities within the delivery network.

One tool preferably utilized in the present invention is a tracking system by which managers in many parts of the network have access to the status of individual products and network facilities. Another tool preferably utilized in the present invention is a simulation tool by which managers can model the network and test scenarios for the purpose of changing product routing plans based on predicted capacity and bottlenecks. Another tool preferably utilized in the present invention is a planning tool that can facilitate preparation of product routing plans in response to status information from the tracking system and analyses produced by the simulation tool.

Generally described, one embodiment of the present provides a system and method for facilitating delivery of manufactured items from a manufacturing facility to customers via a delivery network, utilizing: (1) one or more databases, including:
(a) in transit information describing a location and status of items in the delivery network being delivered from the manufacturing facility to a destination;
(b) network facility information including identification and capacity of a plurality of network facility points, including origin points, mixing center points, termination points, customer facility points;
(c) carrier information describing capacity, location and status of network transport devices and transport operators;
(d) routing information describing transportation routes within the delivery network, capacity of the routes, and cost of delivery of items along the routes;
(e) a delivery plan including routes for items and planned times for shipment and delivery of items to points along routes;
(f) measured transit time information including actual times taken for movement of items between points in the network; and
   (2) access to the one or more databases from one or more of the network facility points; and the capability to download from one or more of the databases information useful in carrying out a delivery plan implemented via the delivery network. In a preferred option, remote access units are configured to upload to one or more of the databases information for updating the in transit information, the network facility information, and/or the carrier information. Preferably, one or more of the databases includes manufacturing information identifying items to be completed over a known period of time; and the access units are configured to upload to one or more of the databases information for updating the manufacturing information. The access units may be configured to upload to one or more of the databases information for updating the route information, the measured transit time information, and the delivery plan. In one preferred option, the system and method utilize a simulation tool operative to predict performance of alternate delivery plans based on the information stored in the one or more databases.

According to another of its aspects, the present invention provides a method of transporting vehicles from a manufacturing plant to a plurality of destination locations via a delivery network, comprising transporting by rail at least some of a plurality of vehicles released from a manufacturing plant origin point to a mixing center; consolidating vehicles bound for a common destination location at the mixing center; transporting the consolidated vehicles to the common destination location; using a simulation tool to model a delivery network including the manufacturing plant origin point, the mixing center, the destination location, and transport devices and to predict occurrence of delays at the mixing center; and in response to prediction of a delay at the mixing center, planning and executing a routing plan that transports at least some of the vehicles directly from a first point in the delivery network upstream of the mixing center to a second point in the delivery network downstream of the mixing center so as to bypass the mixing center and reduce the predicted delay. In one implementation, the routing plan may transport vehicles from the manufacturing plant origin point directly to the destination location, preferably by car hauler.

According to another of its aspects, the present invention provides a method of transporting vehicles from a manufacturing plant to a plurality of destination ramps via a delivery network, comprising transporting by rail at least some of a plurality of vehicles released from a manufacturing plant origin point to a mixing center; consolidating vehicles bound for a common destination ramp at the mixing center; transporting the consolidated vehicles to the common destination ramp; transporting the consolidated vehicles by car hauler in groups to a plurality of dealerships; using a simulation tool, modeling a delivery network including the manufacturing plant origin point, the mixing center, the destination ramp, the plurality of dealerships, and transport devices and predicting occurrence of delays at the destination ramp; and in response to prediction of a delay at the destination ramp, planning and executing a routing plan that transports at least some of the vehicles directly from a point in the delivery network upstream of the destination ramp to one or more of the dealerships so as to bypass the destination ramp and reduce the predicted delay. In particular implementations, the routing plan transports vehicles from the manufacturing plant origin point directly to one or more of the dealerships, or transports vehicles from the mixing center directly to one or more of the dealerships, preferably by car hauler.

According to another of its aspects, the present invention provides a method of transporting vehicles from a manufacturing plant to a plurality of destination ramps via a delivery network, comprising transporting by railcar at least some of a plurality of vehicles released from a manufacturing plant origin point to a mixing center, utilizing a first group of railcars each carrying unmixed vehicles bound for a respective common destination ramp, and a second group of railcars carrying mixed vehicles bound for more than one destination ramp; unloading the second group of railcars at the mixing center; consolidating the unloaded vehicles onto a third group of railcars each carrying unmixed vehicles bound for a respective common destination ramp; transporting the first and third groups of railcars from the mixing center to the respective common destination ramps; using a simulation tool, modeling a delivery network including the manufacturing plant origin point, the mixing center, the destination ramp, and transport devices and predicting occurrence of delays at the mixing center; and in response to prediction of a delay at the destination ramp, planning and executing a routing plan that diverts at least some of the mixed vehicles at the manufacturing plant origin point to car haulers for transport directly to a point in the delivery network downstream of the mixing center. In particular implementations, the downstream point in the delivery network comprises a respective destination ramp, or the delivery network may comprise a plurality of dealerships, and, in response said prediction of a delay at the destination ramp, the method may divert at least some of the mixed vehicles at the manufacturing plant origin point to unmixed car haulers for transport directly to respective dealerships.

According to another of its aspects, the present invention provides a method of operating a delivery network for transporting vehicles from a plurality of manufacturing plants to a plurality of destination locations, comprising establishing a relationship with a plurality of independent entities, the plurality of entities providing a continuous delivery network from the manufacturing plants to the destination locations; providing at least partial management of each of the plurality of delivery network the companies by the use of delivery network managers having a primary allegiance to a delivery network management company; providing a delivery information network for use by the delivery network managers; providing the delivery network managers with access to information via the delivery information network; and in response to the information provided, directing activities of employees of the plurality of independent entities to facilitate delivery of the vehicles from the manufacturing plants, along the continuous delivery network, and to the destination locations. Preferably the delivery network managers also have the ability to remotely update the delivery information network and to communicate with one another. The independent entities may include vehicle manufacturers, rail carriers, car hauler carriers, load or unload contractors, and/or dealers.

According to another of its aspects, the present invention provides a method of scheduling, manufacturing, and shipping items via a delivery network, comprising assembling a set of parts needed to make a predetermined number of items in a predetermined order; providing a delivery network comprising a plurality of network facility points, including one or more origin points and mixing center points, and a plurality of termination points; inserting the items as they are made into the delivery network; monitoring activity at the network facility points; projecting relative congestion along a plurality of routes through the delivery network based on the monitored activity in the network and the destinations of the items to be made; and responsive to the projected relative congestion in the delivery network, altering one or both of the assembled set of parts and the predetermined order of making the items, so as to cause the items to enter the delivery network in an order calculated to improve efficiency of delivery. In a preferred implementation, the alteration includes ordering production from the assembled set of parts of items going to the same termination point in sequential order, to facilitate direct loading from assembly line to transport device.

Furthermore, the invention provides a method of scheduling, manufacturing, and shipping items via a delivery network, comprising providing a delivery network comprising a plurality of network facility points, including one or more origin points and mixing center points, and a plurality of termination points; assembling a set of parts needed to make a predetermined number of items; ordering production from the assembled set of parts so as to manufacture items going to the same termination point in sequential order; and inserting the items as they are made into the delivery network. The network may also include customer facility points, each of the items having a delivery destination at one of the customer facility points

More specifically described, a preferred embodiment of one aspect of the invention provides a method and system of the present invention relate in one embodiment to the transportation of vehicles from a plurality of vehicle manufacturing plants to a plurality of vehicle dealer locations. In one embodiment, this invention comprises manufacturing the vehicles at each of the manufacturing plants in a sequence based on the destinations of the vehicles. The invention also comprises notifying rail and car hauler carriers of a manufacturing productions schedule, which takes into account the above mentioned sequence. The invention also involves associating sets of the manufacturing plants into plant groups, and providing a plurality of parent mixing centers, each receiving vehicles from a plurality of the plant groups, which are associated exclusively with one parent mixing center. A plurality of rail car loads of vehicles (bound for a single destination, within a first time window) are released from one or more of the plant groups sharing a parent mixing center. The rail car loads are transported to the shared parent mixing center associated with each of the plant groups if the destination is farther than a selected distance from a final loading location of the plant group; In this embodiment, the present invention also provides for a system for simulating the best routes for vehicles released from all the manufacturing plants in the first time window, based on available rail transport and production schedules of all the manufacturing plants. At the shared parent mixing center, this embodiment of the invention combines the rail car loads with rail car loads from other plant groups, bound for the same destination; and then allows for the transporting of the trains to remote mixing centers, where there is further assembling of trains according to the simulated best routes. The invention also allows for the bypassing of remote mixing centers when a full train has been assembled.

The invention further provides for the transportation of the trains to destination ramps; the transferring of the vehicles to car hauler trailers; and the transporting of the car hauler trailer to a dealer location and unloading the vehicles.

Another aspect of this embodiment of the invention is the ability to track each vehicle. This is accomplished by, for example, marking each vehicle with a machine readable vehicle code (the marking can involve, for example, affixing adhesive material with bar-coded information, or it can, for example, be a permanent identification mark that is put on the vehicle). The system provides for:
the scanning of each vehicle code as a vehicle is loaded onto a rail car;
the marking of the rail cars loads with a machine-readable rail car code, and storing the vehicle codes of each load in association with the rail car code;
scanning the rail car code on arrival at the parent mixing center;
scanning the rail car code on departure from the parent mixing center;
scanning the rail car code on departure from the remote mixing center;
scanning the rail car code on arrival at a remote mixing center;
the scanning of the rail car code on arrival at a destination ramp;
the scanning of the vehicle codes as the vehicles are loaded onto a car hauler trailer;
the scanning of the vehicle codes on arrival at the dealer location.

On each of the scans mentioned above, the system enables the sending of the scanned vehicle or rail car codes to a central computer, where they can be used to track the vehicles, and for other logistical purposes.

Also, in this embodiment there is provided a management team independent of the rail and car hauler carriers. The management team is capable of accessing the central computer to monitor the location of each manufactured vehicle at any time, monitoring the performance of the carriers in delivering vehicles to predetermined destinations within preset time limits, and alerting the carriers if a vehicle is behind schedule. The management team also possesses the ability to provide alternate transport for vehicles that are behind schedule.

In somewhat more detail, according to one preferred embodiment, the system of the invention is designed to provide vehicles from a manufacturing plant to a dealer facility reliably within a set number of days. The system establishes a transportation network that is coordinated with vehicle assembly in the manufacturing plant. A goal is to assemble and load vehicles onto rail cars and car hauler trailers in blocks going to the same destination, in order to minimize the handling of the vehicles and to maximize bypassing of handling and sorting facilities whenever possible.

At the manufacturing plant associated with this embodiment, vehicles are assembled according to a “geographic build principle.” Geographic build has several possible implementations, as described below. The purpose is to improve vehicle transit time and delivery predictability by aligning the plant production sequence by geographic region. This alignment allows the vehicle delivery network to improve efficiencies through better equipment utilization and reduced rail switching which provides improved cycle times. Assembly plants also improve rail loading practices through simplified load make-up requirements. Geographic build increases railcar utilization and train length, increases the number of unit trains to improve velocity and reduce switching time and dwell time at interchange points, improves arrival predictability, helps prevent vehicle storage, reduces the number of loading destinations, reduces load makeup time, and reduces plant dwell due to partial loads.

In one implementation of geographic build, vehicles are assembled in groups going to the same destination. The manufacturer coordinates just in time delivery of parts for the vehicles in accordance with the schedule to optimally feed vehicles into the transportation network. The plant also works to release the vehicles for transportation as soon as they are complete, and the vehicles are loaded and transported immediately. Origin automotive manufacturing plants are consolidated into groups that feed an assigned “parent mixing center.” In the past, multiple manufacturing plants have sent vehicles to several mixing centers, at which all the vehicles were unloaded and re-mixed after sorting according to destination. The present system moves the sorting process as far upstream as possible, including the scheduling of vehicle assembly, as noted above. Whenever possible, rail cars are filled at the assembly plant with vehicles bound for a single destination ramp. Thus, in one typical scenario the vehicles are moved from the assembly plant by rail car or car hauler to a mixing center where full rail cars are consolidated with others and car hauler loads are loaded onto rail cars. The rail cars take the vehicles to a destination ramp, at which the vehicles are unloaded onto car haulers for transport to dealerships. However, the system bypasses mixing centers whenever possible, for example, by sending car hauler loads directly to dealerships from the vehicle assembly plant, or by forming complete trains at a manufacturing plant and sending them to a destination ramp. The need for unloading vehicles for the purpose of sorting them is minimized. This is facilitated by providing high volumes of vehicles bound for the same destination at the same time from an origin group of manufacturing plants. The result is a sufficient volume of such vehicles to build trains that the railroads will handle at a reasonable cost.

The transportation network uses simulation programs to determine the best way to load car haulers and rail cars and to build trains based upon the assembled vehicles that will be available and their destinations. The simulations will be used not only for production planning, but also to optimize transportation in the event of exceptional circumstances, such as a need to adjust planned loads when a group of assembled vehicles must be held to correct a defect.

A part of the system is the ability to track each assembled vehicle throughout the transportation network. The concept is called “full visibility.” The vehicle identification number of each assembled vehicle is entered into the system at the assembly plant, and associated with each car hauler or rail car in which that vehicle is loaded. Whenever the car hauler or rail car is scanned, the location of each vehicle is updated in the system memory. The system provides accurate advance notification to carriers (car haulers and railroads) so that they are able to provide transportation resources in a timely manner. The location information is also compared to the planned schedule for each vehicle, and an alert or alarm is provided if a vehicle has fallen off schedule. In pre-identified situations, the system will automatically re-route a particular vehicle or change its method of transportation to overcome a difficulty.

The system also provides management of the transportation network by personnel at various facilities in the network. These personnel in the field will manage the carriers actively to assure that they meet their commitments. The network managers will observe network activity based on information from the car tracking system, respond to off-schedule alarms which impact their facility or will impact another facility, and notify other network managers and carriers of problems and how to respond to overcome the problems. They will also work with the carriers on load planning and the timing of shipments. They will be responsible for proper loading of rail cars and car haulers, for carrier timeliness, and for assuring that vehicles are placed in the correct loads and reach the correct destination. The car tracking system will allow these managers to determine the status of every vehicle at all times.

The system requires dealers to be flexible in their availability for receiving car haulers with loads for their dealership. An object of the system is to make delivery to dealers more efficient by unloading car haulers at any time on a seven day, twenty-four hour basis, while at the same time notifying dealers in advance of a precise delivery time, so that the dealer can be ready to receive the vehicles without having to have personnel on site at all times. For example, the dealer may be notified via the network or by e-mail that a shipment will arrive on a certain date between 7:00 and 9:00 am. The system allows prediction of the delivery time with accuracy, and the dealer is responsible for having personnel present to receive the vehicles.

Thus, the present invention is capable of optimizing a vehicle distribution network. A system according to the invention can transport new vehicles produced at many manufacturing plants to a large number of dealers nationwide. As dealers place orders for vehicles, the orders go directly to the manufacturing plant that produces the particular vehicle ordered. The vehicle is produced, then shipped to the dealer as fast as possible. The preferred modes of transportation used are railcars and car haulers. The delivery network is a type of “hub and spoke” network with mixing centers located at strategic points in the U.S. for consolidating vehicles into railcars arriving from the manufacturing plants and creating direct shipments to destination ramps in other parts of the country.

All vehicles are identified by a unique “vehicle identification number” or “VIN.” In accordance with common practice, a uniquely identified vehicle will sometimes be referred to below as a VIN.

Other features and advantages of the present invention will become apparent to one skilled in the art upon examination of the following drawings and detailed description. It is intended that all such features and advantages be included herein within the scope of the present invention as defined by the appended claims.

### BRIEF DESCRIPTION OF THE DRAWINGS

FIG. 1 a schematic diagram of a vehicle delivery system 10 according to the present invention.

FIG. 2 is a diagrammatic representation of the vehicle distribution network.

FIG. 3 is a geographical map showing a portion of a distribution network.

FIG. 4 is a geographical map showing vehicle transport outbound from the mixing centers.

FIG. 5 is a diagram of the basic vehicle flow through the distribution network.

FIG. 6 is a diagrammatic representation of a consolidation hub.

FIG. 7 is a diagrammatic representation of the data flow network.

FIG. 8 is a further concept diagram of the data flow network.

FIG. 9 is a diagrammatic data flow diagram showing that how shipper data (such as from rail carrier data sources 54 and car hauler data sources 56 can be sent to become part of the manufacturer's data 52, to then be passed along to the vehicle tracking system 34, or in the alternative how the shipper data could be routed directly to the tracking system 34 without going through the manufacturer's system. It may be understood that in the alternative version, a record may be created by the carrier that links the vehicles (e.g., through VINs) to the delivery vehicles (e.g., train cars), and this linking records can be sent to the system 34.

It should also be understood that the railcars could be tracked via conventional railcar tracking systems and such information could also be used to better pinpoint vehicle locations.

FIG. 10 is a diagrammatic process diagram showing how the tracking database 50 of the vehicle tracking system 34 is updated by use of user-added data such as hold instructions, as well as manufacturer data passed from the data communications interface 40.

FIG. 11 is a screen navigation chart 1011.

FIG. 12 is a diagrammatic view 1012 showing connectivity between the user at 42 and redundant systems which may used to run redundant tracking applications if desired.

FIG. 13 is a tracking system entity relationship diagram 1013.

FIG. 14 is a object class hierarchy 1014 of the tracking system 34 software application.

FIG. 15 is a object class hierarchy 1015 of the tracking system 34 software application.

FIG. 16 is a screen shot 1016 of viewable items—Dealers, Ramps and Lanes.

FIG. 17 is a screen show of a status report 1017.

FIG. 18 is a screen navigation flow diagram 1018.

FIG. 19 is a screen shot 1019 of a Dealer View.

FIG. 20 is a screen shot 1020 of a Unit View (a.k.a., Model Summary).

FIG. 21 is a screen shot 1021 of a Vehicle Summary.

FIG. 22 is a screen shot 1022 of a dealer view, status details.

FIG. 23 is a screen shot 1023 of a dealer view, status details, insert hold event screen 1.

FIG. 24 is a screen shot 1024 of a dealer view, status details, insert hold event screen 2.

FIG. 25 is a screen shot 1025 of a search screen.

FIG. 26 is a screen shot 1026 which shows search results.

FIG. 27 is a screen shot 1027 showing Vehicle Detail.

FIG. 28 is a screen shot 1028 showing a Ramp View.

FIG. 29 is a screen shot 1029 showing a unit breakdown (Model Summary) in ramp view.

FIG. 30 is a screen shot 1030 of a Vehicle Summary in ramp view.

FIG. 31 is a screen shot 1031 of a lane view.

FIG. 32 is a screen shot 1032 of a unit breakdown in lane view.

FIG. 33 is a screen shot 1033 of a Vehicle Summary in lane view.

FIG. 34 is a screen shot 1034 of a lane view, status detailed.

FIG. 35 is a screen shot 1035 showing viewable items.

FIG. 36 is a screen shot 1036 showing a Dealer View.

FIG. 37 is a screen shot 1037 showing a Model Summary.

FIG. 38 is a screen shot 1038 showing a Vehicle Summary.

FIG. 39 is a screen shot 1039 showing Status Details.

FIG. 40 is a screen shot 1040 showing Railcar Summary.

FIG. 41 is a screen shot 1041 showing Ramp Summary

FIG. 42 is a screen shot 1042 showing Vehicle Summary.

FIG. 43 is a screen shot 1043 showing Status Details.

FIG. 44 is a screen shot 1044 showing Vehicle Detail.

FIGS. 45-54 relate to management structures. FIG. 45 is a management flow chart showing how the management team 31 provides a “management layer” over (although not necessarily directly supervising) various other entities which may not necessarily be employed by, paid, or salaried employees of the management team 31. These entities include but are not necessarily limited to manufacturer's personnel 33, vehicle loading/unloading contractors 35, car hauler personnel 37 (who operate car haulers 28), rail carrier personnel 41 (who operate trains 23), and dealers 29. It should be understood that the car hauler personnel 37 and rail carrier personnel 41 could be referenced generically herein as “carrier” personnel. It should also be understood that preferably this management is done via contact with the management structure of the above entities. However, it should be understood that the activities and results of those being managed (e.g. hourly workers) will be monitored as many of the management team will be on site.

FIG. 55 is a diagram of inputs to and outputs from the planning tool.

FIG. 56 is a diagram of vehicle flow in the distribution network following operation of the planning tool.

FIG. 57 is a flow diagram for an automated planning process.

FIG. 58 is a diagram of the contents of the routing plan database.

FIG. 59 is a diagram of a daily routing process.

FIG. 60 is a diagram of transit event descriptions and the entities associated with the events in the distribution network.

FIG. 61 is a diagram of vehicle flow for transporting vehicles on LTD railcars from a manufacturing plant to a mixing center.

FIG. 62 is a diagram of vehicle flow for transporting vehicles initially on car haulers from a car plant to a destination ramp via two mixing centers.

FIG. 63 is a diagram of vehicle flow for transporting vehicles from the mixing center to a destination ramp and dealer.

FIG. 64 is a diagram of vehicle flow for transporting vehicles on mix railcars from a manufacturing plant to a mixing center.

FIG. 65 is a diagram of vehicle flow for direct delivery from origin plant to dealer by car hauler.

### DETAILED DESCRIPTION OF PREFERRED EMBODIMENTS

System Overview

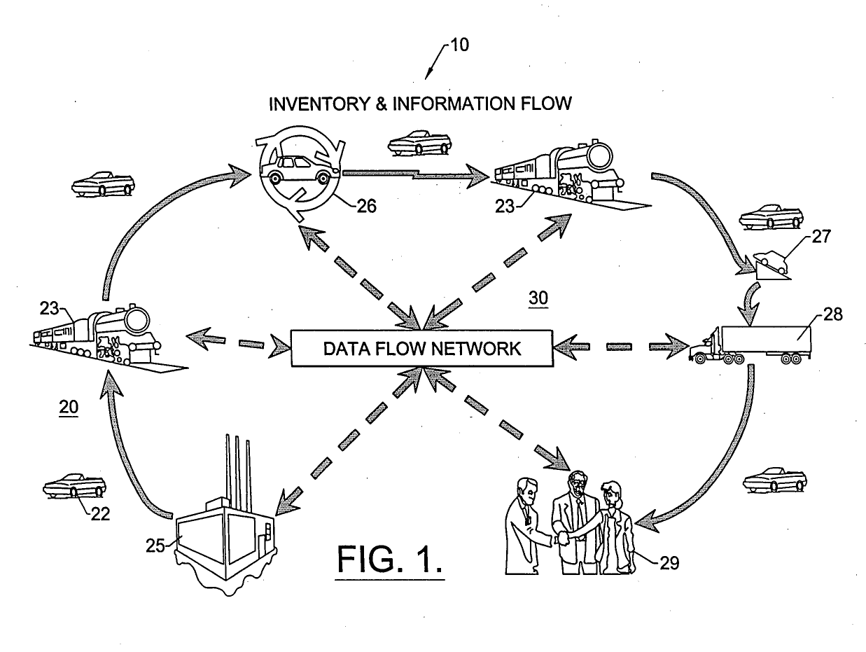

Referring now in more detail to the drawings, in which like numerals refer to like elements throughout the several views, FIG. 1 shows a schematic diagram of a vehicle delivery system 10 according to the present invention. The delivery system 10 includes generally a vehicle distribution network 20, which includes various physical facilities described below for transporting vehicles, and an data flow network 30, which includes various data processing, storage, user interface, and software components that are also described below. The distribution network 20, conceptually shown in FIG. 1, provides for the transport of vehicles 22 by trains 23 of railcars from an origin point 25, such as a manufacturing plant or accumulation hub, to a mixing center 26, where personnel unload and sort the vehicles if necessary. Railroad personnel then load the vehicles onto railcars and build trains 23 to transport the vehicles to destination ramps 27, where personnel unload the vehicles. Others at the destination ramps 27 load the vehicles onto car haulers 28 for transport to automobile dealerships 29. FIG. 1 shows the data flow network 30 conceptually as a system for collecting information from each of a plurality of facility points of the distribution network, and for providing information to each of those points. The flow of information is shown in dashed lines.

On a very generic level, the facilities and basic functions of the distribution network 20 are well known. That is, distribution networks including mixing centers and transport by rail and car hauler existed prior to the present invention. The vehicle delivery system 10 of the present invention improves upon prior distribution networks by providing a more efficient structure as well as comprehensive information describing the status of the network, allowing the network to be operated in an efficient and flexible manner to deliver vehicles faster. The network as described below minimizes the handling of vehicles, maximizes the bypassing of intermediate sites and facilities, and assembles large volumes of vehicles having similar destinations for speedier transport. A team of managers, members of which work at each point of the network, coordinate each operation from initial loading at origin plants to final transfers at destination ramps or dealerships. This team manages the efforts of manufacturers, individual carriers and dealers.

It should be understood that the delivery system described herein is not restricted to delivery of items from their place of manufacture, nor to any particular source of goods or type of goods. Without limiting the scope of the claims, examples of application of the present system are to distribute rental cars, to distribute raw paper from paper manufacturers to factories where the paper is used, and transportation of in-bound parts from parts manufacturers to factories where the parts are incorporated into other products. Of course, the invention is not limited to any type of destination for the items being transported. Any reference herein to particular companies, products or places is by way of example only, and not a limitation on the scope of the claims.

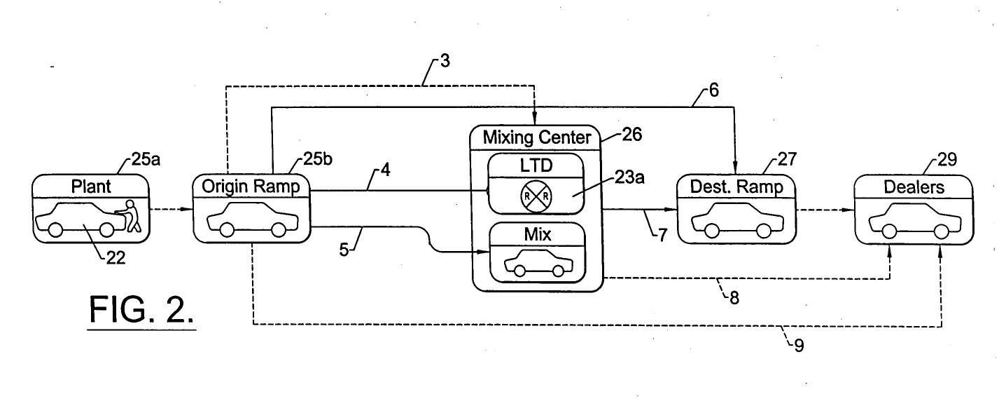

A diagrammatic representation of the vehicle distribution network is shown in FIG. 2. At the origin point 25, a vehicle 22 is manufactured at a plant 25a and released to an origin ramp 25b for loading. FIG. 2 shows multiple possible initial lane segments for the vehicle 22. Segment 3 represents car hauler transportation to a mixing center 26. Segment 4 represents “LTD” (load to destination ramp) railcar 23a transport to the mixing center for attachment (without unloading) to a train bound for a destination ramp 27. LTD railcars contain vehicles bound for the same destination ramp. Segment 5 represents “mix” (mixed vehicle destinations) railcar 23b transport to the mixing center for unloading, sorting, loading with other vehicles bound for the same destination ramp, and attachment to a train bound for the destination ramp 27. Segment 6 represents a train of railcars proceeding directly from the origin ramp 25b to the destination ramp 27. One or more additional rail or car hauler lane segments 7 are traversed between the mixing center 26 and the destination ramp 27, from which the vehicle is transported to a dealer 20 by car hauler. Some vehicles may have one car hauler lane segment 8 between the mixing center and the dealer. Segment 9 represents car hauler transport directly from the origin ramp to a dealer 29.

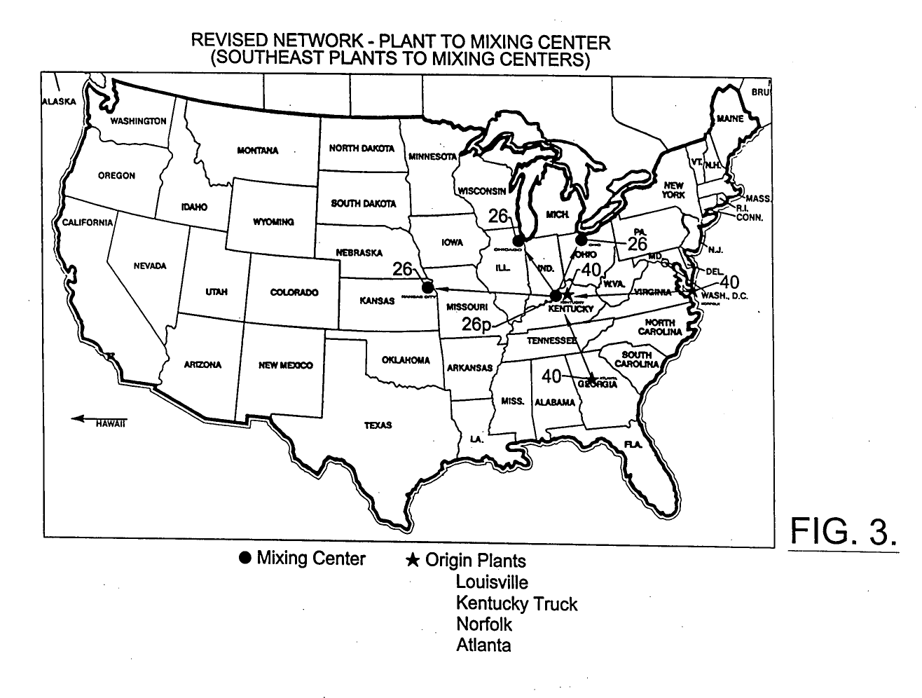

FIG. 3 represents a geographical map showing a portion of an example of a distribution network 20 utilizing the present invention, showing how vehicles move from origin points 25, in this case groups of manufacturing plants, to a mixing center 26. Each origin manufacturing plant sends it manufactured vehicles to one “parent” mixing center 26p. In the example shown, a set of Southeastern U.S. plants in Louisville, Ky., Norfolk, Va., and Atlanta, Ga. route vehicles produced to the mixing center 26p at Shelbyville, Ky. by rail. From Shelbyville, trains of vehicles may pass through other mixing centers 26 at Fostoria, Ohio, Kansas City, Kans., or Chicago, Ill., where the railcars may be attached to other trains if necessary. The arrows represent rail routes from the origin plant groupings to the parent mixing center, and on to other mixing centers.

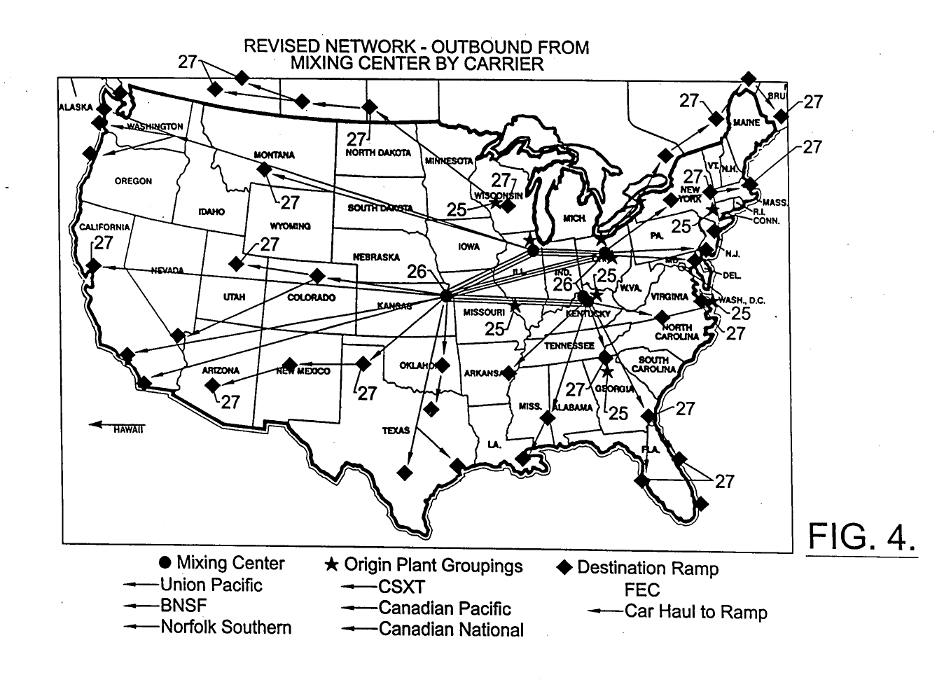

FIG. 4 represents vehicle transport outbound from the mixing centers 26 of the network 20 for the example of FIG. 3. The arrows represent rail routes from the mixing centers to a large number of destination ramps 27. As shown, trains may stop at intermediate destination ramps to drop rail cars, or split at a destination ramp so that the resulting trains can take different routes to more distant destination ramps.

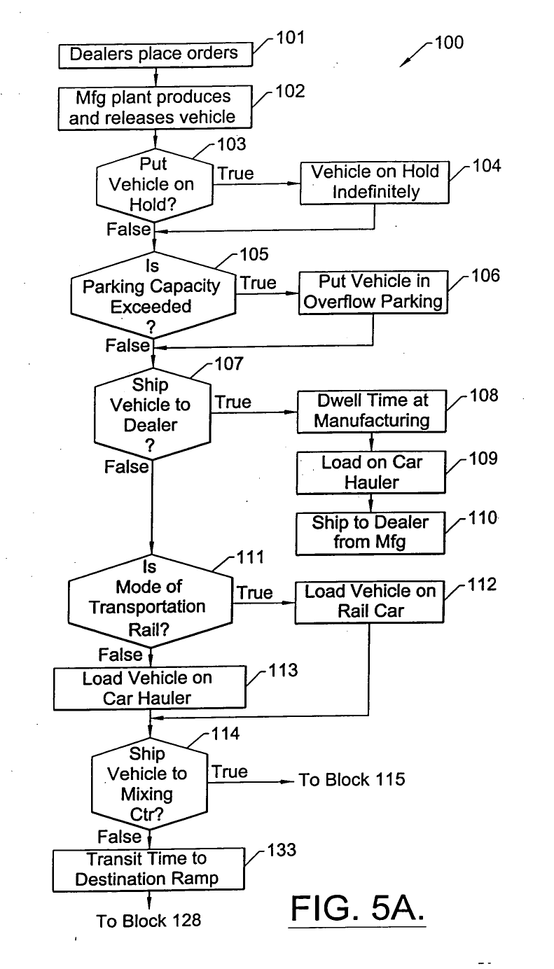

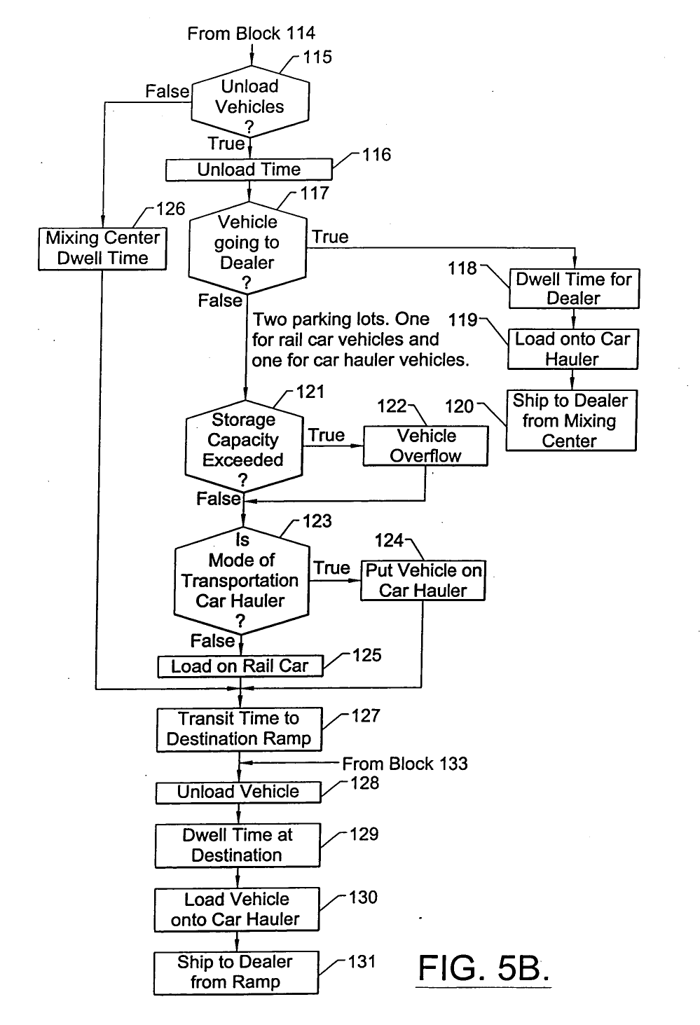

FIG. 5 is a diagram of the basic vehicle flow 100 through the distribution network 20. The process begins at block 101, when dealers place orders for vehicles. At block 102, a manufacturing plant 25 produces and releases a vehicle, which may be put on hold, such as a quality defect hold delaying transportation of the vehicle. An inquiry whether the vehicle is being held is made at block 103. If so, the vehicle will be held for an indefinite time at block 104 until the quality or other problem is resolved. The released vehicles are placed in a lot pending transport. If it is determined at block 105 that the lot's parking capacity is exceeded, the vehicle is moved into an overflow parking lot at block 106. At block 107, it is determined whether the vehicle will be shipped directly to a nearby dealer or to a long distance destination. If to a nearby dealer, the vehicle is loaded at block 109, after a dwell time at the manufacturing plant represented by block 108, onto a car hauler 28, which transports the vehicle to the dealer for unloading at block 110.

If the vehicle must travel a multi-segment lane, then at block 111 it is determined if the mode of transport will be by train 23. If so, it is loaded onto a rail car at block 112. If not, it is loaded onto a car hauler 28 at block 113. At block 114 it is determined whether the transport device is bound for a mixing center 26. If so, the vehicle is transported over a transit time represented by block 114 to a mixing center 26. At block 115, it is determined whether, in the case of rail transport, the vehicle's railcar must be unloaded, or whether it will bypass the mixing center. If unloading is required for one of the vehicles on the railcar, the railcar will be unloaded entirely over a time represented by block 116. Then at block 117 it is determined whether the vehicle is bound for a dealer near the mixing center. If so, at block 119 the vehicle is loaded, after a dwell time in a car hauler parking lot at the mixing center represented by block 118, onto a car hauler 28, which transports the vehicle to the dealer for unloading at block 120.

If the vehicle does not fit in the main parking lot for another intermediate lane segment, as determined at block 121, the vehicle is parked in an overflow lot at 122. From either the main or overflow lot, the vehicle's mode of transport is determined at block 123. If the vehicle will travel the next lane segment by car hauler, then it is loaded on a car hauler at block 124. If the vehicle will travel the next lane segment by rail, then it is loaded on a railcar at block 124. In both cases (and in the case of a vehicle on a railcar that was not unloaded following a mixing center dwell time represented by block 126), the vehicle is transported to a destination ramp 27 over a transit time represented by block 127. The vehicle is unloaded from its transport device at block 128. After a dwell time represented by block 129, the vehicle is loaded at block 130 onto a car hauler 28, which transports the vehicle to the dealer 29 for unloading at block 131.

Returning to the determination at block 114, if the transport (car hauler or railcar) is bound directly to the destination ramp 27, then the vehicle is transported to the destination ramp over a transit time represented by block 133. The process then proceeds to block 128 and continues as described above until the vehicle is unloaded at the dealer.

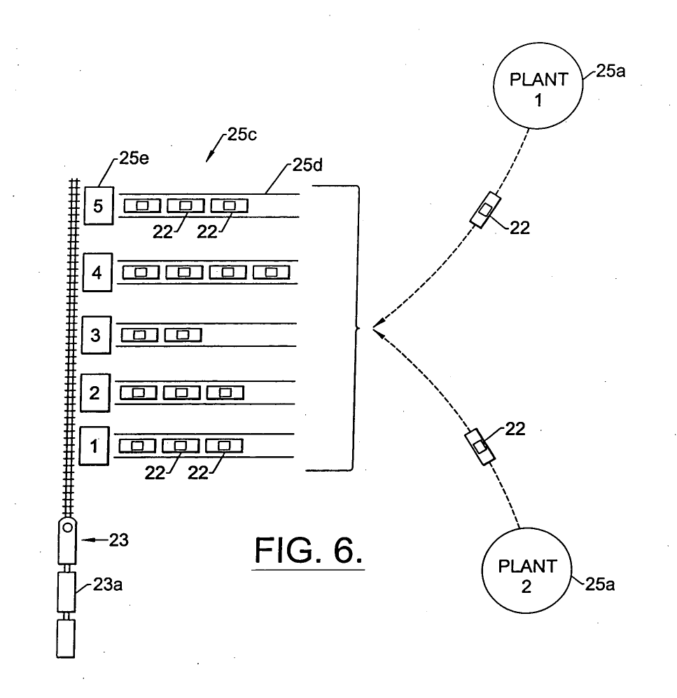

An optional consolidation hub 25c associated with the origin point 25 is shown in FIG. 6. In this embodiment, the vehicles produced at a grouping of nearby origin plants 25a are driven or transported by car hauler to the hub 25c rather than being loaded on railcars at the individual plants. On arriving at the hub 25c, the vehicles are presorted into lines 25d according to destination point for the initial segment of the vehicle's delivery lane. Each line 25d leads to a railcar loading dock 25e, from which the vehicles in the line will be loaded onto the railcars of a train 23. As a result of the presorting, most of the railcars leaving the consolidation hub 25c will be LTD railcars 23a.

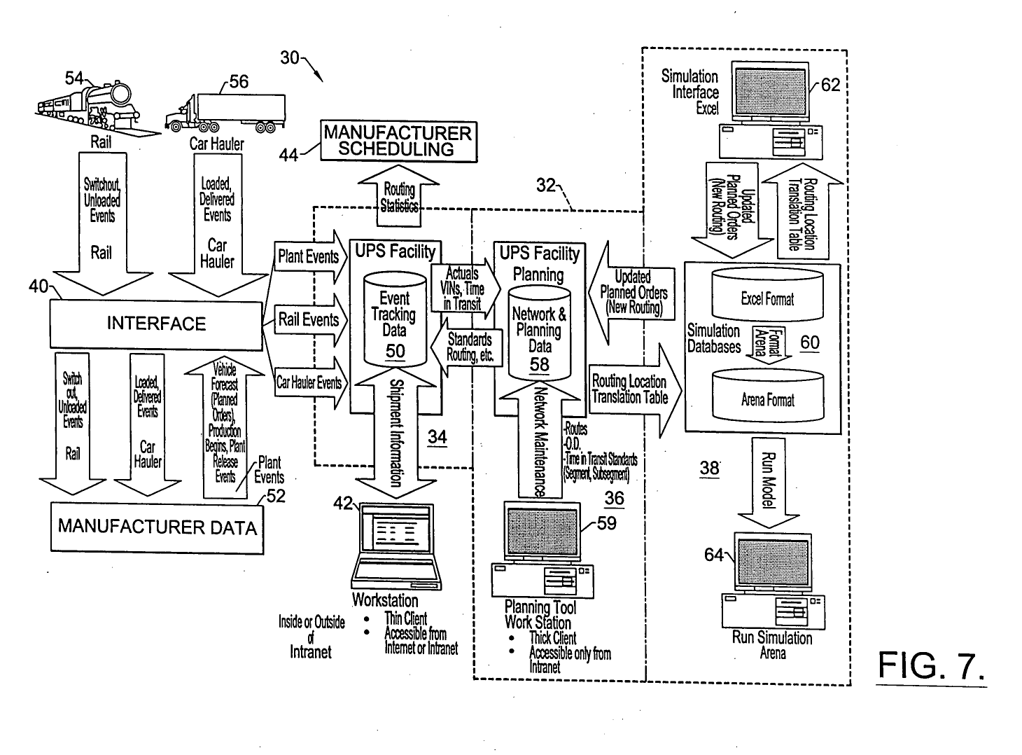

The data flow network 30 is shown diagrammatically in FIG. 7. An intranet 32, shown as surrounded by a plain dashed line, is maintained by a network management team 31 (see Fig. A31), which preferably is the same entity that employs the team of managers noted above. The intranet 32 includes a tracking system component 34, a planning tool component 36, and a simulation tool component 38. The intranet 32 receives input data from various external sources (described below) via a data communications interface 40, which may be, for example, an electronic mailbox.

Components within the intranet send output data to a plurality of workstations 42, which may be a “thin client” accessible from the intranet or from the Internet. The workstations 42 may be portable computers used by members of the team of managers at any of the network facility points. Remote connection can be a dial-up modem connection, or via the Internet. Components within the intranet also send output data to a manufacturer's production scheduling system 44. As explained below, in a preferred embodiment of the vehicle delivery system 10, feedback of information from the distribution network 20 and the data flow network 30 is used to schedule production of vehicles to produce level distribution of the product as it enters the delivery network, and to respond to output requirements of the transportation of the vehicles to market. This principle, referred to herein as “geographic build,” reduces or eliminates large daily fluctuations in distribution which can occur in the first stages of the distribution network. Level distribution evens out the demand for staffing, equipment, and power in the distribution network.

In alternative configurations, any appropriate external communications system may be utilized for input to and output from the intranet 32; for example: electronic mail, the Internet, an extranet, dial-up modem connection, or a private data communications network.

The tracking system 34 includes a tracking database 50 containing status information on all aspects of the distribution network 20, and related software. This status information is received via the interface 40, from three main sources: vehicle manufacturers data 52, including production schedules, when actual production of a VIN begins, and when each VIN is released; railroad data sources 54, including scanners for reading encoded symbols on VINs and railcars, and terminals for manually sending information on the time planned events and unplanned disruptions occur; and car hauler data sources 56, similar to the railroad data sources. The tracking system also receives VIN routing information from the planning tool 36. The purpose of the tracking system 34 is to provide full visibility of the status of the distribution network to the management team, to assist the manufacturers with geographic build efforts, and to provide status and statistical information needed by the planning tool 36 and the simulation tool 38.

The planning tool 36 includes a planning database 58 containing data received from the tracking database 50, from the simulation tool 38, and from a work station 59, and related software. The tracking system provides actual collected data on VIN status and elapsed transit times. The simulation tool provides routing evaluations for upcoming planned VINs. The workstation 59 allows a user to select routes for upcoming VINs and to input origin and destination information as well as time in transit standards. This information is available to the management team through the tracking system, which receives routes, standards, and the like from the planning database 58.

The simulation tool 38 provides an operational/strategic planning tool that will allow the system and its managers to analyze the vehicle distribution network 20 each day as well as look out a number of days into the future to determine if bottlenecks will appear in the network and where they will occur. In addition, this tool provides the ability to test changes to the existing vehicle distribution network “off-line” to determine what changes should be made to the network and the impact of making those changes. The simulation tool 38 includes a simulation database 60 stored in two formats, a format unique to the simulation engine being used, such as Arena. and a spreadsheet format, such as Microsoft Excel format. The simulation database contains input data needed to run the simulation engine being used, obtained from the tracking database 34 via the planning tool 36, and from users via an Excel interface 62, which can be used to modify the delivery network parameters to study the effect of modifications on the efficiency of the delivery network. Simulations are run on a simulation workstation 64 on which the simulation program is loaded. Details of the input data required for a simulation and of the analytical output obtained are described below.

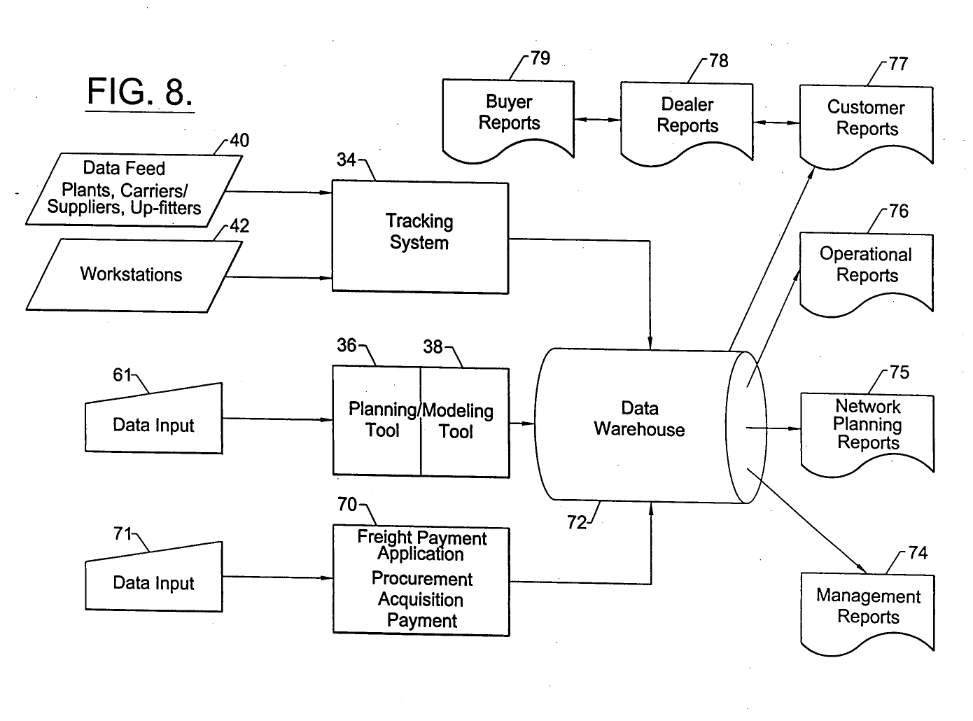

Referring now to FIG. 8, a concept diagram of the data flow network is shown. The tracking system 34, planning tool 36, simulation tool 38, and a payment application 70 provide input to a central data store 72. The tracking system receives input data from the data feed 40 as well as from the workstations 42. The planning and simulation tools receive data inputs 61 representing the various inputs described above. The payment application receives input 71, which may include payment applications from carriers, contractors, and suppliers, as well as work confirmation data from the delivery network. The central data store 72 is utilized to generate many reports useful in operating and assessing the delivery system 10. These include management reports 74, network planning reports 75, operational reports 76, customer reports 77, dealer reports 78, and buyer reports 79.

In a preferred embodiment of the system 10, members of the management team 31 or appropriate personnel of the entities operating the network may be equipped with data acquisition terminals that are capable of capturing signatures. Such terminals may be used to obtain the signature of a person accepting a VIN at the end point of any lane segment, and particularly the signature of a dealer on accepting final delivery of a VIN. By conventional means, the signature data may then be uploaded to the tracking system database 50 or to another data storage location. The management team or vehicle manufacturer may then access the signature data as proof of delivery, and release payment to the carrier who obtained the signature.

Tracking System

The vehicle tracking system 34 tracks vehicles of the automobile manufacturer in the automobile manufacturer's distribution network 20. The vehicle tracking system 34 provides information about the location of vehicles 22 of the automobile manufacturer at certain points in the automobile manufacturer's distribution network. As discussed elsewhere in this application, the automobile manufacturer's distribution network 20 is divided into Zones, which contain many Areas, and each area may contain many Ramps. There are several types of ramps including factory ramps, mixing center ramps, and destination ramps. The invention has determined that various types of managers associated within this distribution network will be given summary level access to shipment data typically based on a time window for a group of vehicles as they progress through the distribution network.

The vehicle tracking system 34 can provide shipment visibility down to a specific VIN within the automobile manufacturer's distribution network. Shipment visibility pertains not only to the ability to locate individual VINs, but also includes the ability to determine the expected arrival time of that VIN at various locations along its delivery route. Shipment visibility also includes the capability to view the VIN in conjunction with a number of other VINs within a variety of “views”. For example, a dealer can view all of the VINs which are en route to his facility, or the Dealer can view only the VINs which are expected in the next week or day. This visibility can be accomplished via the web or other suitable networks such as LANS, WANS, or other electronic networks.

On the specific VIN level, all tracking data associated with a particular VIN can be viewed, including not only historic data relating to past delivery tracking data, but also anticipated delivery scheduling. This is an important feature of the invention in that it allows for “pull”-type management (discussed elsewhere) by allowing management several days ahead in which to arrange for and anticipate incoming delivery, or to divert delivery along different routes if upstream bottlenecks or impediments are discovered or known. It should be understood that other selected and/or predetermined time periods such as shifts, etc., could be substituted for days in the previous sentence.

A VIN Detail View allows for review of the particular specifications of the particular VIN.

Views showing specific VIN level detail or views showing more than one VIN can be provided as output by the vehicle tracking system 34 depending upon the needs and authorization of the user. As previously noted, the automobile manufacturer's distribution network is divided into Zones, which contain many Areas, and each area may contain many Ramps, and there are several types of ramps including factory ramps, mixing center ramps, and destination ramps. Thus, a variety of users are associated along this network, including but not limited to:
Dealers
VP Managers
Zone Managers
Area Managers
Ramp/Supervisor Managers

These individuals have certain tailored views which they can access through the Tracking System 34. Other views are also available for other entities such as Administrators, Data Archivers, and Maintenance.

A variety of reports are also available, including Expediting Reports and Planning Reports. Expediting Reports include Critical VIN, Aged VIN, No Start VIN, and Jeopardized Delivery VIN reports. Some of the Planning Reports include Origin Ramp reports, Pass Through Car reports, and Mixed Car reports. A search capability of also available.

The vehicle tracking system 34 is facilitated by the use of software running on hardware and includes data input and output ports. Data is input into the vehicle tracking system 34 through any of the number of ports, and data is output from the system through another number of ports. Data input can be in the form of new or updated data, provided by a data source system such as the automobile manufacturer's event occurrence database, or another suitable data source.

It should readily be understood that the vehicle tracking system 34 may be considered a “module” for operation within a larger system environment, in the present case within the transportation system 10 of the present invention.

For purposes of further discussion, certain terms and their definitions are now provided.

| Term | Definition |
|---|---|
| Actual Date | The date that the event has actually occurred. In Phase I, this is provided |
| | from data from the manufacturer's legacy computer system (hereinafter |
| | “Legacy”). |
| Alert | A proactive notification of a specific event occurrence or non-occurrence of |
| | an event within its tolerance windows |
| Alternate Lane | A change in the routing regardless of time of validity of that routing that |
| | applies to any vehicle (VIN) that has not dropped into a transportation |
| | network. (In Phase I, prior to Legacy 1B Factory Release.) |
| Carrier | Any provider that transports a vehicle: car hauler, rail provider, etc. Also |
| | known as Vendor. |
| Legacy | A system operated by the automobile manufacturer that supplies data to the |
| | vehicle tracking system 34. |
| Destination | A Destination Ramp is the final facility through which a vehicle passes |
| Ramp | prior to delivery to the dealer. Destination Ramps are predominately |
| | inbound railyards where trains from the Mixing Center or Plant are |
| | unloaded and then loaded onto car-haulers for delivery to the dealer. |
| | Destination Ramps can also be located at the Plant or Mixing Center as a |
| | consolidation point for vehicles that are to be delivered locally. See also |
| | Mixing Center, Origin Ramp. |
| Dwell Time | The waiting time after release or unloading at origin ramp, mixing center, |
| | ramp, or other transportation facility prior to departure from that facility. |
| Lane | A unique combination of ultimate origin, destination, transit time and mode |
| | of transport. A lane consists of a combination of segments. |
| Location | Location refers to the ramp, lane or other place where the event is planned |
| | to take place or actual occurs. |
| Mixing Center | A Mixing Center (4 total facilities) is a hub used for consolidation (unload |
| | and re-load) of vehicles coming from multiple origins onto railcars for like |
| | destination ramps. Additionally, Mixing Centers take pure railcars (Load to |
| | Destination Ramp) from multiple origins and build trains going to the |
| | Destination Ramp. The Mixing Center can also take vehicles from these |
| | origins that are destined for local dealers and load them out for delivery via |
| | over the road car-haul operations. There are presently four (4) Mixing |
| | Centers in the network: Kansas City, Chicago, Shelbyville (KY), and |
| | Fostoria (Oh). |
| Origin Ramp | Origin ramps are located at the factory or plant. |
| Planned Date | The date that the event is projected to occur based on the information |
| | originally provided by the automobile manufacturer. In Phase I, this is |
| | derived from the Legacy 1A record. |
| Ramp | Refers to a location. Origin ramps are at the plant. A Destination Ramp is |
| | the final facility through which a vehicle passes prior to delivery to the |
| | dealer. See also Destination Ramp, Origin Ramp, Mixing Center. |
| Region | A geographical area as defined by the Delivery Logisitics Company. |
| Revised Date | The date that the event is expected to occur based on the actual information. |
| | In Phase I, this information is derived from information provided by The |
| | Automobile Manufacturer's Legacy system. |
| Segment | A segment is a portion of a lane that is defined by a specific origin and |
| | location. Specific (planned and unplanned) events occur along segments. |
| Vendor | Any provider that is contracted to transport a vehicle: car hauler, rail |
| | provider, etc. in the network. Also known as Carrier. |
| VIN | The Vehicle Identification Number is the unique number assigned to a |
| | vehicle. It is a federally required identifier unique to every vehicle |
| | manufactured in the United States (and Canada). Each VIN consists of a |
| | series of numbers and letters, each representing a particular field of |
| | information, such as manufacturing site, model type, engine size, etc. This |
| | is standard terminology used whenever referencing a vehicle, car, truck, or |
| | automobile. |

Tracking System 34—First Embodiment

This embodiment may also be referred to as “Phase I”.

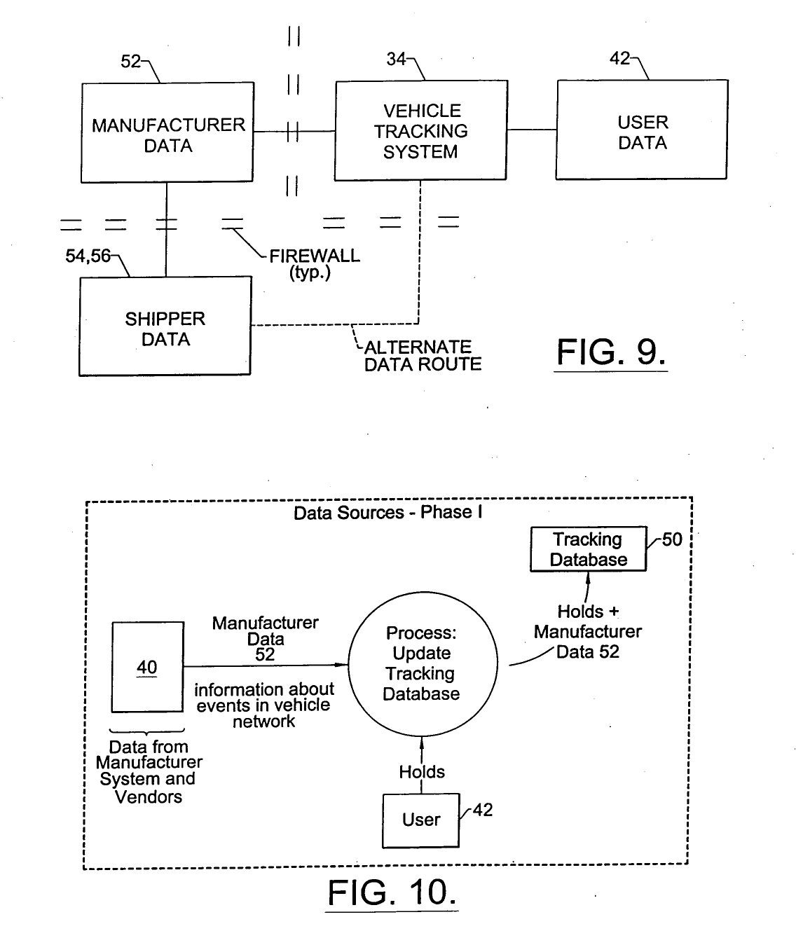

As noted before, the vehicle tracking system 34 (FIG. 9) tracks vehicles 22 (FIG. 1) in the distribution network 20 of the Automobile Manufacturer. The vehicle tracking system 34 provides information about the location of vehicles 22 of the Automobile Manufacturer at certain points in the Automobile Manufacturer's distribution network 20. The vehicle tracking system 34 could be seen as part of the data flow network 30.

The automobile manufacturer's distribution network 20 is divided into Zones, which contain many Areas, and each area may contain many Ramps. There are several types of ramps including factory ramps, mixing center ramps, and destination ramps.

Several types of managers will require summary level access to shipment data typically based on a time window for a group of vehicles as they progress through the distribution network 20.

In one embodiment, the vehicle tracking system 34 application will receive vehicle manufacturers data 52 from a tracking event database provided by the automobile manufacturer (in one embodiment through the automobile manufacturer's legacy system, hereinafter “Legacy” system), imports it and then provides an web format view of the data via the Internet. The objective of vehicle tracking system 34 is to provide shipment visibility down to a specific VIN within the automobile manufacturer's distribution network 20. The vehicle tracking system 34 adds value to this data by projecting and tracking shipment status.

The following data views are included in the first embodiment: Dealer View, Ramp View, and Lane View

Data for the first embodiment is supplied by the automobile manufacturer's Legacy system, which is discussed elsewhere in this discussion.

Functions which are not in the scope of the first embodiment of Vehicle Tracking System 34, but may be included later, include:
Alarms and Alerting
Lane Maintenance Screens
Car Hauler View
Rail Hauler View
Enhanced Security
Carpoint/XML support
Factory Manager View

Data sources other than Legacy also are not be used in the first embodiment with the exception of holds.

Users of this application include a team of managers working as a management team 31 that will work with the automobile manufacturer to manage the Automobile Manufacturer's distribution network 20. The application is accessible to these users via the Internet. Users will include area, ramp and lane supervisors and planners whose activities will include all facets of managing the network, including daily movement of vehicles, contingency planning, notification and response, short-range and long-term planning.

For reference purposes, certain of these managers of the management team 31 are now referenced:

| Position | Description |
|---|---|
| Region Division | The Region Division Managers are responsible for all activities and |
| Managers | results within their defined regions of operations. Their responsibility |
| | will primarily consist of carrier management in the field, insuring that |
| | the requirements of the network are met in each segment or lane of |
| | transit. They are responsible for activities at varying types of |
| | locations; plants, mixing centers, and destination ramps. The Region |
| | Division Managers are expected to develop working relationships with |
| | those carriers assigned business at each location. Additionally, they |
| | are expected to serve as contact point for all matters in the field |
| | relating to the delivery of new vehicles. This will involve establishing |
| | lines of communication and a presence before dealers and carriers. |
| | Activities will include the following: |
| | Carrier performance reviews: daily, monthly, quarterly as required |
| | Auditing: facilities, vehicle handling, paperwork, cost accounting, |
| | personnel |
| | Planning sessions |
| | Dealer visits |
| | Cost control and review |
| | Quality programs and enforcement |
| Area Managers | The operating Area Managers are responsible for all activities and |
| | results within their defined areas of operations - one assigned per |
| | mixing center, and assignment by geographic definitions (including |
| | assembly plants, lanes and segments, and the associated territory |
| | served.) Their responsibility will consist of executing the plan through |
| | carrier management in the field, insuring that the requirements of the |
| | network are met. At plant locations, additional responsibilities will |
| | include vehicle entry into the network per a planned carrier mode; |
| | distribution and flow plan, and building trains according to blocking |
| | schedules as required by the rail network to feed the mixing centers. |
| | The Area Managers are expected to develop working relationships |
| | with those carriers assigned business at each location. Additionally, |
| | they are expected to serve as contact point for all matters in the field |
| | relating to the delivery of new vehicles. |
| | Activities will include the following: |
| | Daily contact with operations and network planning |
| | Carrier performance reviews: daily, monthly as required |
| | Planning sessions |
| | Dealer visits |
| | Cost control and review |
| | Quality programs and enforcement |
| Planning & | The Planning & Systems Division Managers are responsible for |
| Systems Division | supporting the operators and all activities and business elements |
| Managers | related to the joint venture. The positions are aligned with the two |
| | zones dividing the operation into geographic areas of responsibility. |
| | The activities and business elements will encompass all facets of the |
| | operations, including daily movement of vehicles, contingency |
| | planning, notification and response, short-range and long-term |
| | planning, efficiency studies. |
| | SouthWest Zone |
| | Systems/IS |
| | Tracking and Contingency |
| | NorthEast Zone |
| | Empty Rail equipment |
| | This alignment of functional differences was enlisted to distribute |
| | areas of responsibility equally between the two groups, while |
| | providing for a central location for decision-making and coordination. |
| | Activities will include the following: |
| | Daily network performance monitoring |
| | Volume projections |
| | Statistical performance tracking and analysis |
| | Equipment positioning and balance |
| | Systems maintenance (IS) |
| | Contingency planning and implementation |
| | Exception tracking |
| | Data Table maintenance |
| | Network Optimization |
| | Forward model planning |
| | Facilities planning and design |
| | Planning, both short-range and long-term |
| | Simulation model production and processing |

The vehicle tracking system 34 has been developed using known web development techniques. One embodiment includes a web-based application server and an Oracle™ database. The web server hosting this application can be an industry standard Sun Solarism based web server. An Oracle™ database server running under HP-UX™ can anchor the application. However, other hardware configurations can be used without departing from the spirit and scope of the present invention. More details on such hardware are provided elsewhere in this application.

Vehicle Tracking System Events Used With Tracking System 34

As noted above, the vehicle tracking system 34 (see FIG. 9) is configured to “track” vehicles as they pass though the distribution network 20. In one embodiment this tracking is done at least partially by the use of certain events which are captured and subsequently reported. Events that are captured and reported on by the vehicle tracking system 34 in Phase I include but are not limited to the following:

| Event | Source of Data |
|---|---|
| 1. Vehicle Forecasted | Legacy 1J |
| 2. Production Begins | Legacy 1A |
| 3. Vehicle Released | Legacy 1B |
| 4. Loaded onto Rail Car | Legacy 1C & 1D |
| 5. Unloaded from Rail Car | Legacy 2A & 2B |
| 6. Vehicle Arrives at Destination | Legacy 2A & 2B |
| 7. Rail Switch-Out/Car Hauler Depart | Legacy 3C |
| 8. Vehicle Delivered | Legacy 3A - “F” if field 28 |
| 9. Vehicle Put on Hold | Legacy & Vehicle Tracking |
| | System Data Entry |

Production forecasts are used by the vehicle tracking system 34 to establish that a vehicle will require transportation to a dealership or a customer. Plant release data is used to establish that a vehicle has been produced and is ready for transportation. Routing and transportation data are used to determine if the vehicle is being transported in a time frame consistent with the standards established for the route and routing.

It should be understood that the above events are not necessarily in order; for example, vehicles can be put “On Hold” at any point along the distribution network 20.

As discussed elsewhere, a wide variety of users can place the vehicle “On Hold”.

For reference purposes, the following is a restatement of various previously-discussed data entities and terms used relating to the distribution network 20.

A lane is a unique combination of ultimate origin, destination, transit time and mode of transport. A lane consists of a combination of segments. A segment is a portion of a lane that is defined by a specific origin and location. Specific (planned and unplanned) events occur along segments. Origin ramps are at the assembly plant. Destination ramps are the final facility through which a vehicle passes prior to delivery to the dealer. Origin ramps are at the plant.

A carrier or vendor is any provider that transports a vehicle such as a car hauler, rail provider, etc.

The date that and event has actually occurred is referred to as the Actual Date. The Planned Date is the date that the event is projected to occur based on the information originally provided by the automobile manufacturer. The Revised Date that the event is expected to occur based on the actual information.

Location refers to the ramp, lane or other place where the event is planned to take place or actually occurs.

Data Sources

In the first embodiment of the invention (Phase I), the primary source of data for tracking vehicles in the distribution network 20 is manufacturer's data 52 which can include an events database of the automobile manufacturer system, which may be referenced as Legacy. Legacy data is comprised of production forecasts, plant release data and routing and transportation data. Legacy data can also be used to facilitate the payment of carriers and to facilitate other functions as described elsewhere in this application.

The Automobile Manufacturer's Legacy Data

The automobile manufacturer can provide Legacy records bearing exemplary names such as “1J” and “1A” to the Tracking System 34. Carrier Legacy records can be picked up by the management team Delivery from the automobile manufacturer's EDI mailbox. Order in which records are received may not correspond to chronological order. Such item names and characteristics are for example only; other formats of other data sources could also be used without departing from the invention.

| | Description of Part of Record | |
|---|---|---|
| | Relevant to the Vehicle Tracking | How Used by the Vehicle Tracking |
| Record | System 34 | System 34 |
| 1J | Reports on advance shipping notice | Used to initialize vehicle data in the |
| | provided 4 days before completion of | vehicle tracking system 34, “Vehicle |
| | vehicle assembly. Includes: | Forecasted” event |
| | VIN | Planned dates are calculated for subsequent |
| | Origin | events for each vehicle based on the Route |
| | Destination | Code. |
| | Route Code | |
| | The automobile manufacturer uses this | |
| | record to plan segments and costs. In | |
| | Route Code table, N = Normal, P = Preferred, | |
| | only one route code is | |
| | active. Origin/Destination Pair and | |
| | mode determine route code. | |
| 1A | Produced 4 days before vehicle leaves | Reports on “Production Begins” |
| | production. | event“/”Invoiced (Search)” |
| | Includes: | Subsequent events and their associated |
| | VIN | dates are determined. |
| | Origin | Used to initialize vehicle data in The |
| | Destination | Vehicle Tracking System if 1J not |
| | All carriers receive 1A record, not all | received. |
| | want to receive 1J record from the | Subsequent events and their associated |
| | automobile manufacturer. | dates are determined using O/D pair |
| | | without Route Code. |
| 1B | Reports on plant release of vehicle. | Used to indicate “Vehicle Released” event |
| | Includes: | has occurred and actual release date. |
| | VIN | Revised event dates are calculated if actual |
| | Origin | release date is different than planned |
| | Destination | release date. |
| | Release Date | |
| | Currently, a 1B can be sent for a | |
| | vehicle that is not shippable. The | |
| | automobile manufacturer has plans to | |
| | make “released” = “shippable”. The | |
| | automobile manufacturer's QLS | |
| | system has information about holds. | |
| 1C | Reports a rail switch-out - that a | Used together to determine if a vehicle is |
| 1D | vehicle has changed rail carriers. | loaded at a mixing center: |
| | These records associate the VIN to a | Used for “Loaded onto Rail Car” event |
| | rail car. | first time received. |
| | 1C - Railcar Header Record. | Used for “Switchout Event” after first |
| | 1D - Provided for each vehicle | time received. |
| | shipped on a railcar, has railcar id | Revised event dates are calculated if actual |
| | | release date is different than planned |
| | | release date. |
| 2A | The convoy carrier submits this at the | System 34 will assume that the activity |
| | destination ramp to signify the VINS | took place at the point identified in the |
| | have been unloaded and are available | standard routing and calculate accordingly |
| | to the convoy carrier. | to produce information for the “Unloaded |
| | Indicates that rail cars have changed | from Rail Car” event. |
| | trains. | Revised event dates are calculated if actual |
| | Normal arrival . . . | release date is different than planned |
| | | release date. |
| 2B | The convoy carrier will send in a 2B if | |
| | there is a correction to the 1C/1D. | |
| | Example: A VIN reported to be on the | |
| | railcar but wasn't, instead there was a | |
| | different VIN. 2B adds and deletes | |
| | VINS from the Consist | |
| | transmission(1C/D). The 2B will have | |
| | all the fields a 2A would have plus the | |
| | “A” for add or “D” for delete and the | |
| | VIN associated | |
| | with the action code. | |
| 2C | The 2C is sent by the carrier when | Reports arrival of a rail car for which |
| | there is an arrival of a railcar for which | switchout not rec'd. |
| | a switchout was not received. When | |
| | received, Legacy will send a 1C/1D | |
| | back to the carrier. | |
| 2D | One record for each vehicle on the | |
| | railcar reported in the 2C. | |
| 3A | Reports on delivery to dealer or final | Used to indicate “Vehicle Delivered” event |
| | destination (customer). Normal | has occurred and its date. |
| | movements. | Revised event dates are calculated if actual |
| | This transaction will have a “F”. “R”, | release date is different than planned |
| | or a “T” in field 28. | release date. |
| | F = a final delivery to dealer. | 3A-F - “Vehicle Delivered to Dealer” |
| | T = a convoy move for a ramp to | Can be used for “Unloaded from Rail Car” - |
| | ramp | because the vehicle has been dispatched |
| | R = Refused by the dealer. | via convoy carrier. |
| 3B | Reports on diversions directed by the | Will be used to indicate exceptions . . . |
| | automobile manufacturer. These | |
| | include: reduced move to dealer, return | |
| | to ramp; any diversion to location or | |
| | dealer other than the one designated in | |
| | 1B or 1D. | |
| 3D | Reports on convoy dispatch. | Can be used for “Unloaded from Rail Car” - |
| | | because the vehicle has been dispatched |
| | | via convoy carrier. |
| 4A | Reports on changes to vehicle status, | Plans are to use this record to report on |
| | including exceptions such as in-transit | exceptions that affect vehicle tracking. |
| | repair, removed from network to | Any exceptions that do not affect time in |
| | storage, etc. Also includes payment | transit are ignored. |
| | information. | |

As shown in FIG. 7, Legacy data 52 from the vehicle manufacturer and vendors (carriers) can be sent through interface 40 to the vehicle tracking system 34 In one embodiment, a “mailbox” is used as an intermediate repository to facilitate such transfer, with appropriate security such as firewalls in place as known in the art. The vehicle tracking system picks up this data at regular intervals.

Views

The vehicle tracking system 34 functionality includes various views for querying, administrating, and reporting on vehicle tracking data:

All views will contain several multiple web pages with hyperlinks to such functions as search, description, and reports.

The views contained described in this section may be readily accessed from all user types:
1) Vehicle Summary View
2) Unit Breakdown (a.k.a., “Model Summary”) View
3) Vehicle Tracking (a.k.a., “Status Details”) View
4) Vehicle Detail View

The Vehicle Summary View is a list of vehicles based on the location of the user and time requirements of the view. Selection of a vehicle displays the vehicle detail view. Selection of a vehicle's status summary displays the vehicle tracking view. The Vehicle Summary can include the following:
VIN
Vehicle model
Model Year
Planned date of arrival at location (depending on user view)
Revised date of arrival at location (depending on user view)
Current location of the vehicle
On-schedule indicator (i.e., status lights: green=on time, yellow=one day late, red=2 or more days late)

The Unit Breakdown (a.k.a., “Model Summary”) view contains a listing of the following information for the selected user view:

| | |
|---|---|
| Model Name | Models for selected user view |
| Quantity | Quantity of Models |
| Vehicle Summary | Hyperlink to Vehicle Summary View |

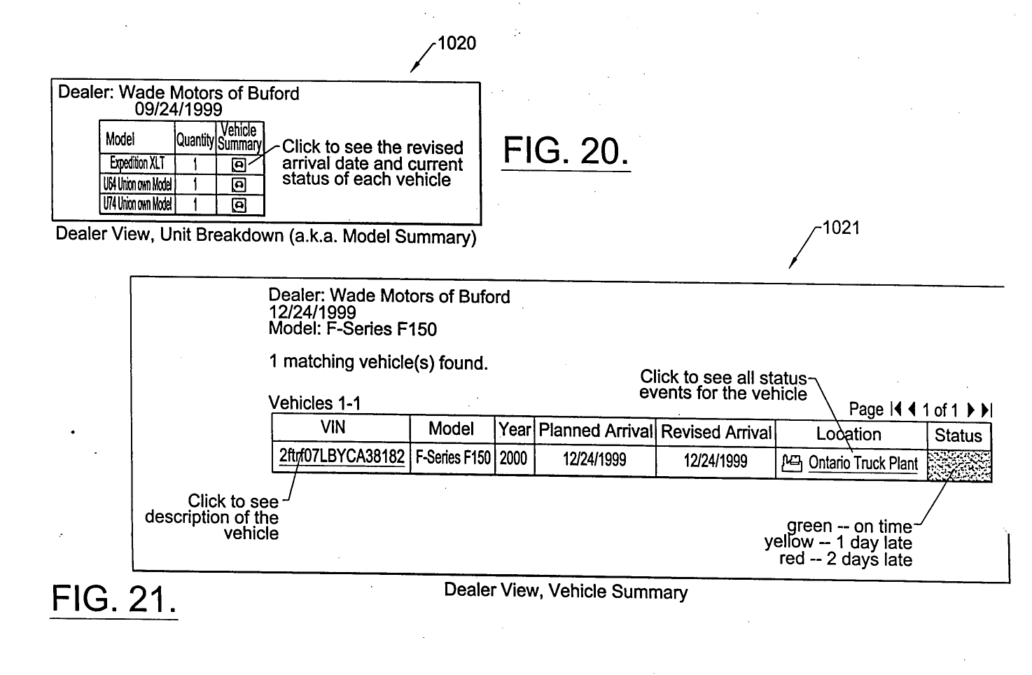

Reference is briefly made to FIG. 20, which shows an Unit Breakdown (a.k.a., “Model Summary”) view.

The Vehicle Tracking (a.k.a., “Status Details”) view, in one embodiment, contains a summary of shipment activity (status details) for the selected vehicle:

| | |
|---|---|
| Event | Description of event |
| Location | Location where event has taken or will take place |
| Planned Date | Planned date for the event |
| Revised Date | Revised date for the event (if applicable) |
| Actual Date | Actual date of the event |
| Notes | Any notes reported about the event |

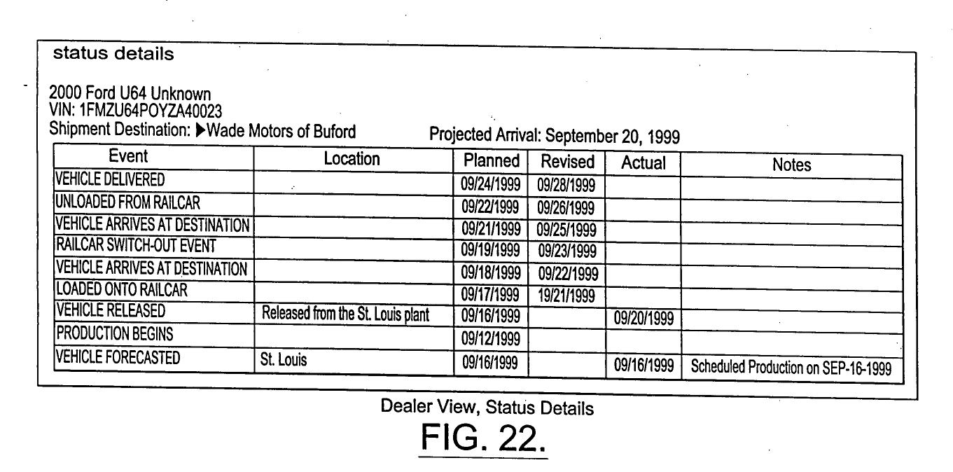

Reference is made to FIG. 22, which shows an exemplary Vehicle Tracking (a.k.a., “Status Details”) view.

The Vehicle Detail View, in one embodiment, contains a detailed description of the selected vehicle, including information such as the following:
Model Name
VIN
Make (Manufacturer)
Line & Series
Model Year
Body Type
Chassis Type
Engine Details (Cylinders, Litres, Net Brake HP, Fuel)
Miscellaneous (Restraint, System)

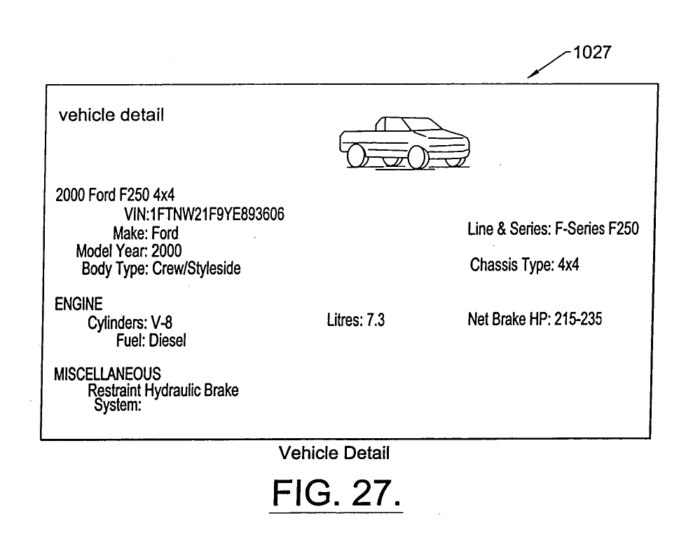

Reference is made to FIG. 27, which shows an exemplary Vehicle Detail View.

The Advanced Query View (not shown) contains that allow the user to search for a vehicle by selected criteria. The search criteria include VIN, model, model year, date range and status (e.g., forecasted, released from plant, invoiced).

The Holds & Damages View (not shown) allows the user to assign & remove hold statuses to a given vehicle. The user is able to assign a damage code to a given vehicle.

The Lane Summary View provides the user with a list of areas that are included in the user's lanes. In the Lane Summary View, the user will see a listing of the following:

| | |
|---|---|
| Date | Date for events associated with |
| | lane |
| Quantity | Quantity of vehicles associated |
| | with that date and lane |
| Unit Breakdown | A hyperlink to the Unit |
| | Breakdown for this date and lane |
| | (a list |
| Vehicle Summary | A hyperlink to the Vehicle |
| | Summary for this date and lane. |

The Ramp Summary View shows the same elements as the Lane Summary View within the user's assigned Ramp(s).

The Ramp Supervisor View shows the same elements as the Lane Summary View for the Ramp Supervisor's assigned Ramp(s). This view can be for 2 days out. It can include the following information for the Ramp:
Hours of operation
Days of operation
Holidays
Comments/Notes
Contact Name
Contact Telephone
FIPS Code

The Dealer Summary View shows the same elements as the Lane Summary View for the user's assigned Dealers.

Administration Views allow for the maintenance of Users, Areas, Dealers, Lanes, Ramps, Regions, and Vehicle Holds.

Adding, changing and deleting users and assigning access rights is performed using the User Account Setup view. This view allows for entry of the following elements to create a New User:

| Element | Description |
|---|---|
| User login ID: | User's Login ID |
| User name: | User's Full Name |
| Change password to: | User-Selected Password |
| User email: | User's email address |
| User pager: | User's pager number |

After entering the new user, the user will use the Add New Permissions link to display the Permissions Maintenance Page. This page displays the following:

| Top level permissions | Add/Remove Permissions | |
|---|---|---|
| Region, area, ramp permissions | add permission | remove permission |
| Dealer permissions | add permission | remove permission |
| Lane permissions | add permission | remove permission |
| Admin permissions | add permission | remove permission |

These hyperlink functions do the following:

| Element | Description |
|---|---|
| Region, area, ramp | Left link to select specific regions or right link for |
| permissions | all |
| Dealer | Left link to select specific dealer or right link for all |
| Lane | Left link for selected lanes or right link for all |
| Admin | Access to administrative function based on user |
| | role |
| Remove Permission | Link to remove the permission next to which it |
| | appears |
| Back to User | Links to add User Permissions List Page |
| Permissions List | |

Administrative Permissions are assigned based on the user's job requirements for Region(s), Area(s), Ramp(s), lane(s), Dealer(s), and/or Hold(s):

| Access To Admin Functions | Add/Remove Permissions |
|---|---|
| Users | add permission |
| Regions | add permission |
| Areas | add permission |
| Ramps | add permission |
| Lanes | add permission |
| Vehicle Holds | add permission |
| Dealers | add permission |

The “add permissions” link (links are in underline) is a link to assign new permissions to the user.

An “Update User” function allows for changing user information or deleting users a search function will allow the administrator to locate a user by user id or name.

Searching can be by either:

User ID (blank for all)
User Name (blank for all)

A list of users which meet the above search criteria are displayed.

| User ID | User Name | Permissions | Remove |
|---|---|---|---|
| User ID 1 | User1 First User1 Last | edit permissions | delete user |
| User ID 2 | User2 First User2 Last | edit permissions | delete user |
| User ID 3 | User3 First User3 Last | edit permissions | delete user |
| User ID 4 | User4 First User4 Last | edit permissions | delete user |
| User ID 5 | User5 First User5 Last | edit permissions | delete user |

A hyperlink can also allow for deletion of the user.

Changing permissions can also be done. Depending on the permissions assigned to the user id, the Add/Remove column will show either add permission (permissions not assigned for all) or remove permissions (permissions assigned for all).

| Top level permissions | Add/Remove Permissions | |
|---|---|---|
| Region, area, ramp permissions | add permission | remove permission |
| Dealer permissions | | |
| Lane permissions | add permission | remove permission |
| Admin permissions | add permission | remove permission |

Editing of permissions can also be done as follows:

| Element | Description |
|---|---|
| Region | All or selected regions can be assigned based on user role |
| Dealer | All or selected dealers can be assigned based on user role |
| Lane | All or selected lanes can be assigned based on user role |
| Admin | Access to administrative function based on user role |
| Remove | Link to remove the permission next to which it appears |
| Permission | |
| Add New | Links to add Permissions Maintenance Page |
| Permissions | |

The administrator is able to remove permissions using a Remove Permission link(s) or add permissions using an Add Permissions link.

Depending on the permissions assigned to the user id, the Add/Remove column will show either add permission (permissions not assigned for all) or remove permissions (permissions assigned for all).

| | |
|---|---|
| Access To | |
| Admin Functions | Add/Remove Permissions |

| | | |
|---|---|---|
| Users | add permission | remove permission |
| Regions | add permission | remove permission |
| Areas | add permission | remove permission |
| Ramps | add permission | remove permission |
| Lanes | add permission | remove permission |
| Vehicle Holds | add permission | remove permission |
| Dealers | add permission | remove permission |

The Area Maintenance view provides the capability to add, change and delete areas.

The Region Maintenance view provides the capability to add, change and delete regions (zones).

The Lane Maintenance view provides the capability to add, change and delete lanes, and define the segments per lane. In segment maintenance, segments can be defined for each lane.

For any given segment of a shipping lane, the time in transit can be modified. The total time in transit for the lane includes the total of the individual segment times in transit, plus the following assumptions (in the first embodiment):

| | |
|---|---|
| Dwell Time at Plant Ramp | Assumed to be 1 day |
| Dwell Time at Destination Ramp | Assumed to be 2 days |
| Dwell Time at Mixing Center | Assumed to be ? days |
| Segment Time in Transit | User-Defined |

Total Lane Time in Transit=Segment1 Time in Transit+Segment2 Time in Transit . . . +Dwell Times at various locations

It should be noted that dwell time at a Mixing Center varies from 8-24 hours. Dwell times at destination ramps vary.

The Ramp Maintenance view provides the capability to add, change and delete ramps.

The Dealer Maintenance view provides the capability to add, change and delete dealers.

The Vehicle Holds view allows the user to place holds by any combination of the following:
Production date
Origin ramp
Destination ramp
Engine type

General Screen Navigation

General screen navigation will now be discussed.

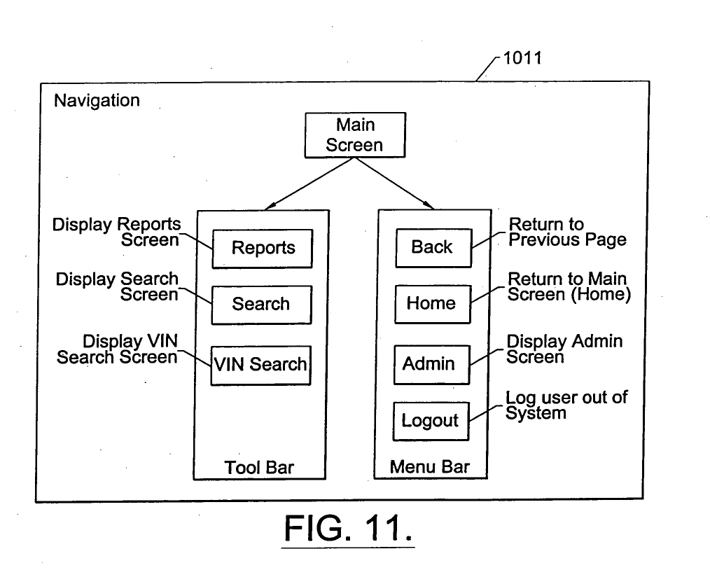

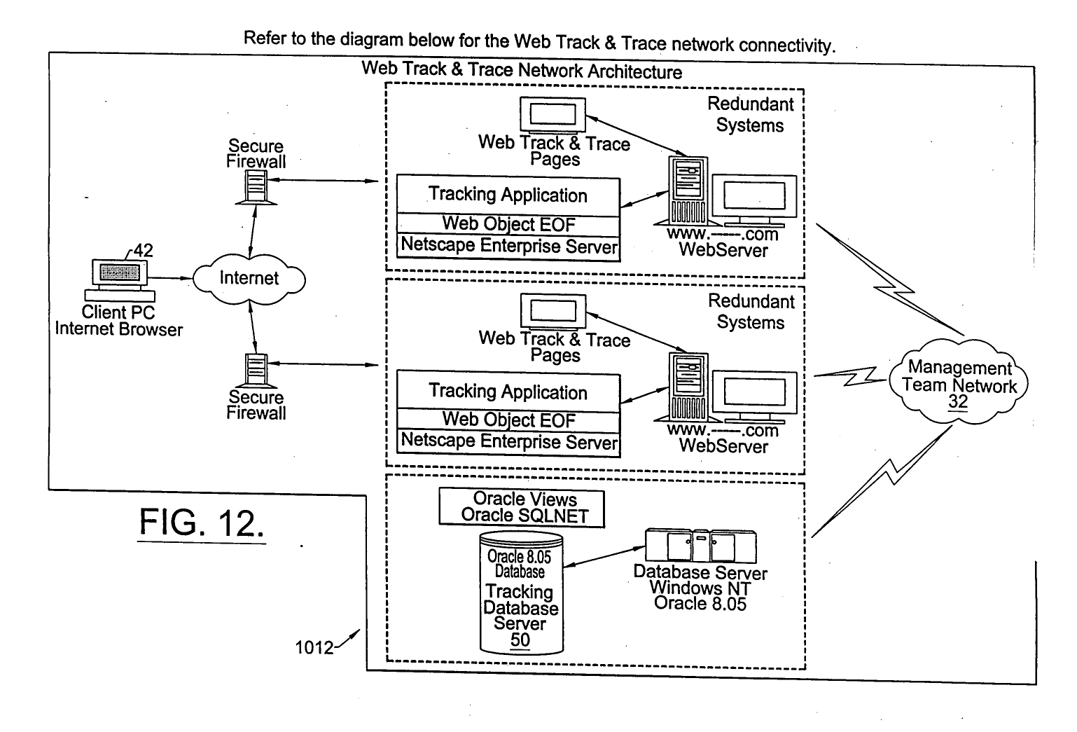

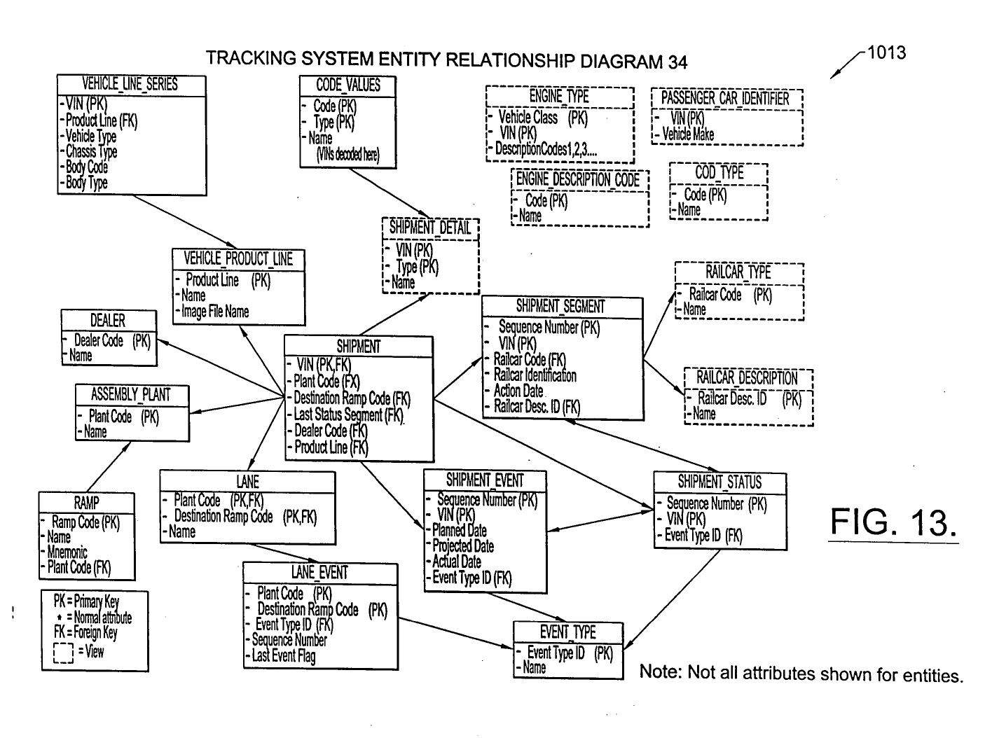

Referring now to FIG. 11, the following common functions can appear on all screens:

Menu Bar Functions (typically at the top):
Back (returns from previous page)
Home (returns to home screen)
Admin (displays administrative screen)
Logout (logs user out)

Tool Bar Functions (can be at the left):
Reports (displays reports screen)
Search (displays screen search)
VIN Search (displays VIN search screen)
   Reports

The report interface will provide the user with all the potential parameters, supplied as input to any given report. All user types as part of their reporting functionality will share this web page.

Several predefined reports have been identified. They include Expediting, Planning and Performance Reports.

Expediting Reports include:

| Name | Description | Data Elements Included |
|---|---|---|
| Critical VIN Report | Reports on events that have | VIN |
| | failed to take place as scheduled | Event (Activity) Date |
| | date. | Last Event Completed |
| | | Last Car |
| | | Last Segment Scheduled |
| | | Carrier SCAC |
| Aged VIN Report | Reports on vehicles for which | VIN |
| | there has been no status update | Event |
| | indicating that the next event has | Scheduled Event Date |
| | taken place; reports is by age | Scheduled Event Location |
| | category (72, 48-71, 24-47 | Segment Carrier SCAC |
| | hours) in applicable segments | Scheduled Delivery Date |
| No Start VIN | Reports on vehicles for which a | VIN |
| Report | plant release has been received, | Release Date |
| | but which have not been | Destination Ramp |
| | associated with a rolling stock. | Origin Segment Carrier |
| | By origin, date of release. | Scheduled Delivery Date |
| Jeopardized | Reports on vehicles that have not | VIN |
| Delivery Report | arrived at the destination ramp as | Current Segment Carrier |
| | scheduled, indicating that the | Car (1C/1D Car) |
| | delivery date may be in | New Scheduled Delivery Date |
| | jeopardy. In VIN Order. | Completed Days for Completed |
| | | Segments |
| | | Scheduled Delivery Date |

Planning Reports include:

| Name | Description | Data Elements Included |
|---|---|---|
| Origin Ramp | Reports on a breakdown of | Destination Ramp |
| Report | the vehicles released or | VIN |
| | scheduled to be released by | Carrier |
| | vehicle type that have not | Release Date |
| | been loaded. By destination, | Destination |
| | vehicle type or release date. | Scheduled Delivery Date |
| | | Total for |
| | | Destination/Vehicle |
| | | Type |
| Pass Through | Reports on a view of | Rail Car ID |
| Car By | vehicles that do not require | Carrier SCAC |
| Destination | vehicle unloading or loading | Scheduled Arrival Date |
| Report | at the mixing center, vehicles | Origin Ramp |
| | scheduled to arrive on a | Destination Ramp |
| | selected date. By mixing | |
| | center by carrier. | |
| Mixed Car | Reports on rail cars | Rail Car |
| Report | scheduled to arrive at the | VIN |
| | mixing center that require | Carrier |
| | unloading. By mixing center | Arrival Date |
| | by scheduled arrival date. | Destination Ramp |
| Reload Vehicle | To be determined. | |
| Report By | | |
| Destination | | |
| Mixing Center | To be determined. | |
| Inbound Report | | |
| Destination | To be determined. | |
| Ramp | | |
| Report | | |
| By Dealer | | |
| Destination | To be determined. | |
| Ramp | | |
| Report | | |
| By Carrier | | |

Vehicle tracking System—Second Embodiment

This section describes the functional requirements identified to date for a second embodiment of the auto delivery system. These requirements may be modified in response to changing customer needs.

Items excluded from the second embodiment of the vehicle tracking system 34 efforts but which may be included in additional embodiments include: Car Hauler View, Rail Provider View, and Consumer View

An enhanced function and view “enhanced dealer view” (not shown) is used which dealers to locate forecasted or inbound vehicles matching specified criteria. The criteria includes make/model, engine type.

A diversion view (not shown) allows the user to manually define a new destination for a vehicle. This serves as a notification to The vehicle tracking system 34 not to generate an alert when the vehicle isn't delivered as originally forecasted. Only a Ramp, Area, or Zone Manager can divert a vehicle.

New data services such as payload tracking information from the railroads is incorporated into the vehicle tracking system 34 database. At a minimum, this information provides location scans on railcars as they travel throughout the vehicle distribution network.

The car hauler personnel also provide tracking information on VINs as they transport them to their destinations.

Alarms and alerts are also possible; under this embodiment the system generates an email notification based on late arriving or missing vehicles at a predefined point in a lane.

A lane configuration interface is created that allows the user to add/change/delete lane segments. Each lane segment origin also contains a user defined vehicle dwell time.

This interface also allows the user to define shipment lanes by combining segments, with an origin, destination and method of travel.

A lane shipment notification allows, on a lane by lane basis the user to define a delivery tolerance that when exceeded generates an email to a responsible individual.

A damage notification concept is provided such that when a VIN is assigned a damage code the system sends an email notification to a damage manager. This manager is defined at the damage code level.

A hold notification is also provided such that when a VIN is assigned a hold code the system sends an email notification to a hold manager. This manager is defined at the hold code level.

When ramp capacity is exceeded, the vehicle tracking system 34 sends an alert.

Each ramp has a predefined VIN capacity. When a mixing center is defined in the vehicle tracking system 34, the administrator provides a parameter that defines vehicle dwell time while at the center. On a system wide basis, the administrator also defines the number of days in the future to generate this alert.

The system shall support the definition of ASCII-based reports. These reports can be downloaded via the web browser and then imported into Excel or some other Database.

The format of each individual report is determined as the business needs require.

Under the second Vehicle Delivery System embodiment the holds & damages view is modified to assign/un-assign holds and damage codes to groups of vehicles based on commonly used filter criteria; things like current/future location, manufacturing date, VIN range, make/model, engine type.

Design Specifications

The vehicle tracking system 34 system does the following:
Stores EDI data feeds into a data feed directory repository
Processes EDI data in accordance to the Customer's business rules
Populates an Oracle database with data that is either pulled directly from the EDI data, or is generated in accordance to the Customer's business rules
Provides access to the shipment information to users with varying degrees of access and business interests via a secure Internet application
Provides the facility for a “logistics manager” user to manage and optimize shipment routes and logistics
Provides facility to generate reports for the various users of the system

Fundamental components of the software include:
Database
EDI Processor
Data Processing Engine
Object Library
Applications

Database tables/views/stored procedures and supporting object models and code, were developed to provide functionality specifically for the vehicle tracking system 34 vl. A relational database specific to the vehicle tracking system 34's requirements was also developed.

Much of the data provided to users vehicle tracking system 34 is derived from the original EDI data using a “Data Processing Engine”. This data requires regular processing to determine state of the shipment. For instance, the “state” of a shipment (whether it is “late”, “on-time”, or “early”) is derived from the dates associated with the generation of 1×, 2×, 3×, 4×, “flags/alerts/alarms” is calculated on a regular basis, as new EDI data comes in.

To capitalize upon the strengths of the development tools (WebObjects, Java, Oracle, etc.) an “object library” is created. Objects are software components that are “reusable”. The object library would include: reusable web components (reusable components can be used to render information in the same manner for different application using a simple API), Java user interface widgets, utilities for paging or faxing data to customers when a problem occurs, utilities for sharing data between applications, and so forth.

The main user interface to The vehicle tracking system 34 provides shipment-tracking information to the ramp, area and zone supervisors. Under this interface, data is “read-only”. The information displayed secured by logon id and password. Search capabilities are provided to locate specific vehicle information by VIN, VIN fragment, make/model, Shipment “milestone” dates. This interface also allows for the display of shipment detail and status, indexed by expected ship date, expected arrival date, vehicle Types, etc. Reports can also be obtained to provide shipment metrics and/or history.

The “System Admin” interface to The vehicle tracking system 34 enables a “super user” to add/modify/delete users of the system, set/reset metrics, performs database admin duties, etc., as needed.

Monitoring and logging the usage of the system and other metrics is used as needed for determining usage, loading, and “cost-of-operation” of the system.

A conventional computer CPU, memory and disk space according to the prior art includes ample capacity to host the DBServer process for one prototype-type version of the invention. This process would accept queries from the Webserver, execute the query against the Oracle (ET) DB, and reply with the results.

Web server utilization according to the present invention can be accomplished through use of known web server architecture.

Reference is made to Fig. A6 for the Web Track & Trace network connectivity, which shows how a user internet browser on a workstation 42 can access redundant systems through the management team's network user.

Hardware and Software Platforms for System 34

The vehicle tracking system 34 software can be run by use of the following hardware/software platform support:

| Platform | Specific Vendor/Product |
|---|---|
| Web Server Hardware | Sun Microsystems hardware 2-4 250's |
| | Processor Performance: TBD |
| | 512 MB RAM minimum |
| Application Server Hardware | Sun Microsystems hardware 2-4 250's |
| | Processor Performance: TBD |
| | 300 MB Disk Space |
| Database Server | Compaq 3000 hardware, |
| Hardware (Prototype) | Processor Performance: 200 MHZ dual, |
| | 128 MB RAM minimum |
| Database Server | As known in the art |
| Hardware (Production) | |
| Web Server Software | Netscape Suitespot Enterprise Web |
| | Server, Version 3.6 or later |
| Application Server Software | Solaris 2.6 and upwardly compatible |
| | releases |
| Database Server Software | Oracle Database Server Version 8.05 or |
| | later |
| Secure Socket Layer Software | Verisign (Version 3) |
| Reporting Server Software | ReportMill 3.0 |

Such specifications are for example only and should not be construed as limiting.

Performance Criteria

Being a web project, the performance of the vehicle tracking system 34 can be more or less arbitrary, however, testing on the current system can be undertaken to determine the average performance times for the existing system as a baseline set of performance specifications. The following are some general figures, which much be considered as part of the design and acceptance process. The following table summarizes user-related numbers:

Prototype

| Statistic | Minimum | Maximum |
|---|---|---|
| Total Users | 0 | 118 |
| Concurrent Users | 0 | 35 |
| Uptime | 95% | 95% |

Production

| Statistic | Minimum | Maximum |
|---|---|---|
| Total Users | 6,000 | 10,000 |
| Concurrent Users | 0 | 1,000 |
| Vehicles | 4 m | 5 m |
| | 10% growth/year | 10% growth/year |
| Lanes | 150 | 1000 |
| Events | 7 per vehicle | 10 per vehicle |
| Status | 7 per vehicle | 20 per vehicle |
| Dealers | 6,000 | 10,000 |
| Uptime | 100% | 100% |

Data related specifications are summarized in the table below:

| Statistic (Tables) | MAX |
|---|---|
| Shipment (Vehicles) | 142 Bytes |
| Shipment Status | 425 Bytes |
| Shipment Event | 367 Bytes |
| User | 299 Bytes |
| Lane | 18 Bytes |
| Dealer | 112 Bytes |

With these sizes in place, the following statistics can be derived:

| Statistic | MAX |
|---|---|
| Shipment Display Set (200 record | 556K |
| limit) | |
| Shipment Event Display (10 record | 28K |
| limit) | |

Vehicle Tracking System Object Class Hierarchy

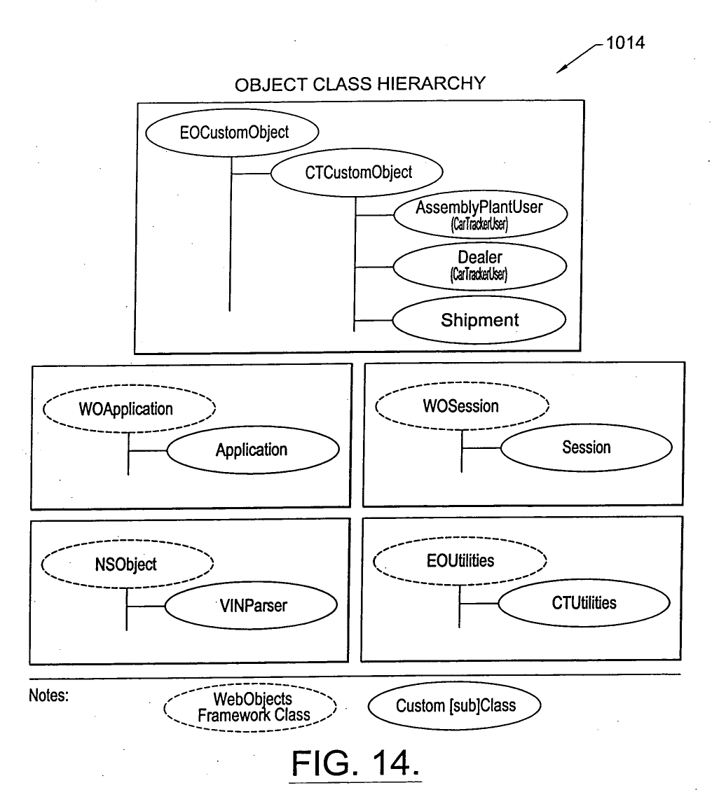

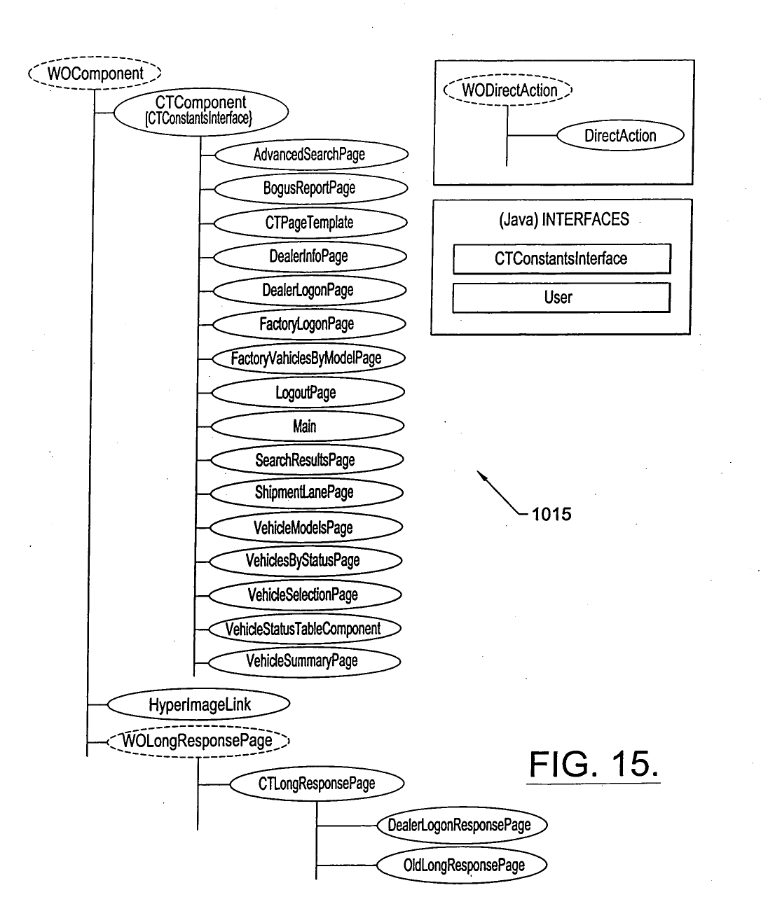

Reference is now made to FIGS. 14 and 15, which show the object class hierarchy of the object-based programming structure.

Vehicle Tracking System Screens

Various exemplary screen which will be seen by the users will now be discussed.

The vehicle tracking system 34 screens can be displayed using a Web browser. The user enters ID and password to login into the vehicle tracking system 34.

Ramps & Lanes User'S Viewable Ramps and Lanes

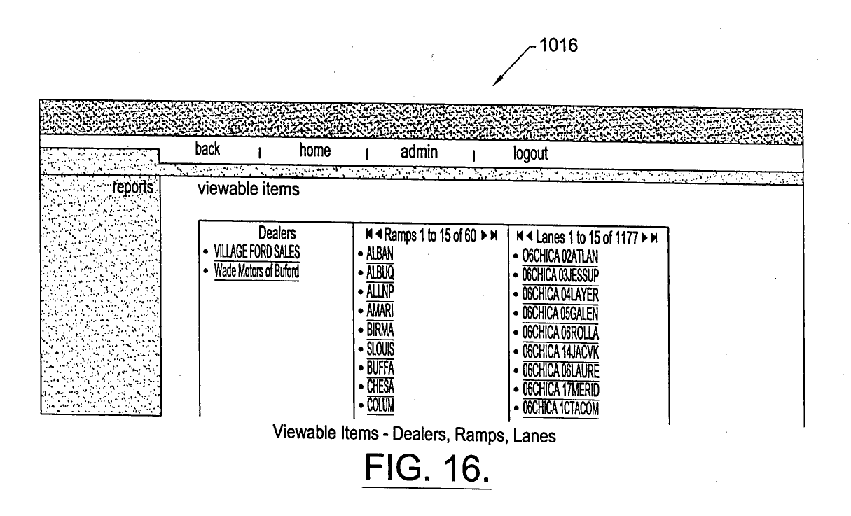

This type of screen, shown as FIG. 16, displays the ramps and lanes that are viewable to the user. Standard functions that appear on the top of each screen include: <back>, <home>, <admin>, and <logout>. This screen also has <reports> and <search> options, discussed in later detail.

Clicking on a link in the ramps column displays the ramps screen. Clicking on a link in the lanes column displays the lanes screen.

Ramps Screen: User'S View>a Ramp is Selected on Ramps & Lanes Screen

This screen (not shown) displays the details for the ramp selected by the user. This screen also has <reports> and <search> options. Clicking on unit breakdown displays the unit breakdown screen. Clicking on the vehicle summary displays the vehicle summary screen. These types of screens are discussed in later detail.

Unit Breakdown Screen: User'S View>a Ramp is Selected in Table>Unit Breakdown Icon is Selected for a Date

This screen (not shown) displays the details for the breakdown selected by the user on the previous screen. This screen also has <reports> and <search> options. Clicking on the vehicle summary displays the vehicle summary screen.

Unit Breakdown Date: User'S View>a Ramp is Selected>Unit Breakdown Icon is Selected for a Date>Vehicle Summary Icon is Selected for Date

This screen (not shown) displays the details for the unit breakdown selected by the user. This screen also has <reports> and <search> options. It displays the VIN, Model Year, Expected Arrival Date, Projected Arrival Date, Location and Status.

Vehicle Detail: User'S View>a Ramp is Selected in Table>Unit Breakdown Icon is Selected for a Date>Vehicle Summary Icon is Selected for Date>VIN Selected on Line Item

Under this screen (not shown) detailed vehicle information is displayed for the VIN selected from the previous screen.

Shipment Lane Screen: User'S View>a Ramp is Selected in Tabale>Unit Breakdown Icon is Selected for a Date>Vehicle Summary Icon is Selected for Date>Location Selected For a VIN Line

In this screen, (not shown) Shipment Lane information is displayed for the lane selected from the Unit Breakdown Lane.

Lane Screen: User'S Viewable Ramps and Lanes>Lane Selected

When the user selects Lane from the Ramps & Lane Screen, the Lane Screen is displayed (not shown). Clicking on Unit Breakdown link displays the Unit Breakdown Screen and clicking on Vehicle Summary displays the Vehicle Summary Screen.

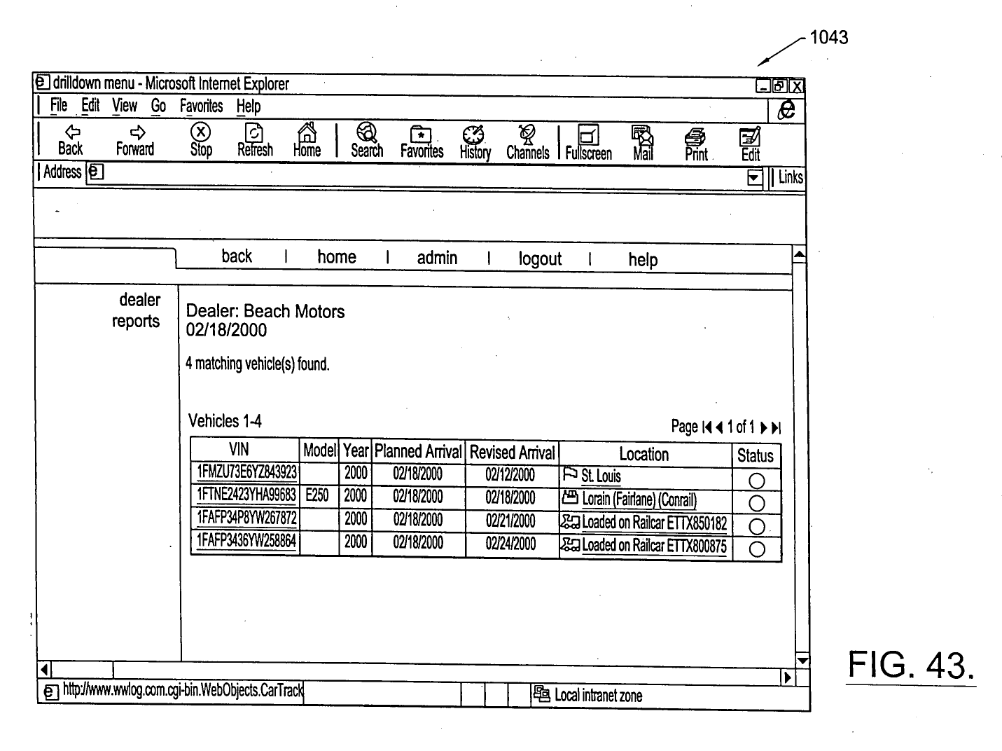

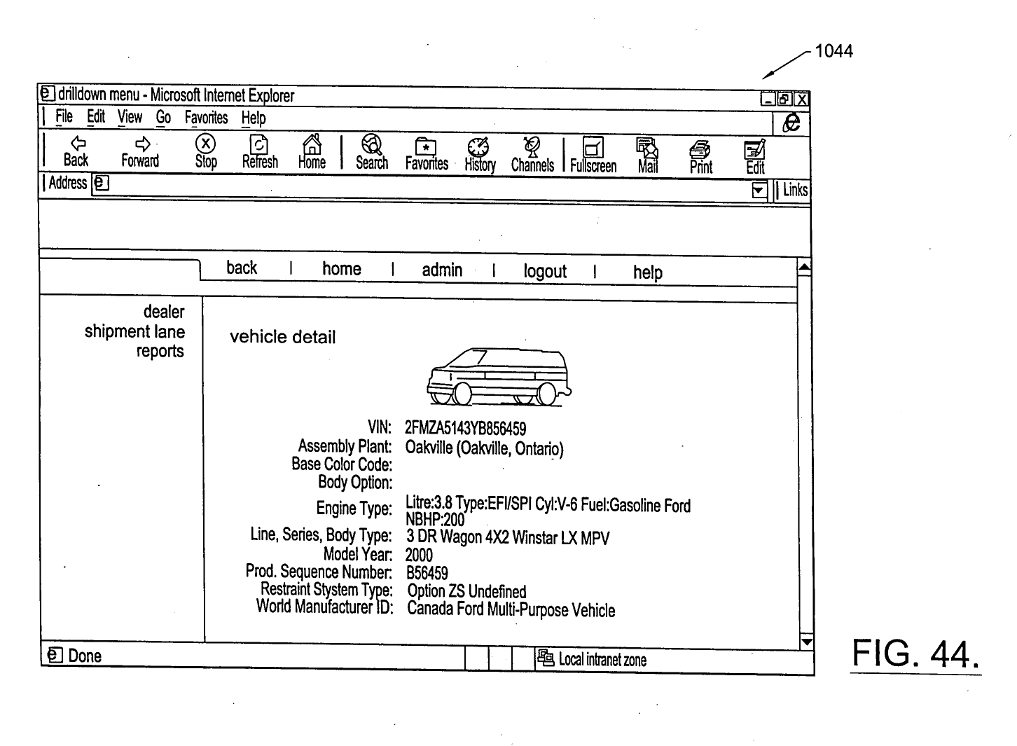

More details and examples of the output and uses of the vehicle tracking system 32 will be discussed later by way of example, particularly in conjunction with FIGS. 16-44.

Simulation Tool

The transportation system 10 of the present invention utilizes an operational/strategic planning tool that will allow the system and its managers to analyze its vehicle distribution network 20 each day as well as look out a number of days (for example, fourteen) into the future to determine if bottlenecks will appear in the network and where they will occur. In addition, this tool provides the ability to test changes to the existing vehicle distribution network “off-line” to determine what changes should be made to the network and the impact of making those changes. There is a benefit to simulating changes to the existing network and seeing the impact of those changes on service and cost. Examples of such changes are:
routings (origins, destinations, mixing centers, etc.)
mode of transportation (rail versus car hauler)
volume of vehicles demanded (dealer orders)
capacity changes (number of vehicles loaded/unloaded, parking capacity, vehicles per railcar or car hauler, etc.)
   The selected tool 38 is a computer simulation model of the vehicle distribution network, one acceptable program being the simulation model sold by Systems Modeling Corporation under the brand ARENA. It should be understood that several other simulation engines are readily available and can be utilized in connection with the present invention.

The following discussion will identify all parameters necessary to accurately develop a simulation model of a vehicle distribution network using the ARENA tool. It will clearly define the objective of the model, all assumptions, the model scope, the input and output data required, specific model logic, and model validation. Also described will be the definition of the model inputs, the definition of model outputs, and the definition of information required for validating that the model accurately represents the existing system.

Model Assumptions

There are a number of specific assumptions under which the model is built. These assumptions may change if the functionality of the model is expanded or contracted. The assumptions for an example of the model described below are as follows:

1. An alternate routing is considered a change in:
the mode of transportation (rail vs. car hauler)
the routing from the origin mfg. plant to destination ramp
the destination ramp
car hauler company

2. The input data describing the current system status will be accurate.

3. The time units used for the model will be days.

4. No human resource issues will be considered in this model.

5. This phase of the simulation model will not track empty railcars.

6. All holds on vehicles occur at either a manufacturing plant or a destination ramp.

7. No vehicles are loaded or unloaded between a mixing center and a destination ramp nor a manufacturing plant and a mixing center.

8. Once a vehicle is released from manufacturing its routing is locked. However, routings can be changed up until the vehicle is released from manufacturing.

9. All railcars are the same size and type at each manufacturing plant. There are two types—bi-level and tri-level.

10. All car haulers are the same size and type (53′ long).

11. The number of vehicles and railcars switchable each day is achieved at manufacturing plants.

12. All shipments of vehicles from a manufacturer or mixing center direct to a dealer via car hauler will be “black boxed.” However, the simulation assumes a 24-hr dwell time at the manufacturing plant and a 48-hr dwell time at the destination ramp (which could be a mixing center).

13. Vehicles are grouped by destination ramp at the manufacturing plant (origin).

14. Lanes are made up of segments from an origin manufacturing plant to a destination ramp.

15. Vehicles are in transit to a destination ramp within 24 hours of being released from production.

16. Initially, only one manufacturer's vehicles on the railcars will be considered.

17. There is one train per day that leaves a mixing center or manufacturing plant going to a destination.

18. Railcars will always be full.

19. Vehicles in the system will not be tracked by VIN#, but rather by simulation vehicle type (1-21).

20. Empty railcars and empty car haulers are always available at the manufacturing plant and mixing center.

21. The date that a VIN is associated with a railcar is the date the railcar leaves that location (origin manufacturing plant or mixing center).

22. All vehicles at one location with the same origin and destination that are associated with railcars will all be part of the same train.

23. Vehicles must be loaded onto a specific railcar type (bi-level or tri-level) at either the manufacturing plant or mixing center. Vehicles can only be transported on the type of railcar used at the plant they were produced.

24. The vehicle manufacturer only uses two car hauler companies.

System Description and Scope

The manufacturer's dealers place orders for vehicles. These orders go directly to the manufacturing plant that produces the particular vehicle ordered. The vehicle is produced, then shipped to the dealer as fast as possible. The modes of transportation used are railcars and car haulers. The vehicle delivery network is a “hub and spoke” network with four “mixing centers” located at strategic points in the U.S. for consolidating vehicles into railcars arriving from the manufacturing plants and creating “direct shipments” to destination ramps in other parts of the country.

The example of a vehicle distribution network described below will include the daily transportation of vehicles between 21 manufacturing locations, one mixing center (Kansas City), and the mixing center's 17 ramp destinations. Transportation to and from locations outside of this scope will not be tracked. Expanding the model is desirable, therefore the model should be constructed in a way to allow easy expansion of the model to include other locations. The flow chart of FIG. 5 represents the logical flow of vehicles in the model.

Model Input Data

The simulation model requires a large quantity of input data to minimize the assumptions used; otherwise the simulation model may not be validated and its output may be suspect. A separate simulation database (database 60 shown in FIG. 7) with the required data may be created and maintained. In addition to the simulation database, Microsoft Excel spreadsheet interface is provided to allow users to easily change rail and parking capacity as well as vehicle routings. Following is a list of the input data for the simulation model:
Simulation Vehicle Type (1-21)
The tracking system will provide simulation vehicle types (1-21) to the simulation database. Each of the 21 manufacturing plant produces a unique vehicle type. If necessary, the vehicle tracking system 34 will convert manufacturer vehicle types to simulation vehicle types.
Origin (Integer value of 1-21).
The tracking system will pass unique integer values representing all 21 origin ramps to the simulation database. Ifnecessary, the vehicle tracking system 34 will convert manufacturer origin alphanumeric assignments to the integer values.
Destination (Integer value of 22-75).
The tracking system passes unique integer values representing all 54 destination ramps to the simulation database. If necessary, the vehicle tracking system 34 will convert manufacturer destination ramp alphanumeric assignments to the integer values.
Mixing Center (Integer value of 76-79).
The tracking system passes unique integer values representing all 4 mixing centers to the simulation database.
Vehicle routing number (Integer value from Master Routing Table of 1-4,536).
A unique integer value is enteredfor all possible routings and alternate routings (4,536 possible routings) between the 21 origin manufacturing plants and the 54 destination ramps. An example of this table is shown in the Master Routing Table below. If necessary, the tracking system will convert manufacturer routing alphanumeric assignments to the integer values.
   Master Routing Table

(This is a list of all possible Lanes and Alternate Lanes.)

| | | | | | Mode to | | Mode to | | Mode to | | Mode to | | Mode to |
|---|---|---|---|---|---|---|---|---|---|---|---|---|---|
| Routing | Origin | Destination | Number | | Stop 1 | | Stop 2 | | Stop 3 | | Stop 4 | | Stop 5 |
| Number | 1(1-21) | (22-79) | of Stops | Stop 1 | (1-3) | Stop 2 | (1-3) | Stop3 | (1-3) | Stop 4 | (1-3) | Stop 5 | (1-3) |

| | | | | | | | |
|---|---|---|---|---|---|---|---|
| 1 | Detroit | San Diego, CA | 1 | San | Rail | | |
| | | | | Diego, CA | | | |
| 2 | Detroit | San Diego, CA | 2 | Fostoria | Rail | San Diego, | Rail |
| | | | | | | CA | |
| 3 | Detroit | San Diego, CA | 2 | Kansas | Hauler A | San Diego, | Hauler |
| | | | | City | | CA | A |
| 4 | Detroit | San Diego, CA | 1 | San | Hauler A | | |
| | | | | Diego, CA | | | |
| . . . | Detroit | San Diego, CA | 1 | San | Hauler B | | |
| | | | | Diego, CA | | | |
| n | | | | | | | |

Note:
Routing Number of 0 represents a vehicle on hold.
Note:
Mode 1 = rail
Mode 2 = car hauler A
Mode 3 = car hauler B

The Master Routing Table may be used to define all possible standard and alternate routings that vehicles could take to get from a manufacturing plant to a destination ramp. Each routing will contain the O-D pair as well as the number of intermediate stops between the origin and destination. If there are intermediate stops along the route, then each stop is entered in the table. This table only has to be created once and can be appended as routes change.
Current or last known location of vehicle along routing (intermediate stop).
The tracking system will pass the current or last known location of all vehicles already in the pipeline to the simulation database. This information is part of a Current Location Table shown below. This location must be a unique integer value (1-79) and represents an origin manufacturing plant, a mixing center, or a destination ramp. If necessary, the tracking system maintains a cross-reference table of these integer values and the corresponding manufacturer alphanumeric value.

Current Location Table

| | | | | | | | | | | | Railcar |
|---|---|---|---|---|---|---|---|---|---|---|---|
| Location | | | | | | | | | | | Unload |
| ID | | | | | | | | Actual | | | Flag |
| (origin, | Routing | | | | | Current | Expected | Departure | | | (1 = |
| MC, DR, | Number | | | | Quantity | Or Last | Departure Date | Date from | Expected | Actual | unload |
| railcar, | (from | Quantity | Quantity | | Of | Known | from Current | Last Known | Manufacturing | Manufacturing | and 0 = |
| or car | Master | of Type 1 | of Type 2 | | Type 21 | Location | Location | Location | Release Date | Release Date | don't |
| hauler) | Table) | Vehicles | Vehicles | . . . | Vehicles | (1-79) | (mmddyy) | (mmddyy) | (mmdd-y) | (mmddyy) | unload) |
| NIFG2 | 1 | 345 | 324 | | | 2 | Dec. 13, 1999 | | Dec. 12, 1999 | | 0 |
| MFG2 | 34 | 278 | | | 77 | 2 | 12113/99 | | Dec. 12, 1999 | | 0 |
| NIC4 | 23 | 142 | 34 | | | 79 | Dec. 13, 1999 | Dec. 03, 1999 | Dec. 01, 1999 | | 0 |
| MC4 | 28 | 355 | | | | 79 | Dec. 13, 1999 | Dec. 04, 1999 | Dec. 01, 1999 | Dec. 04, 1999 | 0 |
| MC4 | 34 | 76 | | | 113 | 79 | Dec. 13, 1999 | Dec. 05, 1999 | Dec. 01, 1999 | Dec. 04, 1999 | 0 |
| DR17 | 44 | 66 | 52 | | | 38 | Dec. 13, 1999 | Nov. 28, 1999 | Nov. 26, 1999 | | 0 |
| CarHauler | 5 | | | | 8 | 14 | | Dec. 08, 1999 | Dec. 07, 1999 | | 0 |
| 21 | | | | | | | | | | | |
| Railcar207 | 15 | | | | 76 | | Dec. 02, 1999 | Dec. 07, 1999 | | | 0 |

At the start of the simulation run, the current location of all vehicles in the system will be read in from the simulation database and tallied. This will be done for all valid routings of vehicles that are defined in the Master Routing Table.
Expected manufacturing release date of vehicle (from 1 January in mmddyy) format).
The tracking system passes this date to the simulation database in mmddyy format. It is part of the Current Location Table that contains the information on all vehicles currently in the system for a given day. An example of this table is shown above.
Actual manufacturing release date of vehicle already in pipeline (mmddyy format.).
The tracking system passes this date to the simulation database in mmddyy format. It is part of the Current Location Table that contains the information on all vehicles currently in the system for a given day. An example of this table is shown above. Note that this field is blank unless the actual release date is different than the planned release date of the vehicle. This date will override the planned release date.
Quantity of vehicles on each railcar or car hauler by vehicle type and routing number (Integer value).
The tracking system passes the total quantity of each simulation vehicle type on each railcar or car hauler and its routing number to the simulation database at the start of the simulation. The tracking system assigns a unique integer value to each of these railcars and car haulers and pass this to the simulation database as well. The tracking system tracks the routing number for each VIN in the model. This information is part of the Current Location Table above.
Railcar Unload Flag (Integer value of 0=don't unload and 1=unload). The tracking system passes either a zero (0) or one (1) to the simulation database for each railcar or car hauler that is carrying vehicles at the start of the simulation. This value will determine whether the railcar should be unloaded at the mixing center upon arrival. The railcar or car hauler ID will be a unique integer value assigned by the tracking system. This information will be part of the Current Location Table above.
Actual departure date from last known location (mmddyy format). The tracking system provides the date each railcar left from its last known location (origin or mixing center). This information will be part of the Current Location above.
Location and quantity of cars on hold (location will be an integer value 1-75).
The tracking system passes the total quantity of vehicles on quality hold at an origin manufacturing plant or destination ramp to the simulation database at startup. Cars on hold will have a routing number ofzero (0).
Usual number of railcars per train between origin and mixing center and mixing center and destination ramp (Integer value).

This number is based on historical data on the number of railcars that were allowed on a train for each combination of origin and mixing center (84 possible) and mixing center and destination ramp (216 possible). This information is contained in a table that the user can update. An example of this table is shown in the Number of Railcars Per Train Table below. This information provides a constraint on the number of railcars that can travel on one train between two points. Number of Railcars Per Train

| | | | | | 59 destinations (4 |
|---|---|---|---|---|---|
| | | Kansas | | | MCs, 54 DRs, & |
| | Fostoria | City | Dearborn | ***. | Dealers) |
| Fostoria | X | 80 | 100 | | |
| Kansas City | 80 | X | 90 | | |
| Dearborn | 100 | 90 | X | | |
| *** | | | | X | |
| 25 origins | | | | | X |
| (21 mfrs | | | | | |
| & 4 MCs) | | | | | |

Dealer orders for vehicles for the next 14 days by manufacturing plant and routing number.
Manufacturer provides all dealer orders for vehicles for the next 14 days ofproduction. These orders are at the VIN level. The tracking system “rolls up” these orders and pass the data to the simulation database as total quantity of vehicles ordered each day for each manufacturing plant by routing number. The user can override the maximum number of railcars and car haulers loaded as well as the load to delivery (LTD) percentage. An example of this data is shown in the Planned Orders from Dealers Table below.
   Planned Orders from Dealers

Day 1 (have 14 tables, one for each day, so that manufacturer can make changes on any day)

| | | | | | | | | | | | | | | |
|---|---|---|---|---|---|---|---|---|---|---|---|---|---|---|
| | Max | Max Car | | | | | | | | | | | | |
| | Railcars | Haulers | LTD % | | | Quantity | | Quantity | | Quantity | | Quantity | | Quantity |
| | Loaded | Loaded | Over- | Total | Rout- | For | Rout- | for | Rout- | for | Rout- | for | Rout- | For |
| Origin | Override | Override | ride | Produced | ing 1 | Routing 1 | ing 2 | Routing 2 | ing 3 | Routing 3 | ing 4 | Routing 4 | ing 5 | Routing 5 |

| | | | | | | | | | | |
|---|---|---|---|---|---|---|---|---|---|---|
| MFG1 | | 500 | 12 | 500.1- | | | | | | |
| MFG2 | | 600 | 34 | 300.″ | 2 | 100 | 10 | 100 | 77 | 100 |
| MFG3 | | 700 | 66 | 3%: ˜I˜ | 38 | 350 | | | | |
| *** | | 800 | 4 | 600′˜ | 1 | 200 | | | | |
| MFG21 | 0.5 | 900 | 8 | 300″ | 356 | 200 | 9 | 400 | | |

The transit time for a loaded railcar or car hauler to travel from a manufacturing facility (0) to a destination ramp (D). Each O-D pair will have a unique transit time.
The transit time for a loaded railcar or car hauler to travel from a mixing center (MC) to a destination ramp (D). Each MC-D pair will have a unique transit time.
The transit time for a loaded railcar or car hauler to travel from a manufacturing facility (0) to a mixing center (MC). Each O-MC pair will have a unique transit time.
The transit time for a loaded car hauler to travel from a manufacturing facility (0) to a local dealer within 250 miles.
The transit time for a loaded car hauler to travel from a mixing center (MC) to a local dealer within 250 miles.

Below is an example of transit times needed from a manufacturing plant to a destination ramp (i.e., O-D pairs) via railcar. Note that the first column will contain all 21 manufacturing plants and four mixing centers. The header row will contain the 21 manufacturing plants, four mixing centers, and the 17 destination ramps.

O-D Travel Time—Rail

(Enter all travel times in days.)

| | | | | | 59 destinations |
|---|---|---|---|---|---|
| | | Kansas | | | (4 MCs, 54 DRs, |
| | Fostoria | City | Dearborn | *** | & Dealers) |
| Fostoria | X | 2 | 2 | | |
| Kansas City | 2 | X | 3 | | |
| Dearborn | 2 | 3 | X | | |
| *** | | | | | |
| 25 origins | | | | | X |
| (21 mfrs & 4 | | | | | |
| MCs) | | | | | |

This same information will be needed for car hauler transit times, but the header row will also include one dealer representing all dealers within 250 miles of a manufacturing plant or mixing center. There will be two car hauler transit time tables to reflect the two car hauler companies that serve manufacturer.
Vehicle capacity at site (max number of parking spaces at manufacturing, mixing center, and destination ramp)
Railcar capacity at site (max number of railcars allowed at manufacturing, mixing center, and destination ramp)
Max number of railcars or car haulers loaded per day (at manufacturing and mixing center)
Max number of railcars or car haulers unloaded per day (at mixing center or destination ramp)
Number of vehicles per railcar
Number of vehicles per car hauler

Below is an example of a table for capacity information needed for each manufacturing plant:

Origin Capacity Information

| | | | | | | | | | | | |
|---|---|---|---|---|---|---|---|---|---|---|---|
| | | Vehicles | | Length of | Linear | | Max vehicle | Max railcars | Max vehicles | Max car | Deal |
| | Type of Railcar | per | Vehicles per | Vehicle | Feet of | Max | parking | loaded per | loaded per | haulers loaded | Dwel |
| Origin | (bi- or tri-level) | Railcar | Car Hauler | (feet) | Railcar | LTD % | capacity | day | day | per day | Time |

MFG1
MFG2
MFG3
MFG21

Below is an example of a table for capacity information needed for each mixing center:

Mixing Center Capacity Information

| | | | | | | | | | | | | |
|---|---|---|---|---|---|---|---|---|---|---|---|---|
| | | | Max | Max | | Max | | | | | | |
| | Max | Max | number | vehicle | Max vehicle | Railcars | Max | Max car | Max | Max | Max car | |
| | Number | number | of loaded | parking | parking | Loaded | vehicles | haulers | Railcars | vehicles | haulers | Dealer |
| Mixing | of | of loaded | car | capacity | capacity | per | loaded per | loaded per | unloaded | unloaded | unloaded | Dwell |
| Center | LTDs | railcars | haulers | (rail) | (hauler) | day | day | day | per day | per day | per day | Time |

MC1
MC2
MC3
MC4

Below is an example of a table for capacity information needed for each destination ramp:

Destination Ramp Capacity Information

| | | | | | | | |
|---|---|---|---|---|---|---|---|
| | | Max | | | | | |
| | Max | number | Max | Max | Max | Max car | |
| | number of | of loaded | vehicle | railcars | vehicles | haulers | Dealer |
| Destination | loaded | car | parking | unloaded | unloaded | unloaded | Dwell |
| Ramp | railcars | haulers | capacity | per day | per day | per day | Time |

DR1
DR2
DR3
***
DR17

Delivery network management and manufacturer should determine the amount of financial data needed to produce the desired model outputs. Some miscellaneous costs to consider are freight costs, divert costs, etc. The following costs are included:
Railcar cost per vehicle per day (railcar cost/vehicle/day)
Car hauler cost per vehicle per day (car hauler cost/vehicle/day)

Model Logic

Logic in the simulation model to allows the model to perform as close to reality as possible. Following is a list of logic that is part of the model.
1. Vehicles will be routed from an origin to a destination via a routing from the Master Routing Table. This routing will include mode of transportation and any intermediate stops along the way. The duration to get from an origin to a destination will be taken from the O-D Travel Time Table.
2. At the beginning of the simulation run, the status of the system will be read into Arena from the simulation database. This information will “load” the model with the current status or state of the vehicle distribution network. It will consist of the number of vehicles located at each point in the network that is included in the scope of the model. In addition, production orders for the next 14 days will be read into Arena. As these vehicles are produced over the 14-day period in the simulation, they will be assigned a routing from the Master Routing Table based on the origin and destination (O-D) pair. The simulation will use the O-D pairs and the duration times from the O-D Travel Time Table to move the vehicles through the network. For vehicles already in the pipeline as part of a train, the location of the railcar will be used as well as the date it left its last known position. Arena will subtract that time from the total duration time to determine the remaining duration to the destination ramp.
3. Alternate routings will be allowed. These alternate routings are part of the Master Routing Table.
4. Railcars that do not need to be unloaded at a mixing center (all vehicles are going to the same destination ramp) will “pass through” on the next train bound for that destination from the mixing center.
5. The Excel Interface permits changes in capacity information as described above.
6. Vehicles will be loaded on a first-in-first-out (FIFO) basis at the manufacturing plant.
7. Vehicles will be grouped by common destination ramp at the manufacturing plant before being loaded on a railcar or car hauler.
8. If a vehicle needs to be unloaded at the mixing center, all vehicles are removed from the railcar.
9. The number of vehicles per railcar and the number of vehicles moving to a common destination will determine the number of railcars per train. If there is a train restriction on the allowable number of railcars on a train, then railcars that exceed the train capacity will be held until the next train departs.
10. If a vehicle is diverted after already being loaded onto a railcar, then the entire railcar is diverted. It must be unloaded, then reloaded with the vehicles that were not diverted.
11. No railcars will move unless they are full.

Model Outputs

Specific output from the model will be used to measure the results of different scenarios. Management will use the results to determine the effectiveness of changes made to the vehicle distribution network. These outputs will be written to an Excel file to allow for better analysis. Following is a list of outputs (or measures) which the model will provide:
1. Cycle time from 21 manufacturing sites to 17 destination ramps.
2. Cycle time from 21 manufacturing sites to Mixing Center (Kansas City).
3. Cycle time from Mixing Center (Kansas City) to 17 destination ramps.
4. Number of vehicles delivered to each destination ramp.
5. Number of vehicles in transportation system at all times (including all inbound and outbound vehicles to a mixing center).
6. Number of vehicles at each manufacturing site.
7. Number of vehicles at Mixing Center (Kansas City).
8. Transit cost of vehicles in transit.
9. Freight cost (provided by network management and manufacturer).
10. Estimated number of car haulers used at each manufacturing plant.
11. Estimated number of car haulers used at each mixing center.
12. Estimated number of railcars used at each manufacturing plant.
13. Estimated number of railcars used at each mixing center.

Model Verification and Validation

The simulation model is verified and validated before scenarios can be run. Verification is the process of making sure the model is built the way it was intended. Validation is the process of making sure the model behaves according to reality. The simulation model is validated by its results to the historic performance of the vehicle delivery system.

Model Analyses (scenarios)

Once the simulation model is built and verified, an infinite number of scenarios (or experiments) can be run by altering model inputs. For each scenario, delivery network management and manufacturer study how the results (outputs) change based on changes made to the model inputs. This information is used in making planning decisions that increase the effectiveness and efficiency of the delivery network. Examples of such planning decisions include the choice of routing (lanes) for vehicles, and the order in which vehicles will be built.

By using the Excel Interface provided with the simulation model, management will be able to change specific inputs such as:
Number of vehicles loaded/unloaded per day per location.
Number of vehicles produced at each manufacturing plant and their routing number.
Vehicle type produced at each manufacturing plant.
Transit time between all origin-destination ramp (O-D) pairs.
Transit time between all mixing center-destination ramp (MC-D) pairs.
Transit time between all origin-mixing center (O-MC) pairs.
Transit time between all origin-dealer pairs within 250 miles.
Transit time between all mixing center-dealer pairs within 250 miles.
Add routings to the Master Routing Table.
Number of vehicles that can fit on a railcar and car hauler by simulation vehicle type.
Parking capacity at all manufacturing plants, mixing centers, and destination ramps.
Rail capacity at all manufacturing plants, mixing centers, and destination ramps.
Time of rail switch by location (1-79).
Costs (freight, rail, car hauler, divert, etc.).

Animation

Using Arena animation of the model can be displayed representing the movement of trains from the 21 manufacturing facilities to the 17 destination ramps, via the Kansas City mixing center. In addition, all model outputs listed above are displayed on the screen during the simulation run as status variables. This is known as scoreboard animation. A bitmap image of the U.S., with all manufacturing plants, mixing centers, and destination ramps, is used as a “backdrop” for the animation.

The model contains a menu system to help the user move about the screen to view different parts of the animation, system status variables, or actual model logic. There also is a direct link with the Excel Interface to allow the user to change input variables to run different scenarios.

Modification of the Model

Further input data may be passed to the model to allow other functionality, such as simulating the effects of blocking at manufacturing plants (loading vehicles on railcars based on destination ramp). The goal of such functionality would be to reduce the number of railcars that need to be uncoupled during transit from the manufacturing plant to the destination ramp, thereby reducing transit time further. Other additional functionality may include:
1. Adding or removing manufacturing plants and mixing centers.
2. Tracking empty railcars throughout distribution network.
3. Allowing alternate routings with effective and termination dates.
4. Allowing mixed loads (vehicles from different manufacturers) on railcars.
5. Adding data on loading practices at the manufacturing plant (such as practices to reduce vehicle handling).
6. Adding data on train make-up (such as practices to reduce the switching and shunting times).
   Operation of the Delivery System

As should be apparent from the foregoing description, components of the vehicle delivery system 10 interact, and in particular share raw and/or processed data which is then used in carrying out the functions of each component. For this reason, the operation of the data flow network 30 is interactive, rather than linear, and while the delivery of a vehicle in the distribution network 20 can be described from manufacturer to dealer, events along the way are monitored, recorded, and tracked for use in operation of the overall system. Thus, there is no critical starting point in the following description of the operation of the system.

Tracking and Associated Data Collection

At this point further exemplary views, reports, etc., will be discussed as examples of ways in which the Tracking Application may be used.

The following section provides a discussion of the vehicle tracking system 34 features primarily from the standpoint of the end user in the field, namely, the Dealers, Ramp Managers and Lane Managers.

The Vehicle Tracking System Features

As discussed in at least part detail above, the Vehicle Delivery System 34 offers the following features, based on the permissions of the particular user profile.

| Feature | Description |
|---|---|
| Dealer Tracking | See all vehicles that are expected to arrive at a |
| | dealership on a particular date. |
| | See all vehicles that are expected to arrive at a |
| | dealership on a particular date, according to model. |
| | See the revised arrival date for a vehicle expected at a |
| | dealership on a particular date. |
| | See how late a vehicle is in arriving at a dealership. |
| | See the current location of a vehicle expected at a |
| | dealership on a particular date. |
| Ramp Tracking | See all vehicles that are expected to arrive at a ramp on |
| | a particular date. |
| | See all vehicles that are expected to arrive at a ramp on |
| | a particular date, according to model. |
| | See the revised arrival date for a vehicle expected at a |
| | ramp on a particular date. |
| | See how late a vehicle is in arriving at a ramp. |
| | See the current location of a vehicle expected at a ramp |
| | on a particular date. |
| Lane Tracking | See all vehicles that are expected to arrive at the |
| | destination point of a lane on a particular date. |
| | See all vehicles that are expected to arrive at the |
| | destination point of a lane, according to model. |
| | See the revised arrival date for a vehicle expected at |
| | the destination point of a lane on a particular date. |
| | See how late a vehicles is in arriving at the destination |
| | point of a lane. |
| | See the current location of a vehicle expected at the |
| | destination point of a lane on a particular date. |
| Placing a Vehicle on | When the user drills down to the status events for a single VIN, |
| Hold | the user can insert a Hold event, so that the vehicle does not |
| | proceed further. |
| Search | The user can search for a vehicle within one of the views. For |
| | instance, if the user searches for a vehicle within the view for a |
| | dealer, the search is limited to vehicles destined for that |
| | dealership. |
| | Search criteria includes: VIN, model, year of vehicle, date or |
| | date range, and event status. |
| Vehicle Descriptions | The user can see a description for any vehicle in the system. |
| | The vehicle detail includes body type, chassis type, various |
| | engine characteristics, and the restraint system. |
| Reports | Design the user's own report for repeated use, or use one of the |
| | standard Vehicle Tracking System reports. |

Introduction to Vehicle Tracking System Views

When a user enters the vehicle tracking system 34 application, the user has access to one or more of the following views for getting description and status information about vehicles:

| View | Description |
|---|---|
| Dealer | For a given date, this view shows what vehicles are initially |
| | projected for arrival at a particular dealership. |
| | A revised date may also appear for the vehicle's arrival at the |
| | dealership. |
| | The user can inquire further to see the entire status detail for |
| | a vehicle. |
| Ramp | This view shows all vehicles destined for a particular ramp, |
| | according to the original projected date and lane. |
| | A revised date may also appear for the vehicle's arrival on |
| | the ramp. |
| | The user can inquire further to see the entire status detail for |
| | a vehicle. |
| Lane | This view shows all vehicles that are being transported along |
| | a particular lane, according to the original destination date |
| | for the end point of the lane. |
| | A revised date may also appear for the vehicle's arrival at the |
| | end point of the lane. |
| | The user can inquire further to see the entire status detail for |
| | a vehicle. |

Viewable Items Onscreen

Under one embodiment of the invention, when the user accesses vehicle tracking system 34 though the login screen, the Viewable Items Screen is shown. Depending on the job requirements of the user, the user will see a list of hyperlinks for one or more of these categories:
Dealers
Ramps
Lanes

Reference is now made to FIG. 16, which shows a Viewable Items screen for a user with access to all three categories.

Dealer, Ramp and Lane Searches

As noted above the user can conduct various searches. Under one embodiment of the invention the outcome may differ depending on who the user is.

| When the user selects Search in . . . | the search looks for vehicles . . . |
|---|---|
| Dealer View (a dealer selected) | scheduled for arrival at the |
| | dealership on the date(s) that the |
| | user specifies. |
| Ramp View (a ramp selected) | scheduled for arrival the ramp on |
| | the date(s) that the user specifies. |
| Lane View (a lane selected) | schedule to arrive at the lane's end |
| | destination on the date(s) the user |
| | specifies. |

Vehicle Status Information

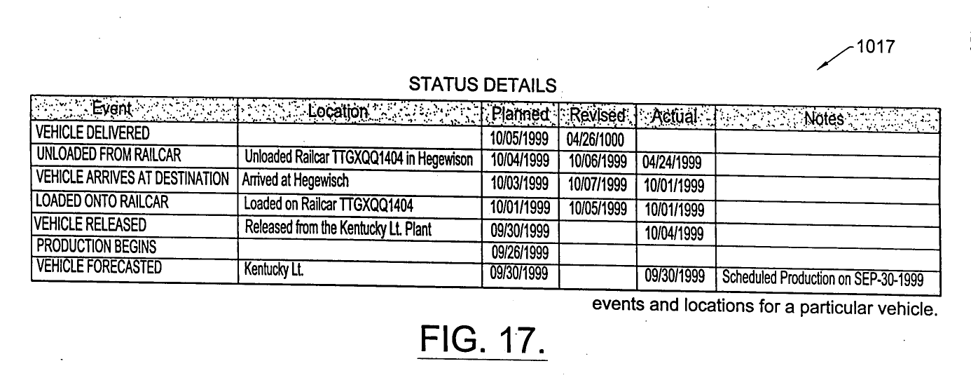

The tracking system 34 enables a user to see the current status of a vehicle in terms of the events that occur between production and shipment of a vehicle to a dealership. As discussed in detail later, the user can track each vehicle though all its status checkpoints as shown in the status details chart of FIG. 17.

Navigation for Dealer, Ramp, and Lane Views

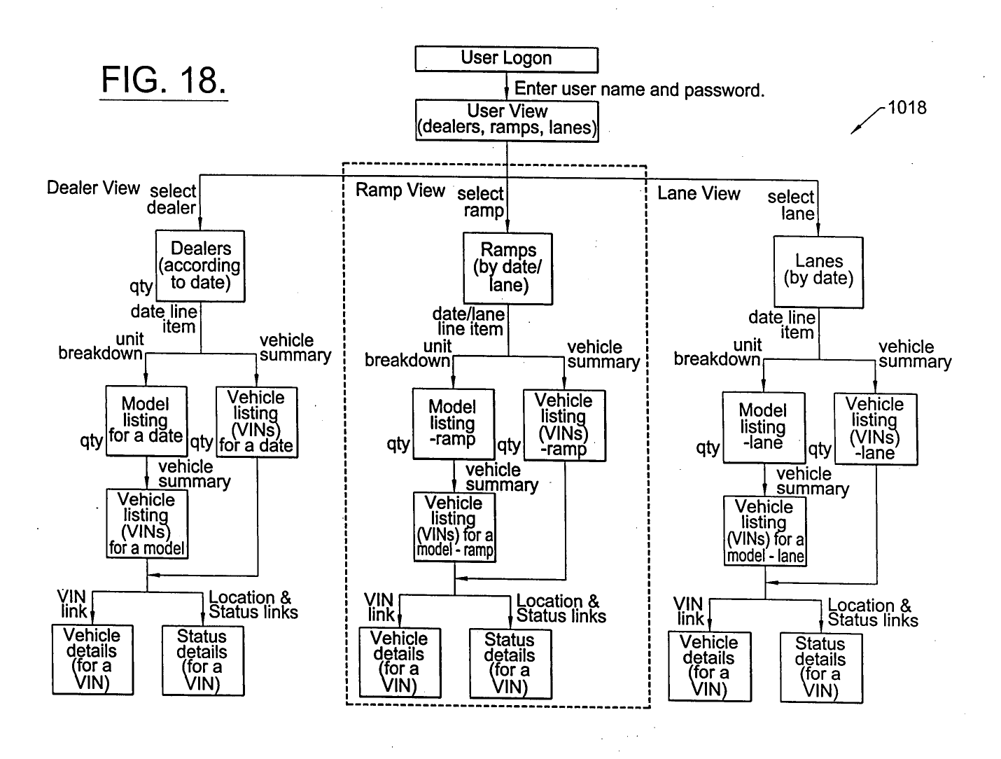

Reference is now made to FIG. 18, which illustrates how the user can navigate within the Dealer, Ramp, and Lane views.

Dealer View

This section describes how a user can check status information and descriptions for vehicles destined for arrival at a dealership.

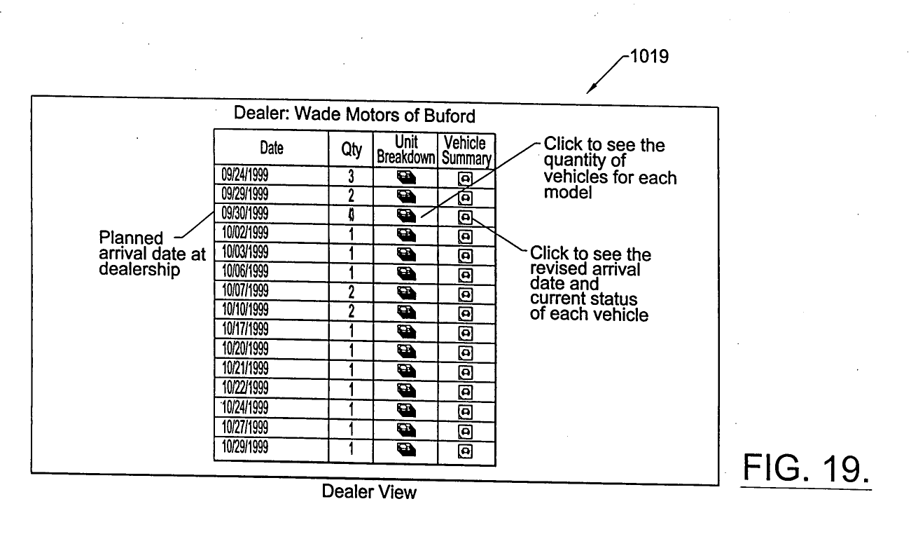

To see the view for a dealer (in this case Wade Motors at Buford), the user clicks a dealer name on the Viewable Items screen. A table similar to that shown in FIG. 19 is displayed.

This “Dealer View” shows the quantity of vehicles that were originally planned to arrive at the dealership for each date listed. The following options are available in the Dealer View:
See the quantity of vehicles for a date according to model (click the Unit Breakdown icon).
See the revised arrival date and current status of each vehicle for a date (click the Vehicle Summary icon).
See the entire status table of events for a particular vehicle (click the Vehicle Summary icon, then click the status location).
   Accessing the Unit Breakdown

To see the quantity of vehicles originally planned for delivery at the dealership according to model, the user goes to the row for a specific date and clicks the icon in the Unit Breakdown (a.k.a. Model Summary) column. A screen appears similar to that shown in FIG. 20, which lists a Model column, a Quantity column, and a Vehicle Summary column.

The Unit Breakdown of FIG. 20 shows the user the quantity of models originally planned for arrival on a specific date at a dealership. The Unit Breakdown includes the following:
1) Model
2) Quantity (quantity for a particular model)
3) Vehicle Summary (a link to more detailed information about vehicles for a particular model)
   Unit Breakdown Options

The user has the following options in the Unit Breakdown:
1) See the revised arrival date and current status of each vehicle for a date (click the Vehicle Summary icon).
2) See the entire status table of events for a particular vehicle (by clicking the Vehicle Summary icon, and then clicking the status location).
   Accessing the Vehicle Summary

The user can see a list of vehicles with the current status and revised arrival date at the dealership, by going to the row for a specific date and clicking the Vehicle Summary icon, either in the Dealer View or in the Unit Breakdown.

The Vehicle Summary for the Dealer View (FIG. 21) lists all vehicles originally planned to arrive at the dealership on a specific date. The Vehicle Summary includes the following:
VIN (partial VIN, VIN column)
Vehicle model (Model column)
Year of the vehicle (Year column)
Planned date of arrival at dealership (Planned Arrival)
Revised date of arrival at dealership, when applicable (Revised Arrival column)
Current Location of the vehicle (Location column)
On-schedule indicator (traffic light in Status column). When lit, green is on time, yellow is one date late, and red is two days late.
   Vehicle Summary Options

The user has the following options in the Vehicle Summary:
1) Seeing a description of a vehicle (by clicking the VIN).
2) Seeing the entire status table of events
   Accessing Status Details

To see all status events for a vehicle, go to the vehicle in question on the Vehicle Summary and click the current status item in the Location column. This provides the Status Details screen display as shown in FIG. 22.

This vehicle Status Details screen for the Dealer View shows all status information concerning a particular vehicle on its way to the dealership. Status Details includes the following:
A standard event that involves production or transport of the vehicle
Location information tied to the vehicle event
The original date planned for the event to occur
The revised date for the event to occur
The date when the event actually occurred
Any notes associated with the event
   Vehicle Status Updates

For the standard sequence of events necessary to get a vehicle to its final destination, the vehicle tracking system 34 updates a vehicle's status in the following ways:
Planned dates are assigned to events when a vehicle is determined to be “shippable” at the assembly plant.
Revised dates are assigned to events when the vehicle leaves the mixing center.
An actual date is assigned to an event after the event has occurred.
   Status Details, Put Vehicle on Hold

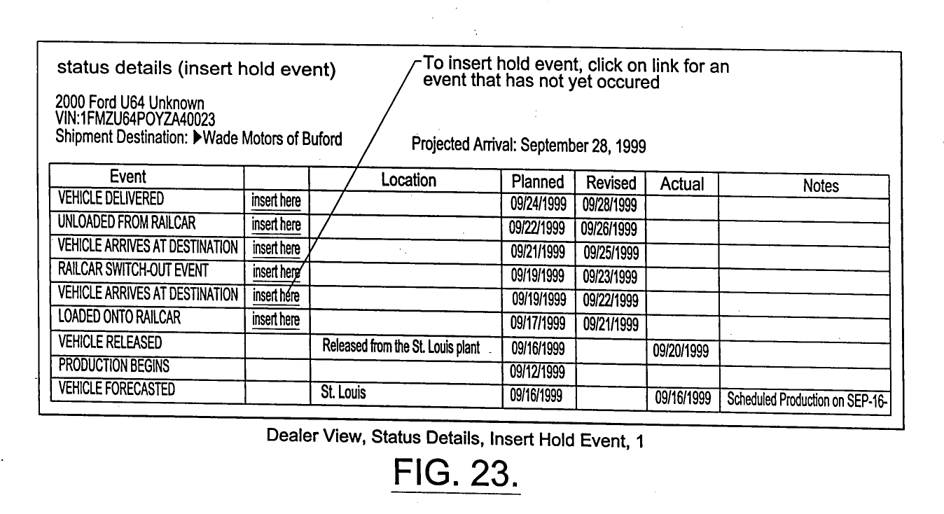

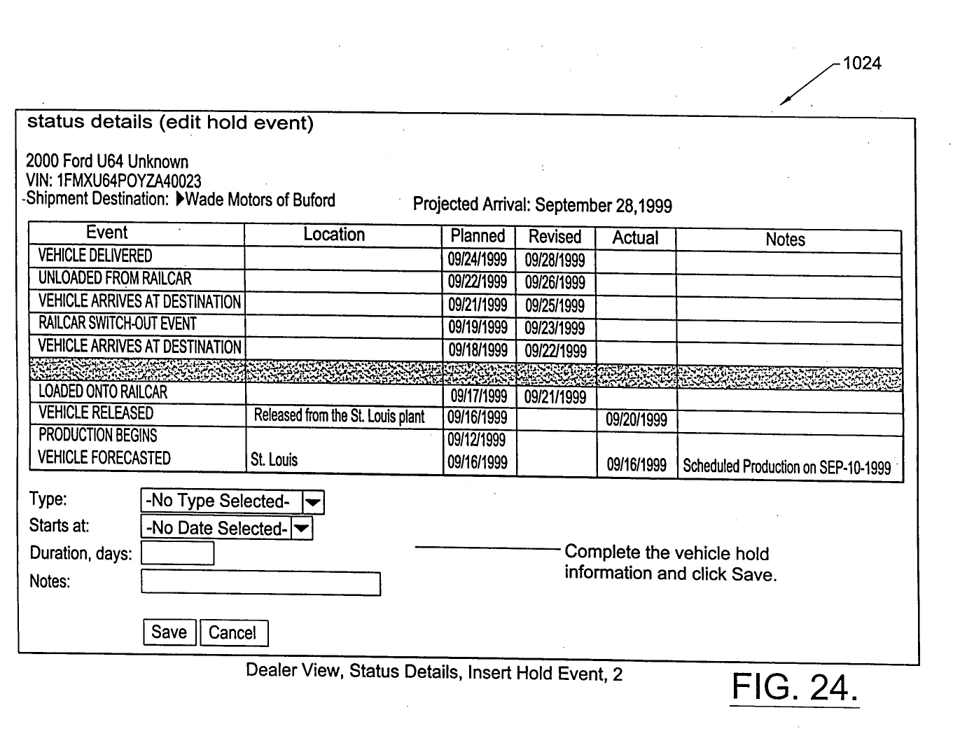

The Status Details screen, if the user has permission to do holds, the user can place the vehicle on hold by doing the following:
1. Select put on hold on the side navigation bar. This brings up the screen shown in FIG. 23.
2. Click the insert here link for the event at which the user is stopping transport of the vehicle as shown in FIG. 24, a blank line appears for the new hold event the user is creating.
3. In the boxes below, select the type of event, the start date for the event, the duration of the event, and any applicable notes. The user should click Save when finished.
   Searching for a Vehicle

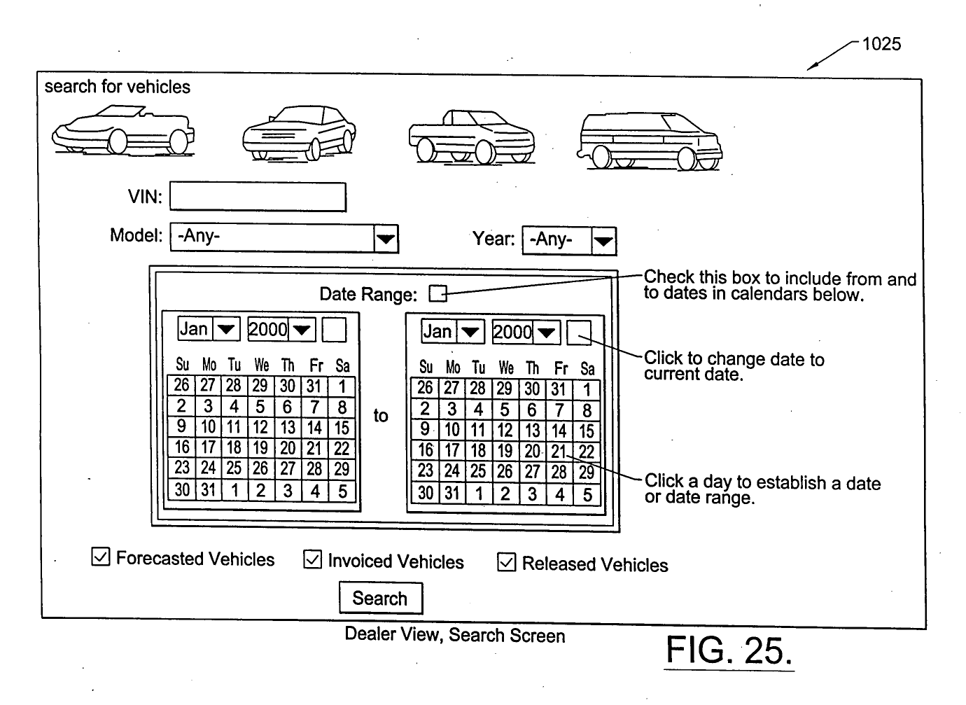

When the user does a vehicle search while in Dealer View, under one embodiment the search only involves those vehicles associated with delivery to that dealer. To search for a vehicle planned for arrival at a dealership, the user does the following:
1. Select a dealer on the Viewable Items screen.
2. Click Search on the side navigation bar. FIG. 25 is displayed.
3. Enter the search criteria the user wants.
   Search Options

The Search screen has the following options to narrow the search:

| Option | Description |
|---|---|
| VIN | Enter the 17-character VIN or any part of it: beginning, middle, end. |
| Model | Select a model from the drop-down list or accept Any. |
| Year | Select year of the vehicle from the drop-down list or accept any. |
| Date/Date Range | Select the month and year pertaining to the status of the vehicle |
| | destined for the dealership. Then select a day in the calendar on the |
| | left, or select a date range by clicking a day in both the from |
| | calendar and to calendars. |
| Vehicle Status | Forecasted Vehicles - Vehicles that have the Vehicle Forecasted |
| | event as the last occurring event. The date/date range that the user |
| | specifies is matched to the vehicle-forecasted date. A vehicle is |
| | forecasted for a release date. |
| | Invoiced Vehicles - Vehicles that have the Production Begins event |
| | as the last occurring event. The date/date range that the user |
| | specifies is matched to the production-begins date. A vehicle is |
| | invoiced when production begins. |
| | Released Vehicles - Vehicles that have the Vehicle Released event |
| | as the last occurring event. The date/date range that the user |
| | specifies is matched to the vehicle-released date. A vehicle is |
| | “released” when it begins transport from the plant. |

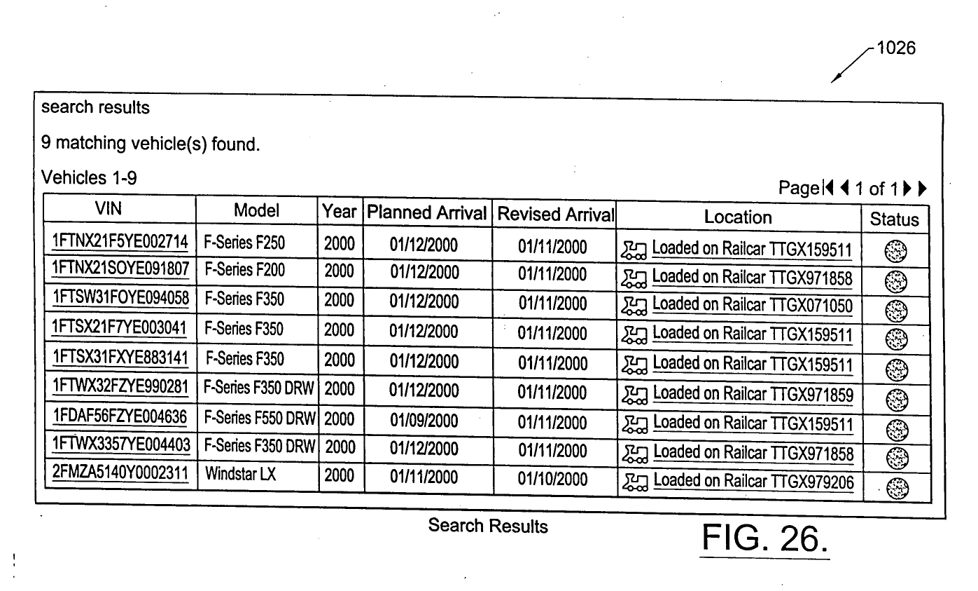

Exemplary results are shown on FIG. 26.

Accessing Vehicle Detail

The vehicle tracking system 34 provides a description of each vehicle in the system. This information is derived from the VIN.

To access detail for a vehicle, the user clicks the vehicle identification number (VIN) for a vehicle on a Status Detail screen. FIG. 27 shows an example of Vehicle Detail.

Ramp View

This section describes how the user can check status information and descriptions for vehicles destined for arrival at a dealership.

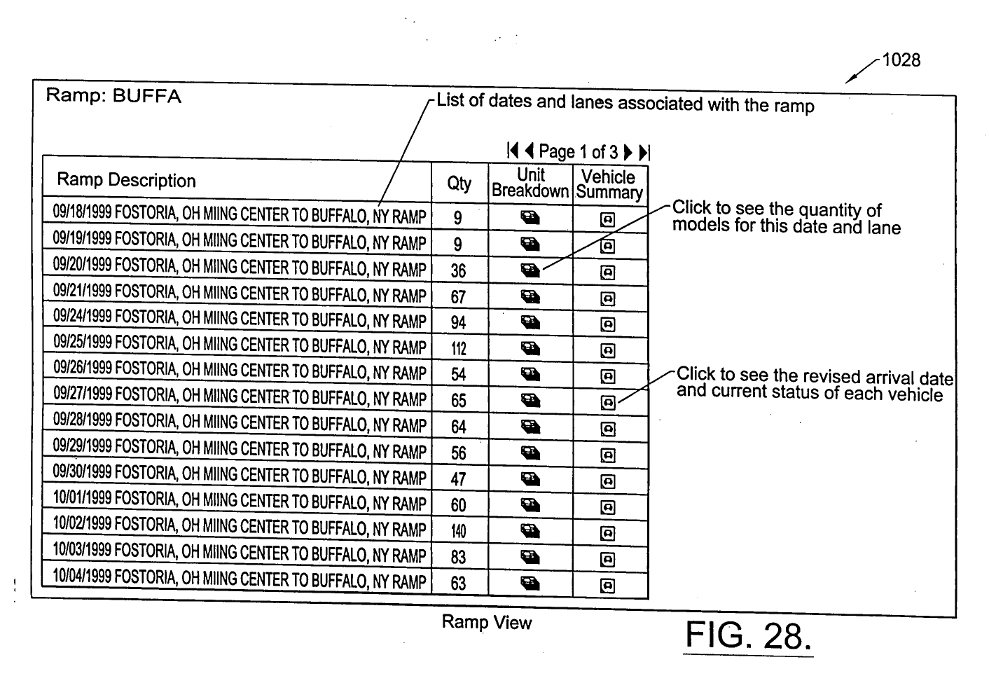

To see the view for a ramp, click a ramp name on the Viewable Items screen. A table similar to that shown in FIG. 28 following is displayed. This “Ramp View” shows the quantity of vehicles that were originally planned to arrive at the ramp for each date listed.

The user has the following options in the Ramp View:
See the quantity of vehicles for a date according to model (click the Unit Breakdown icon).
See the revised arrival date and current status of each vehicle for a date (click the Vehicle Summary icon).
   Accessing the Unit Breakdown

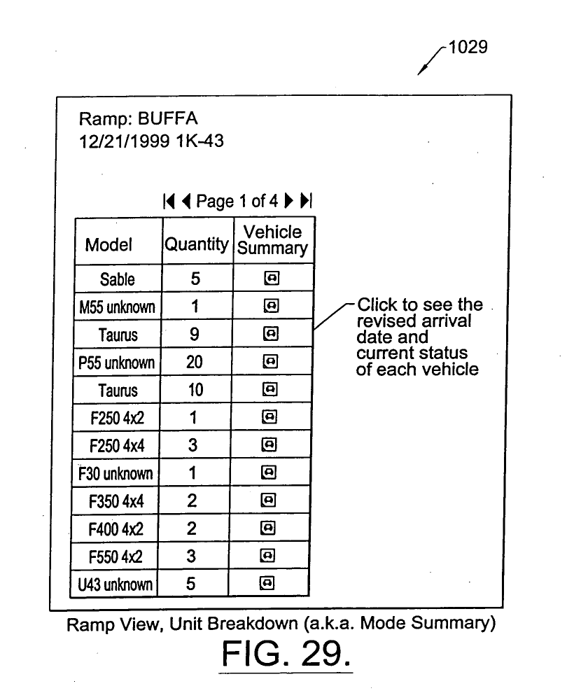

To see the quantity of vehicles originally planned for delivery at the ramp according to model, the user should go to the row for a specific date and click the icon in the Unit Breakdown column. A screen such as in FIG. 29 appears.

The Unit Breakdown (FIG. 29) shows the user the quantity of models originally planned for arrival on a specific date at a ramp. The Unit Breakdown (a.k.a., Model Summary) includes the following:
Model
Quantity (quantity for a particular model)
Vehicle Summary (a link to a more detailed information about vehicles for a particular model)

The user has the following options in the Unit Breakdown:
See the revised arrival date and current status of each vehicle for a date (click the Vehicle Summary icon).
See the entire status of table of events for a particular vehicle (click the Vehicle Summary icon, then click the status location).
   Accessing the Vehicle Summary

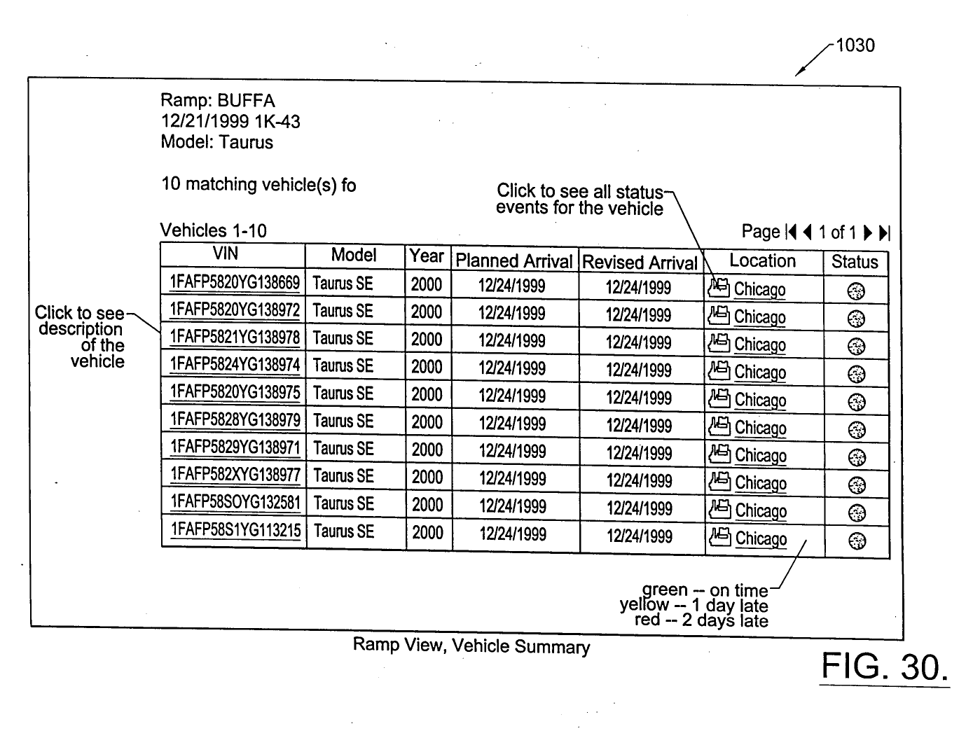

To see a list of vehicles with the current status and revised arrival date at the dealership, the user should go to the row for a specific date and click the Vehicle Summary icon, either in the Ramp View or in the Unit Breakdown. FIG. 30 is shown.

The Vehicle Summary for the Ramp View lists all vehicles originally planned to arrive at the ramp on a specific date.

As may be seen, the Vehicle Summary includes the following:
VIN (partial VIN, VIN column)
Vehicle model (Model column)
Year of the vehicle (Year column)
Planned date of arrival at ramp (Planned Arrival)
Revised date of arrival at ramp, when applicable (Revised Arrival column)
Current location of the vehicle (Location column)
On-schedule indicator (traffic light in Status column). When lit, green is on time, yellow is one day late, and red is two days late.
   Vehicle Summary Options

The user has the following options in the Vehicle Summary:
See a description of a vehicle (click the VIN).
See the entire status table of events for a particular vehicle (click the status location).
   Other Views

It should be understood that similar Status Details Views, Hold procedures, search functions, and Vehicle Detail access is similar to those discussed in Dealer views.

Lane View

This section described how the user can check status information and descriptions for vehicles associated with a lane.

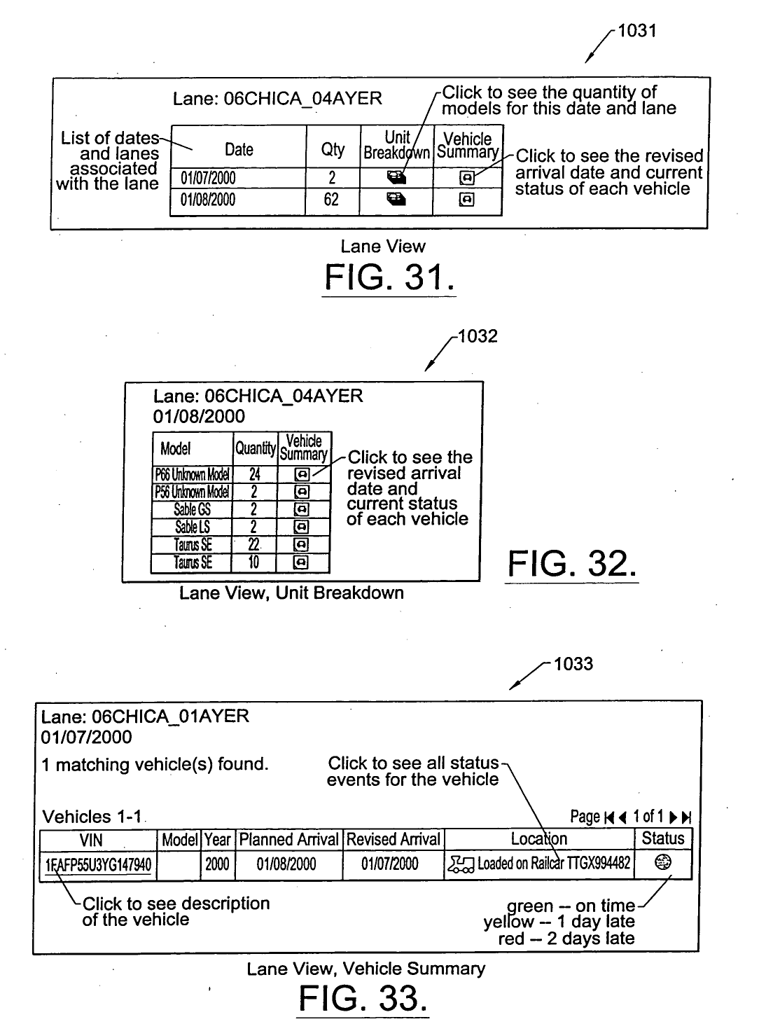

To see the view for a Lane, the user clicks a ramp name on the Viewable Items screen. A table similar to FIG. 31 is displayed.

The Lane View shows the quantity of vehicles that were originally planned to arrive at the lane's end destination for each date listed.

The user has the following options in the Lane View:
See the quantity of vehicles for a date according to model (click the Unit Breakdown icon).
See the revised arrival date and current status of each vehicle for a date (click the Vehicle Summary icon).
   Accessing the Unit Breakdown

To see the quantity of vehicles originally planned for delivery at the lane's end-destination according to model, the user goes to the row for a specific date and click the icon in the Unit Breakdown column. A screen appears similar to FIG. 32.

The Unit Breakdown shows the user the quantity of models originally planned for arrival on a specific date at the end destination (ramp). The Unit Breakdown includes the following:
Model
Quantity (quantity for a particular model)
Vehicle Summary (a link to more detailed information about vehicles for a particular model)

The user has the following options in the Unit Breakdown:
See the revised arrival date and current status of each vehicle for a date (click the Vehicle Summary icon).
See the entire status table of events for a particular vehicle (click the Vehicle Summary icon, then click the status location).
   Accessing the Vehicle Summary

To see a list of vehicles with the current status and revised arrival date at the dealership, the user goes to the row for a specific date and click the Vehicle Summary icon, either in the Ramp View or in the Unit Breakdown. FIG. 33 is then shown.

The Vehicle Summary for the Lane View lists all vehicles originally planned to arrive at the lane's end destination on a specific date.

The Vehicle Summary (FIG. 33) includes the following:
VIN (partial VIN, VIN column)
Vehicle model (Model column)
Year of the vehicle (Year column)
Planned date of arrival at ramp (Planned Arrival)
Revised date of arrival at ramp, when applicable (Revised Arrival column)
Current location of the vehicle (Location column)
On-schedule indicator (traffic light in Status column). When lit, green is on time, yellow is one date, and red is two days late.
   Vehicle Summary Options

The user has the following options in the Vehicle Summary:
See a description of a vehicle (click the VIN).
See the entire status table of events for a particular vehicle (click the status location).
   Accessing Status Details

To see all status events for a vehicle, the user goes to the vehicle in question on the Vehicle Summary and click the current location item in the Location column.

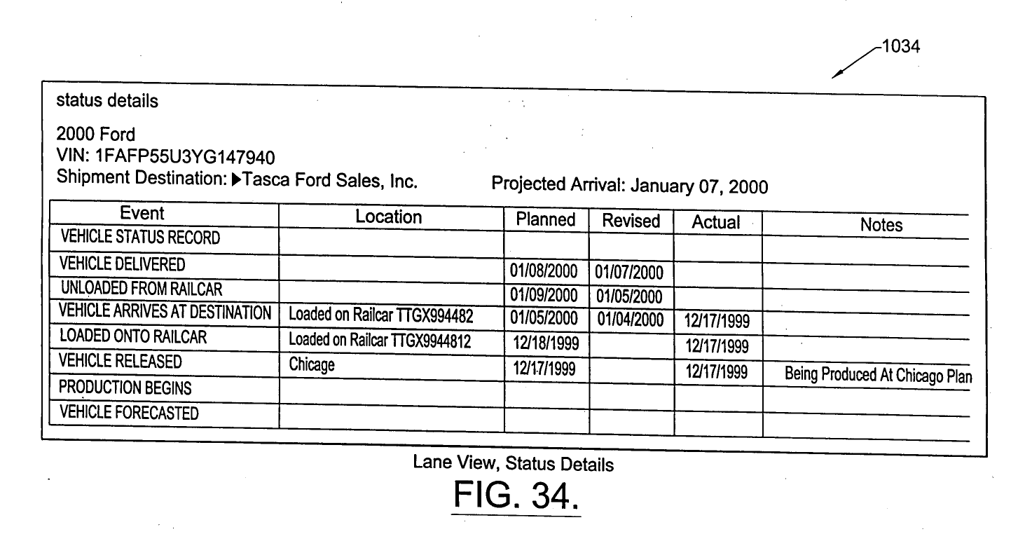

The vehicle Status Details screen for the Lane View (FIG. 34 is shown) shows all status information concerning a particular vehicle on its way to the dealership.

Status Details includes the following:
A standard event that involves production or transport of the vehicle
Location information tied to the vehicle event
The original date planned for the event to occur
The revised date for the event to occur
The date when the event actually occurred
Any notes associated with the event
   Other Views

Vehicle Status Updates, Hold techniques, searches, and vehicle detail access procedures are again similar to those discussed with respect to the Dealer views.

Reports

This section shows the user how to use Query Builder to design the user's own Vehicle Tracking System report.

To access Query Builder to design the user's own report, the user does the following:
1. Goes into Vehicle Tracking System and click Reports on the left navigation bar. The Report Builder main screen appears.
2. Clicks Query Builder. The Query Builder screen appears.
   Report Information

Query Builder enables the user to design the user's own reports based on the following Vehicle Tracking System information:

| Entity | Attributes for Entity |
|---|---|
| Area | Area ID |
| | Name |
| | Zone ID |
| Assembly Plant | Name |
| | Plant Code |
| Dealer | City |
| | County |
| | Dealer Code |
| | Dealer Name |
| | FIPS |
| | SPLC Code |
| | State |
| | Street Address |
| | Zip |
| Lane | Description |
| | Destination |
| | Lane ID |
| | Origin |
| Lane Segments | Duration |
| | Segment Name |
| | Segment Order |
| Ramp | Area ID |
| | Mnemonic |
| | Plant Code |
| | Ramp Code |
| | State |
| Vehicle | Base Color Code |
| | Body Option |
| | Dealer Code |
| | Destination Ramp Code |
| | Emission Indicator |
| | Estimated Delivery Date |
| | Estimated Production Date |
| | Last Status |
| | Model Year |
| | Plant Code |
| | Plant Ramp Code |
| Zone | Name |
| | Zone ID |

Designing a Report

To design a report, the user does the following:
1. Choose an option in the drop-down box for the basis of the query and click Continue. The user's choice appears at the top of the screen, next to Entity, and the next list of options appears.
2. Select an attribute from the drop-down list and click Continue. A search criteria screen is displayed that allows the user to specify a range of limitation for the attribute.
3. Specific the starting point of the search (in this case associated with “Zip”) and click Continue. The Report Editor for formatting controls appears.
   Some attributes bring up a numeric search criteria screen, such as the one below. The user can then specify a range of numbers.
4. Accept the report as it is, clicking Save Report or Use Report, or continue to design this report by changing the page orientation or by clicking Column Editor.
   Column Editor allows the user to add more columns with related information.
5. Use the Column Editor to add more columns and do column formatting, then click Accept. The user return to the Format Editor with the changed displayed.
6. The user can click either Save Report or Use Report, after reviewing the column formatting for the report.
7. When the user selects Save Report, the user can enter a report name and description, then click Save.

The user returns to the Report Editor screen. The report the user designed will appear as a report option on the Predefined Reports screen.
8. To generate the report immediately, click Use Report. The Generate Report screen appears.

Make any changes the user wants to make to the fields, then scroll down the page to specify output parameters for the report.
9. Specify how the user wants the report produced and what to do with it. The user clicks Go to output the report.
   Output Format Options

The following options are available in Query Builder for a report's output format.

| Option | Description |
|---|---|
| HTML, Single page | Places entire report on one HTML page, so that the user |
| | only has to scroll down to see entire report. |
| HTML, Paginated | Separates the report into pages. Enter a number in the |
| | Records per page box to specify number of records. |
| HTML, Records per page | When the user selects Paginated, enter the number of |
| | records to be contained on each page. |
| PDF | Makes the report a PDF file. A PDF viewer (Adobe) must |
| | be installed to view the PDF formatted results |
| Text, Display in browser | The user should select one of the following: display in |
| | browser, download to local machine, e-mail to xxx. The |
| | report displays directly in the browser, like Microsoft |
| | Explorer or Netscape. The user can then print the report. |
| Text, Download to local | The user should select one of the following: display in |
| machine | browser, download to local machine, e-mail to xxx. |
| | Downloads and allows the user to save it as a text file on |
| | the user's computer. |
| Text, E-mail to . . . | The user should select one of the following: display in |
| | browser, download to local machine, e-mail to xxx. |
| Text, Comma delimited | Separates the items on the report rows with a comma. |
| Text, Tab delimited | Separates the items on the report rows with a tab space. |
| Text, Specify delimiter | Separates the items on the report by the character that the |
| char._{———} | user specifies. |
| Text, First row headers | Adds the header names at the top of the page. |
| Text, new lines | This check box should be selected the user is working on a |
| | Unix machine, to adjust the line feed (carriage return or |
| | Unix line feed only). |
| Text, Apply formatters | This check box should be selected to indicate that the user |
| | wants a character formatter carried forward to the output |
| | (example, $). See the Formatter field on the Report |
| | Column Editor screen. |
| Text, No surrounding | Report items are not enclosed by quotation marks. |
| quotes | |
| Text, Double quotes | Report items are enclosed by double quotation marks. |
| Text, Single quotes | Report items are enclosed by single quotation marks. |
| Specify surrounding char. | Report items are enclosed by the character that the user |
| | specifies. |

Predefined Reports

This section describes the reports that are available with vehicle tracking system 34, Phase 1.

To access the Origin Ramp Report, the user does the following:
1. Goes into The Vehicle Tracking System and click Reports on the left navigation bar. The Report Builder main screen appears.
2. Click Predefined Reports. The Predefined Report screen appears.
3. Click the Planning arrow, the click Origin Ramp. The Generate Report screen for the Origin Ramp Report appears.

The Origin Ramp Report lists all vehicle status information according to the origin ramp the user specifies.

When the user has accessed the Origin Ramp Report, complete the following information:
1. Enter the number of records to include in the report (Fetch Limit).
2. Enter an origin ramp code (Input Value: Origin Ramp Code).
3. Define the date range for vehicle release date(s) the user wants (Input Value: Release Date Range Start and Release Date Range End).
4. Select the output format for the report (HTML, PDF, Text), including any options the user prefers and click Go. See Output Format Options for more explanation of options.
   Introduction to the No Start VINs Report

The No Start VINs Report lists all vehicles that have been released from the plant as the last recorded status.

Accessing the No Start VINs Report

To access the No Start VINs Report, the user does the following:
1. Goes into The Vehicle Tracking System and click Reports on the left navigation bar. The Report Builder main screen appears.
2. Clicks Predefined Reports. The Predefined Report screen appears.
3. Clicks the Expediting arrow, then click No Start VINs. The Generate Report screen for the No Start VINs Report appears.
   Using the No Start VINs Report

When the user has accessed the No Start VINs Report, the user then completes the following information, by:
1. Entering the number of records to include in the report (Fetch Limit).
2. Entering an origin ramp code (Input Value: Origin Ramp Code).
3. Selecting the output format for the report (HTML, PDF, Text), including any options the user prefers, and clicking Go. See Output Format Options for more explanation of options.
   Output Format Options

The following options are available in Query Builder for a report's output format.

| Option | Description |
|---|---|
| HTML, Single page | Places entire report on one HTML page, so that the user |
| | only has to scroll down to see entire report. |
| HTML, Paginated | Separates the report into pages. The user enters a number in |
| | the Records per page box to specify number of records. |
| HTML, Records per page | When the user selects Paginated, the user enters the number |
| | of records to be contained on each page. |
| PDF | Makes the report a PDF file. A PDF viewer (Adobe) must |
| | be installed to view the PDF formatted results. |
| Text, Display in browser | The user should select one of the following: display in |
| | browser, download to local machine, e-mail to xxx. The |
| | report displays directly in the browser, like Microsoft |
| | Explorer or Netscape. The user can then print the report. |
| Text, Download to local | The user should select one of the following: display in |
| machine | browser, download to local machine, e-mail to xxx. |
| | Downloads and allows the user to save it as a text file on the |
| | user's computer. |
| Text, E-mail to . . . | The user should select one of the following: display in |
| | browser, download to local machine, e-mail to xxx. |
| Text, Comma delimited | Separates the items on the report rows with a comma. |
| Text, Tab delimited | Separates the items on the report rows with a tab space. |
| Text, Specify delimiter | Separates the items on the report by the character that the |
| char._{———} | user specifies. |
| Text, First row headers | Adds the header names at the top of the page. |
| Text, new lines | This check box should be selected if the user is working on |
| | a Unix machine, to adjust the line feed (carriage return or |
| | Unix line feed only). |
| Text, Apply formatters | This check box should be selected to indicate that the user |
| | wants a character formatter carried forward into the output |
| | (example, $). See the Formatter field on the Report Column |
| | Editor screen. |
| Text, No surrounding | Report items are not enclosed by quotation marks. |
| quotes | |
| Text, Double quotes | Report items are enclosed by double quotation marks. |
| Text, Single quotes | Report items are enclosed by single quotation marks. |
| Specify surrounding char. | Report items are enclosed by the character that the user |
| | specifies. |

### Additional Embodiment

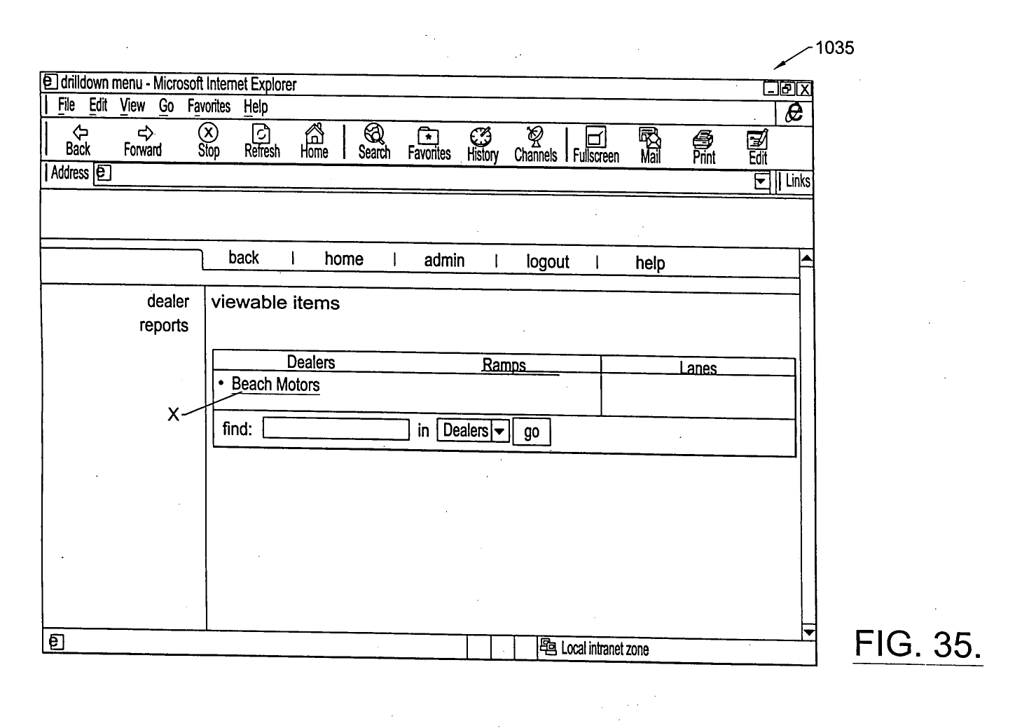

Reference is now made to an additional embodiment of the invention, to be discussed in conjunction with FIGS. 35-44.

After logging in (screen not shown) the user is presented with “viewable items” which the user can access, which can be by password access or by the shown search factor. Assuming the user clicks on the “Beach Motors” by hyperlink at “X”. FIG. 35A will be presented, which is a Dealer View. As may be seen, this view shows for a given date, the number of vehicles projected for arrival at the dealership. As an example, on Feb. 19, 2001, four vehicles are projected. For that date, four different summaries are available: model summary, railcar summary, ramp summary, and vehicle summary.

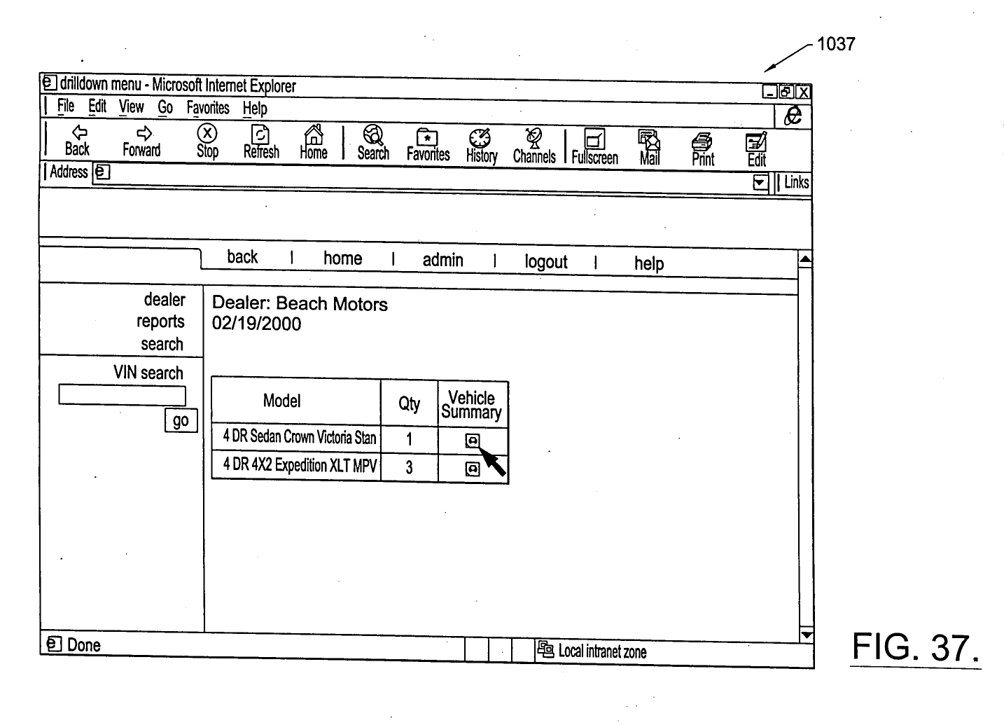

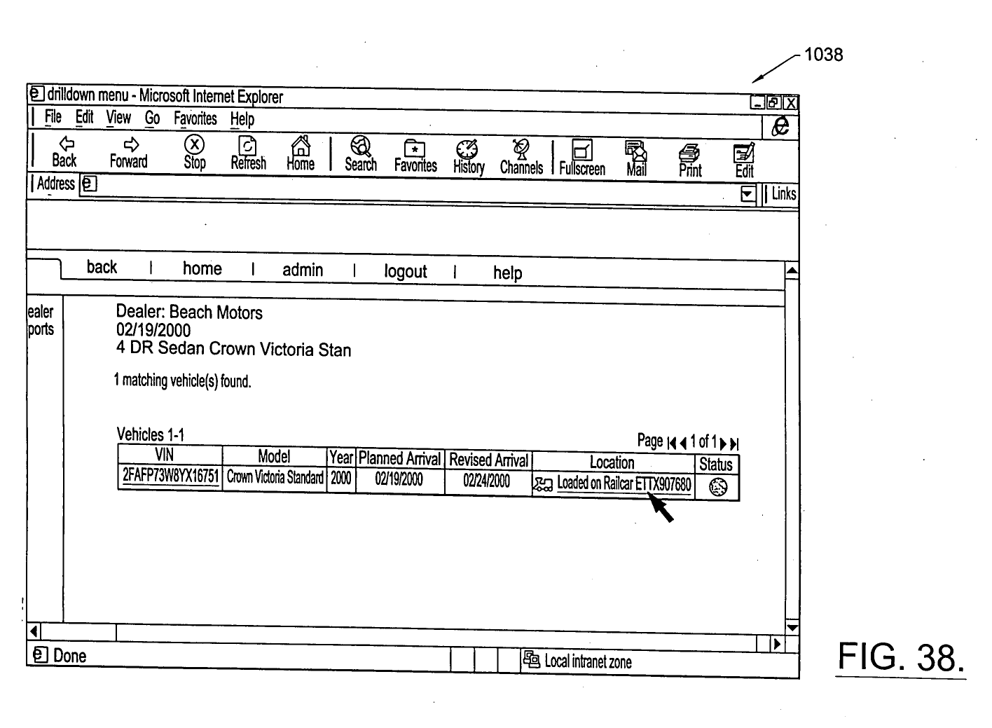

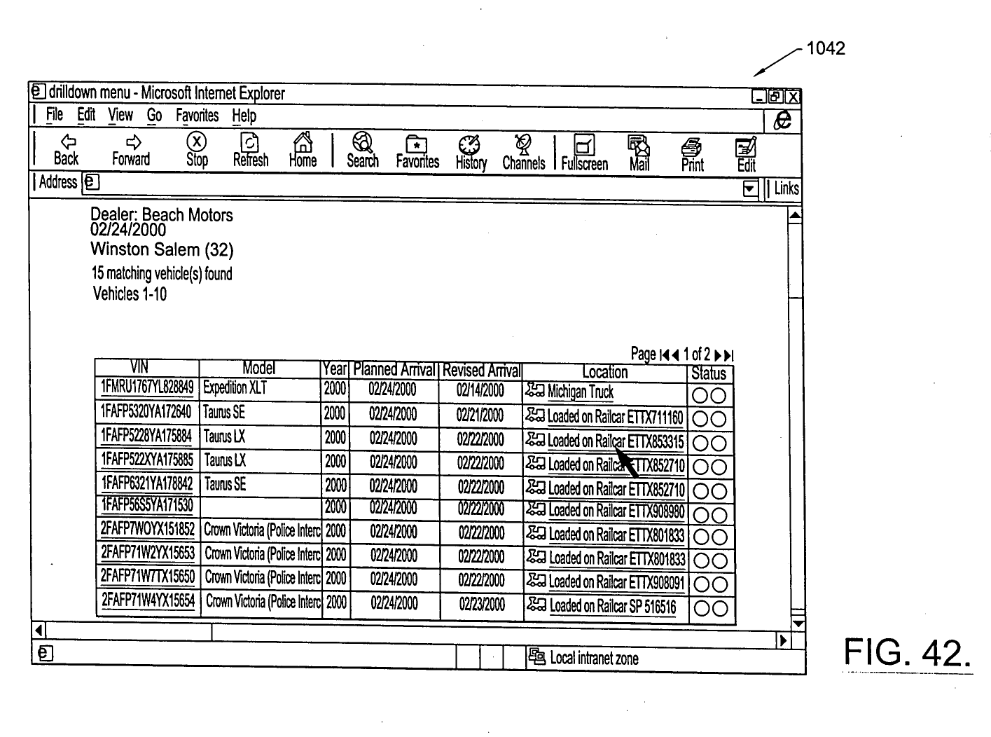

Assuming link “A” is selected from FIG. 26, a screen such as FIG. 37 is then displayed. FIG. 37 is a model summary list, by model, of the four vehicles which are to arrive at the dealership on Feb. 19, 2001. As may be seen, one is a Crown Victoria, whereas the others are Expedition XLT models. Assuming one “clicks” (selects) the Vehicle Summary hyperlink shown on FIG. 37, the Vehicle Summary will be shown as in FIG. 38. FIG. 38, the Vehicle Summary, shows the VIN (ZFAFP73W8YX167501), the model (Crown Victoria Standard), year (2000), planned arrival (Feb. 19, 2001), revised arrival (Feb. 24, 2001) location (loaded on railcar ETTX907680) and status. If more than one vehicle was located, the Vehicle Summary would have looked more like FIG. 42.

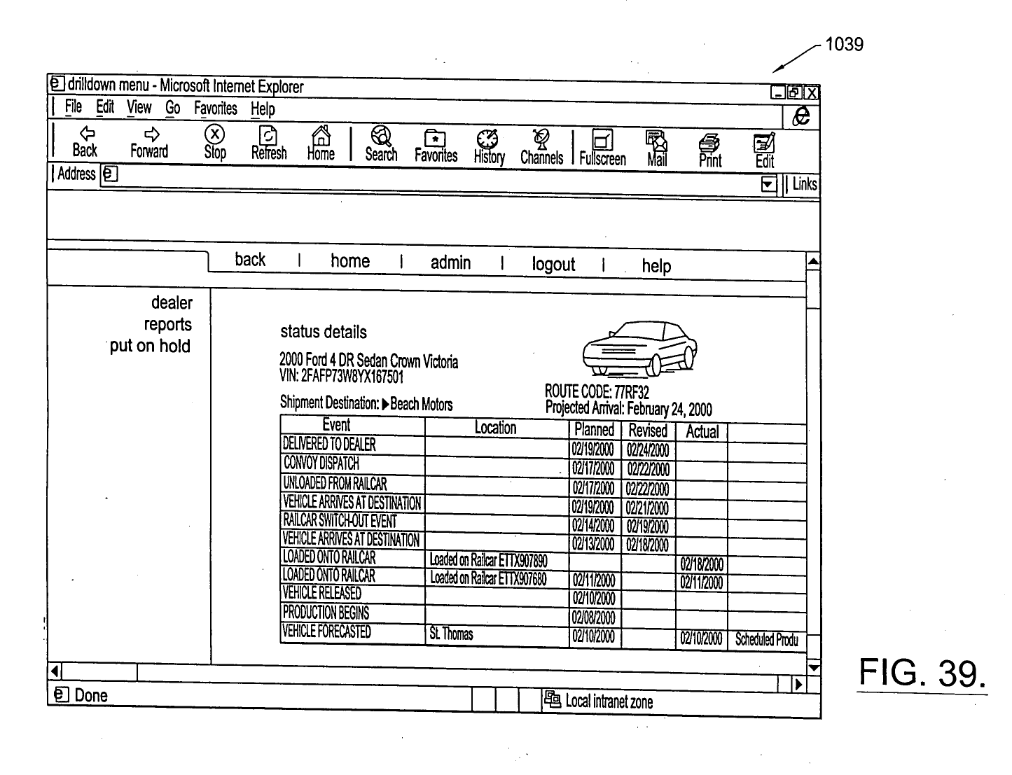

If the “location” link is selected, a Status Details Screen such as in FIG. 39 (or 43) is provided, which in this case shows the past history, present status, and future anticipated events planned for the automobile.

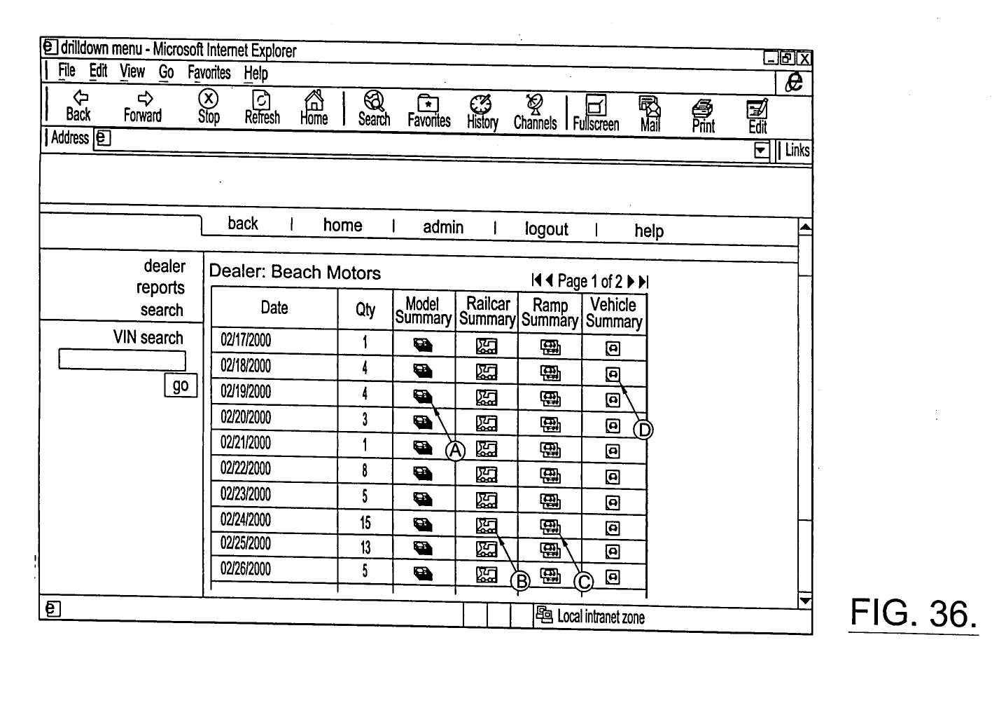

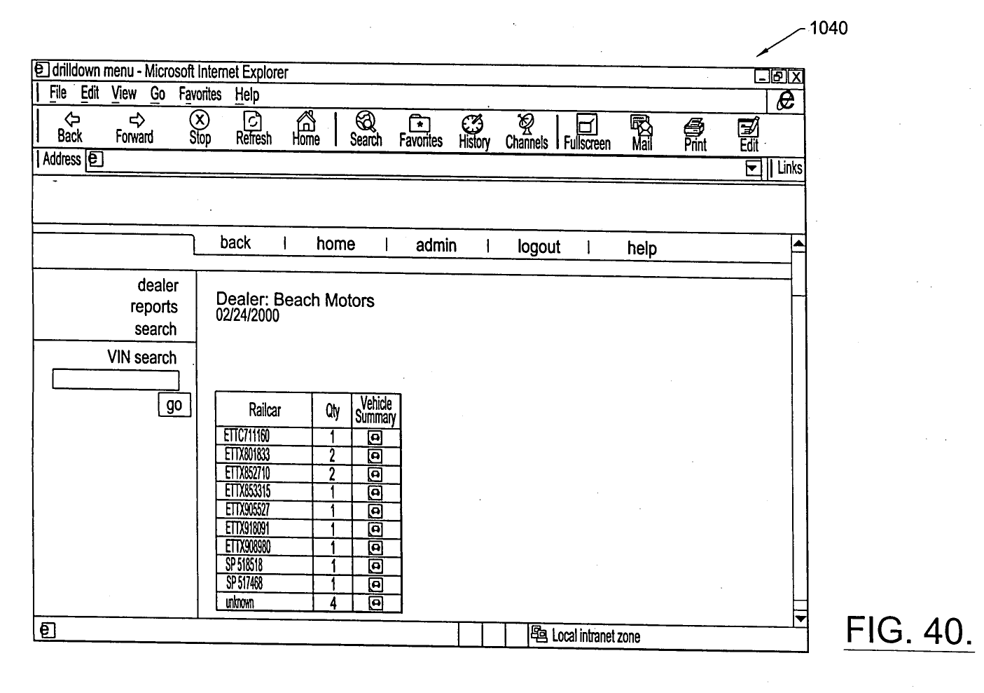

Deferring back to FIG. 36, if instead link “B” is selected, namely the Railcar Summary, a screen such as FIG. 40 is provided. As may be seen, this screen where twenty-four autos interact with the Rail System. If the Vehicle Summary link is selected as shown, a Vehicle Summary display similar to FIG. 38 will be shown, except more lines of display will accommodate the twenty-four autos (unless they are on the same train).

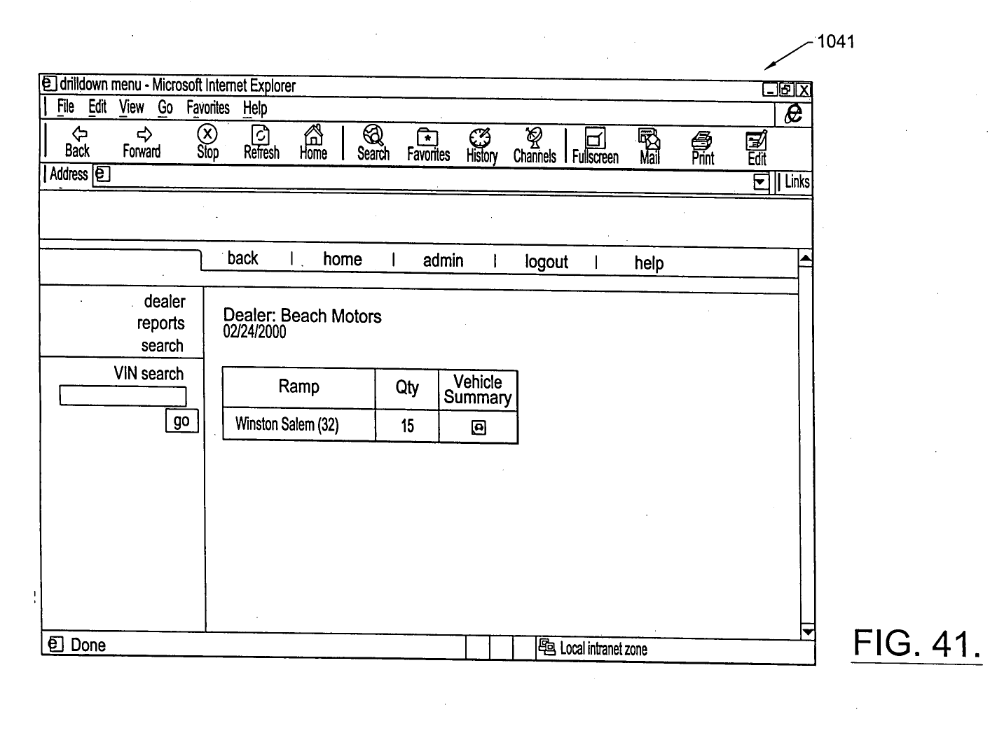

Deferring again back to FIG. 36, if the “Ramp Summary” link is selected, then a Ramp Summary screen such as FIG. 41 is then shown, which as may be seen shows the Winston Salem ramp with fifteen (15) vehicles. If Vehicle Summary is selected, a Vehicle Summary report such as shown in FIG. 42 is shown, which in this case requires two pages (only one is shown).

Deferring back again to FIG. 36, if the Vehicle Summary link is selected from this screen, a list of vehicles similar to FIG. 38 or 42 would be shown.

As may also be seen, a VIN search is provided in many of the screens, to allow an independent VIN search (which could be limited to the user's associated VINS). AS may also be seen, in FIG. 39 a link is provided to allow the user to put a vehicle “on hold”, as discussed earlier.

Simulation Runs

As noted above, the simulation tool 38 (1) analyzes the vehicle distribution network currently and into the future to predict bottlenecks; and (2) tests the impact of proposed changes to the existing vehicle distribution network “off-line.” Periodically, and preferably at least once each day, an experienced simulation operator employed by the management team runs a simulation of the network at the simulation workstation 64. In preparation for running scenarios, the operator checks for the presence of required, up-to-date input data as described above. As noted, most of the required input data is received from the tracking system 34, which in turn receives the data from monitors or scanners in the distribution network 20, or from manufacturer and carrier computers.

At the beginning of the simulation run, the workstation reads in the status of the system from the simulation database. This information loads the model with the current status or state of the vehicle distribution network, and includes the number of vehicles located at each point in the network, production orders for the next selected number of days, and (as the vehicles are produced) assigned routings from the Master Routing Table based on the origin and destination (O-D) pair. Updates to the manufacturer's production schedule can be input via the Excel interface 62. The simulation uses the O-D pairs and the duration times from the O-D Travel Time Table to move the vehicles through the network. For vehicles already in the pipeline as part of a train, the location of the railcar will be used as well as the date it left its last known position. Arena will subtract that time from the total duration time to determine the remaining duration to the destination ramp.

Running the current status of the network provides the outputs listed above, which measure the current efficiency of the network. The operator can view the throughput of the network, cycle times between points in the network, transit and freight costs, and the number of transport devices being utilized at each origin point and mixing center. Over the selected number of days, the operator can see where bottlenecks will occur, and provide recommendations for adjusting the network to avoid the predicted bottlenecks.

As discussed above, bottlenecks can occur principally (1) at a manufacturing plant, when the number of vehicles produced exceeds parking capacity, or vehicles are not loaded fast enough to meet target times, or there is a lack of sufficient empty railcars or car haulers; (2) at a mixing center when the number of railcars or car haulers exceeds their “parking” capacity, or the number of vehicles unloaded exceeds parking capacity, or there is a lack of sufficient empty railcars or car haulers, or vehicles are not loaded fast enough to meet target times, or the proportion of railcars that must be unloaded (rather than bypassing the mixing center) is too high; or (3) at a destination ramp, when the number of railcars or car haulers exceeds their “parking” capacity, or the number of vehicles unloaded exceeds parking capacity, or vehicles are not loaded fast enough to meet target times. To attempt to avoid such bottlenecks, the operator can change specific inputs to the model, selected from the list given above in the description of the Arena model. The Excel interface 62 allows users to easily change inputs to the simulation. Examples of responses to particular bottlenecks, with a possible implementation if the modified model eliminates the bottleneck, are given in the following table:

| BOTTLENECK | EXAMPLE INPUT MODIFICATION | IMPLEMENTATION |
|---|---|---|
| At a manufacturing plant: | | |
| Too many vehicles | No. of vehicles loaded/unloaded per | Hire labor |
| | day, or | Spread production |
| | No. of vehicles made, or | Rent space |
| | Parking capacity, or | More or bigger railcars |
| | Rail capacity. | |
| Vehicles not loaded fast enough | No. of vehicles loaded/unloaded per | Hire labor |
| | day | |
| Not enough empty railcars or car | Rail capacity, or | More or bigger railcars |
| haulers | No. of vehicles made | Spread production |
| At a mixing center: | | |
| Too many railcars or car haulers | Add routings, or | Alter arrival times |
| | Parking capacity, or | Rent car hauler space |
| | Rail capacity | Fewer railcars |
| Too many vehicles | No. of vehicles loaded/unloaded per | Hire labor, extend |
| | day, or | processing hours |
| | Add routings, or | Divert to direct delivery |
| | No. of vehicles made | Spread production |
| Not enough empty railcars or car | Rail capacity, or | More or bigger railcars |
| haulers | Hauler capacity, or | Haul away |
| | No. of vehicles made | Spread production or |
| | | hold vehicles |
| Vehicles not loaded or unloaded fast | No. of vehicles loaded/unloaded per | Hire labor or direct |
| enough | day | train around mixing ctr. |
| Too many railcars to unload | No. of vehicles loaded/unloaded per | Hire labor or direct |
| | day | train around mixing ctr. |
| At a destination ramp: | | |
| Too many railcars or car haulers | Add routings, or | Accelerate arrival times |
| | Parking capacity, or | Rent car hauler space |
| | Rail capacity | Fewer railcars |
| Vehicles not unloaded fast enough | No. of vehicles loaded/unloaded per | Hire labor |
| | day | |
| Too many vehicles | No. of vehicles loaded/unloaded per | Hire labor |
| | day, or | Space arrival times |
| | Add routings | |

Planning Tool

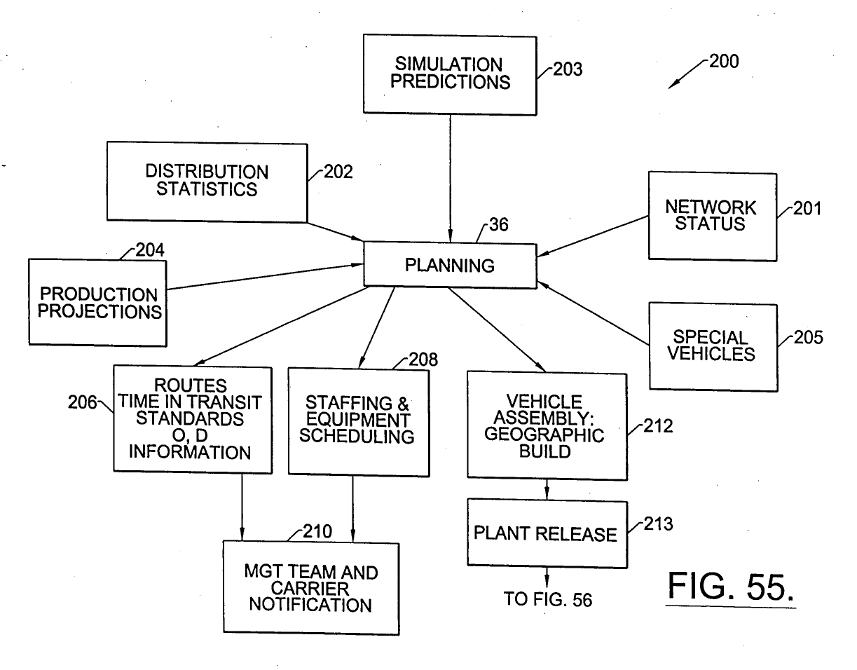

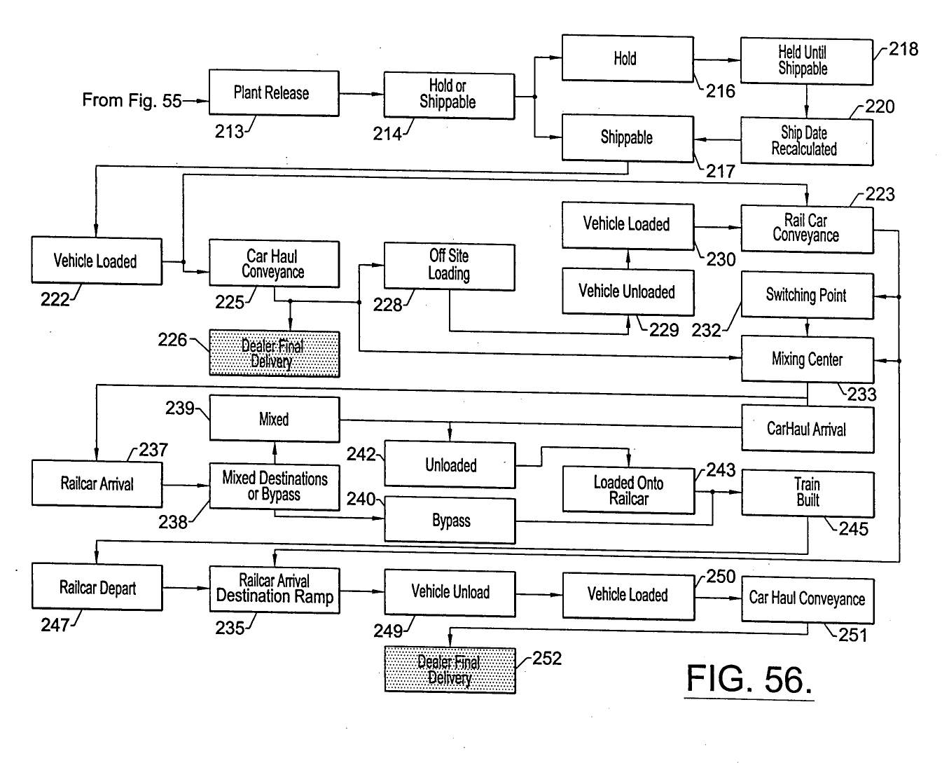

The planning tool 36 serves as the control panel for the vehicle delivery system 10. Referring to FIG. 55, the planning tool utilizes both actual status data 201 and distribution statistics 202 from the tracking system 34 as well as analyses 203 of possible network designs from the simulation tool 38, and information needed to transport special/exception vehicles 205 that are planned for transport. The basic planning model will consider manufacturer production projections 204 for 90-, 60-, 14-, and 5-day periods, and will determine system requirements on a daily basis once the vehicles are produced.

In one embodiment of the invention, an operator at the workstation 59 can access this information, and make decisions to designate routes at 206 for upcoming VINs, as well as time in transit standards. The operator can input origin and destination information. The operator also issues orders at 208 for scheduling equipment and staffing that carriers will need to provide to carry out the designated routes, and notifies the carriers at 210, either by direct communication (e-mail, telephone, fax, letter, data communications interface 40) or through the management team whose members receive the orders at their portable workstations 42 via the tracking system 34. The equipment schedules will cover deliveries over a number of days, and include the number and type of empty railcars and car haulers needed at all origin points and mixing centers at appointed times, and the train departures needed at specified departure times at origin points and mixing centers. For the same period, the staffing schedules will include staff to load railcars and car haulers at origins points and mixing centers, to unload at mixing centers and destination ramps, to receive vehicles at dealers, to reposition vehicles for proper loading, to handle bypass LTD railcars, and to build trains. Such staff may be employed by one or more railroads, one or more car haulers, one or more load/unload contractors, and multiple dealers.

In another embodiment, a software planning engine is run on the workstation 59 to optimize the delivery network 20, automatically assigning routes and ordering resources. Such software allows the planning tool to better actively plan the network and be less reactive. In particular, the software focuses on managing resources to reduce or eliminate unplanned dwell time at origin points and mixing centers. Results of the simulation tool analyses are used to generate time phased workload plans across the network, and to provide vehicle estimated time of arrival (ETA) at rail switching or other network facilities. Furthermore, alternative routes for lane segments, namely, the best predetermined workaround contingencies for foreseeable problems, are factored into the original plan for use if necessary.

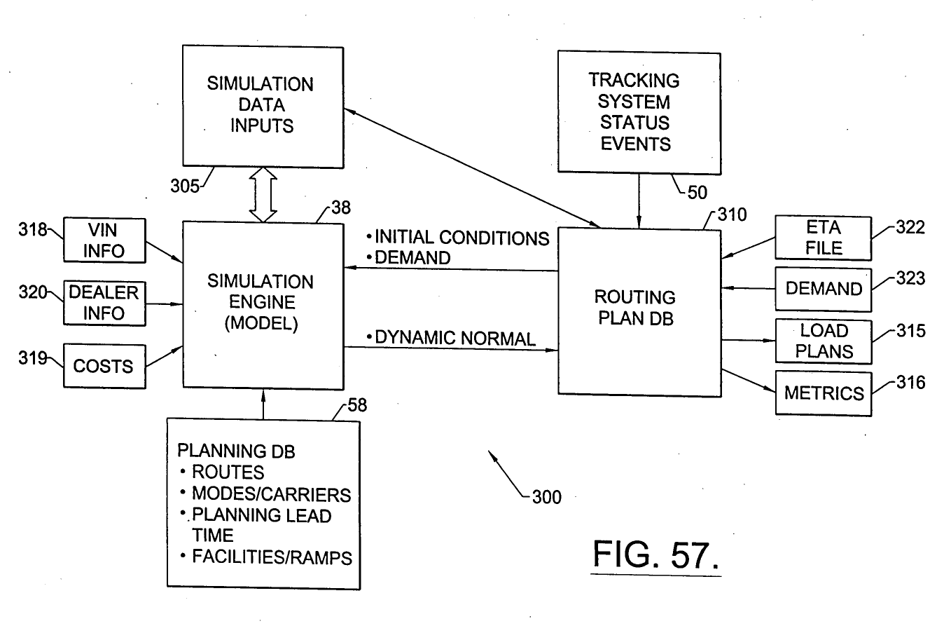

FIG. 57 shows a flow diagram for such an automated planning process 300. Generally, the planning process 300 utilizes the output of the simulation tool 38 given a set of inputs, based on simulation data inputs 305 of the type discussed above, and generates a routing plan database 310 which includes routes according to which the vehicle distribution network 20 is operated. The route planning database 310 receives information directly and indirectly from numerous sources including the tracking system database 50 and the planning database 58. Other input information received through the simulation tool 38 includes VIN information 318 such as the product family (vehicle type, origin plant, and LTD or mix designation of origin ramp) and the load ratio of LTD to mix for the origin plant; transportation cost data 319; and dealer profile information 320. Direct inputs include ETA data 322 for arrival of vehicles at network facilities and demand data 323 reflecting the dealer demand for vehicles by region (such as 3 digit zip code) at a given date.

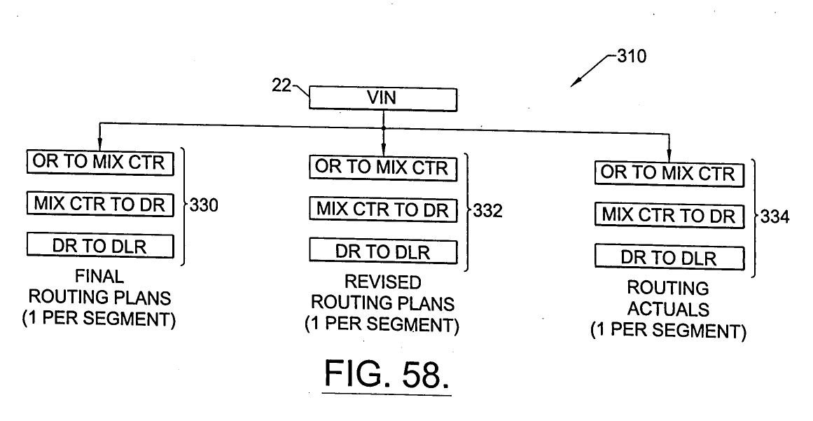

As shown in FIG. 58, the routing plan database 310 contains for each segment of a lane assigned to each VIN 22 a current routing plan 330, revised routing plans 332, and a record of the actual route 334 taken by the VIN, allowing each routing plan to contain the VIN status, a dynamic normal plan, revisions to the dynamic normal plan, and actual events for the VIN. Initial workload conditions are fed to the simulation tool 38 from the revised plans 332. Furthermore, routing plans are provided for each network facility, giving on a daily basis the facility's gross capacity, number of VINs present (“wheels rolling”), and available capacity. Both planned dates and actual events from pre-release through delivery are captured in the routing plan database 310 for each VIN. These plans and events begin with initial production sequencing and include gate release, rail switchout or haul away from the origin ramp, various in transit events, and dealer delivery.

The VIN routing planning process 300 takes advantage of the predictive capability of the simulation tool 38 to plan capacity in the network. The process utilizes key capacity effectively, eliminates bottlenecks and reduces unplanned dwell, thus reducing network cycle time for vehicle delivery and relative costs. One aspect of this process is to apply alternative routings from origin ramps in the simulation process to control bottlenecks at mixing centers. The process focuses on the mixing center as the resource most likely to experience bottlenecks, and on the origin ramp and the best source of high volume workarounds. The simulation tool 38 is used to predetermine the best workaround contingencies for the known production schedule, taking into consideration the relative cost and the effect on cycle time. Any expected origin ramp release of a “batch and hold” is incorporated into the simulation tool model. In operation of the network, flexing normal routes in response to contingencies on a day to day basis produces improved cycle times, and the routing planning process 300 builds such contingencies into the routing plans stored in the routing plan database 310. After several iterations of the simulation tool analysis, a best plan is accepted and communicated as described above to the carriers and the management team.

Reducing the ratio of mix railcar loads to LTD loads in load plans 315 is an example of a technique that is applied to origin ramps. Referring to FIG. 2, assume that the simulation predicts that the need to a few VINs on a mix railcar will prevent an entire train of LTD railcars from bypassing the mixing center. In this case, the extra flexibility available in assigning alternative routings may result, for example, in sending the mix load VINs directly to a destination ramp or dealer by car hauler even though such a destination is farther than the normal limit for direct car hauler delivery. The VIN routing operations process 307 generates time-phased workload plans across the network for scheduling personnel and equipment and for notifying management team members at various network facility points of upcoming needs. The management team then has the accurate information it needs to assure that downstream facilities and carriers have labor and haul away capacity in place to carry out the routing plan. This process also calculates VIN ETAs at rail switchout points that the network is capable of meeting.

Actual network performance is tracked by providing metrics 316 (cost per VIN and cycle time) and “report cards.” The following table shows a comparison of a VIN routing plan 330 to the VIN's routing actual data 334, allowing the management team to assess on time delivery performance.

VIN Plan

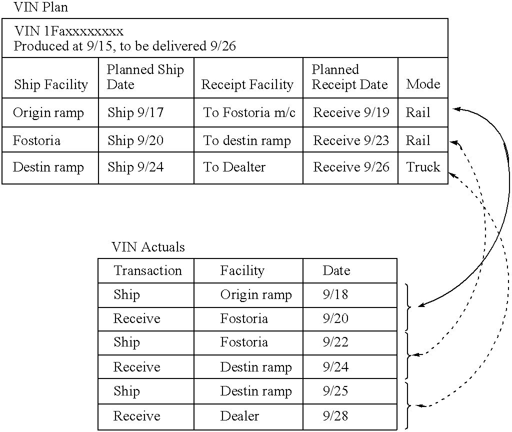

VIN Actuals

Segment events can be summarized to provide “report cards” such as the following chart, which can be utilized to update the simulation model.

Report Cards

| | Plan lead | Actual lead | On Time |
|---|---|---|---|
| Segment | time | time | Percentage |
| Origin ramp to Mix Center | 2 days | 2 days | 100% |
| Mix Center | 1 | 2 | 50% |
| Mix Ctr to Destination Ramp | 3 | 2 | 150% |
| Destination Ramp | 1 | 1 | 100% |

A post planning process is carried out to allow the management team to identify new problems requiring solutions or contingencies, to monitor and coordinate the execution of the routing plans in operation of the network, and to maintain the accuracy of the network model and initial conditions used by the simulation tool.

Geographic Build. Preferably, the planning tool 34 also will influence scheduling of vehicle production so that advanced geographic build practices are utilized at vehicle assembly step 213 of FIG. 55. In one embodiment, manufacturer production volume is planned to meet available delivery network capacity. Geographic build will be utilized to smooth the volume levels for a given destination ramp based on the planned production forecast for a given week. This will allow for a more consistent flow of vehicles by day within each week, while adhering to the total planned production to each destination for the week. Based on advance notice of dealer orders (for example, three weeks lead-time prior to production), the planning tool will be used to provide a production schedule request to a manufacturer indicating the desired daily leveling of volume for a given week. This production schedule request will be based on current network operating capacity, rail and haulaway carrier performance and total forecasted volume for each destination ramp. The production schedule request can be input by the manufacturer into the manufacturer's production scheduling solve algorithm.

Pursuant to another aspect of geographic build, the planning tool scheduling request can specify consolidation of production for shipment to low volume destinations into a more condensed pattern. Also, with access to long range production forecasts, the planning tool will be used to reduce spikes incurred by fleet sales to auto rental agencies or corporations by spreading production of such vehicles to evenly use capacity in the delivery network.

In another type of geographic build, in response to prediction of bottlenecks or actual bottlenecks in the network, the manufacturers can alter the sequence in which particular VINs enter the network (to ease congestion in particular lanes), adjust the ratio of LTD to mix loads, or otherwise affect the sequence of VINs at network facility points experiencing congestion or bottlenecks. If a manufacturer uses a logistics program to coordinate arrival of parts at a plant for production over a following number of days, the manufacturer can plan the vehicles to be made in that period of days by ordering a particular set of parts to fit network capacity, or can alter the sequence in which the planned vehicles are assembled. For example, making enough vehicles going to the same destination ramp can increase the ratio of LTD loads to mix loads.

Geographic build may be used to control the number of vehicles built for particular destinations over a period of time, such as a week. In the alternative, vehicles for a particular destination may be made only on one day of the week, to allow more efficient car hauler loads. In some cases a plant near the first destination may make vehicles going in the other direction only on a day of the week that allows the same car haulers to make an efficient round trip. For example, the manufacturer may do a Louisville to Atlanta build on Monday, and an Atlanta to Louisville build on Tuesday. The same car haulers could then transport both sets of vehicles.

In a preferred embodiment, the manufacturer produces vehicles in an order such that a group of vehicles going to the same destination ramp is released in sequence, allowing the vehicles to be loaded onto railcars without parking them in a holding area.

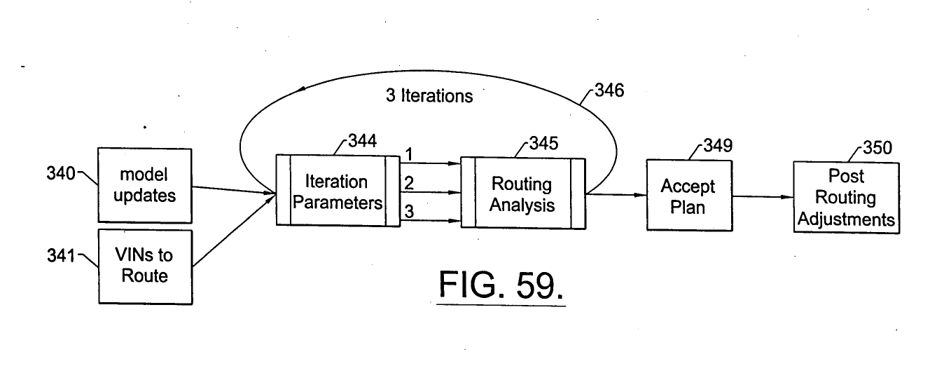

Daily Routing Plan Process. A daily routing plan process is summarized in FIG. 59. Various updates to the simulation model are represented at block 340, and VIN profiles, family data, and production schedules are represented at block 341. These pre-routing inputs include batch and hold updates, facility capacity updates, carrier updates, and route contingency plans. These inputs are associated with a set of simulation parameters at block 344, depending on the current iteration of route planning. Iteration no. 1 assumes unlimited capacity at mixing centers, and takes into account batch and hold expectations at the origin ramps. The simulation tool does a routing analysis at block 345, assessing the magnitude of the worst predicted mixing center problems and the possible origin ramp options for dealing with those problems. Plan metrics, including the cost per VIN and the cycle time to complete the plan, are output. The process of optimizing and simulating then returns to block 344 for iteration no. 2, which uses the real capacity of the mixing centers. On this iteration, the simulation tool at block 345 integrates origin ramp workarounds into the model, and outputs the same metrics. The process again returns to block 344 for iteration no. 3, which uses the best workarounds, and at block 345, outputs a final plan with update VIN ETAs, verifies that the final plan is acceptable, identifies any continuing problem attributes for post-planning evaluation, and provides a plan summary. At block 349, the plan is accepted. The routing process includes a mixing center review, planning for origin ramp contingencies, planning cycle time, planning a cost summary, and updating ETAs. Block 350 represents post routing analysis and adjustments to be applied to the next daily routing process, based on review of final cycle time and cost, workloads, new issues that arise, and lead time analysis.

It will be understood that the techniques described above can be implemented by an operator examining the simulation tool output, as well as automatically.

Vehicle Flow in the Routing Plan

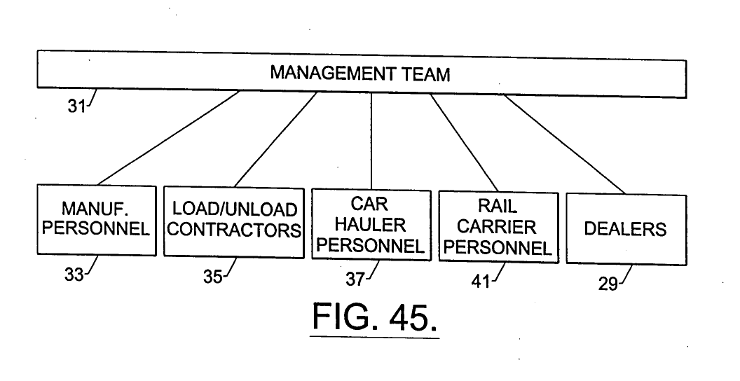

Returning to FIG. 56, the vehicle assembly step 212 is followed by a plant release event of the finished vehicles at block 213. At block 214, the vehicles are divided into held VINs 216 and shippable VINs 217. Those held eventually become shippable at block 218, their ship date is recalculated at block 220, and they return to shippable status at 217. Next, they are loaded by vehicle manufacturer employees 33 or load/unload contractors 35 (See also FIG. 45) at block 222 either onto a railcar at block 223 or a car hauler at 225. The car hauler 28 conveyance may be routed to a dealer 29 for final delivery at block 226, or may proceed to a rail yard or consolidation hub of the type described above at block 228. At such a loading point, the car hauler is unloaded at 229 and reloaded at block 230 onto a railcar as indicated at block 223.

Staging of vehicles at origin plant consolidation hubs and mixing centers, as well as loading and unloading of vehicles onto or from railcars, is typically done by employees of an independent load or unload contractor 35 (see also FIG. 45). Rail carrier personnel 41 include personnel to operate and switch railcars and trains. Car hauler personnel 37 include drivers and assistants who typically load and unload, as well as drive, car hauler trailers. However, the system 10 also contemplates car haulers engaging independent load or unload contractors. In a system according to the present invention, these independent employers are supervised and coordinated by the management team, taking advantage of the visibility of the network made possible by the tracking system 34, and the routing and workload plans received from the planning tool 36.

Trains of railcars at 223 are in transit to a switching point 232, a mixing center 233, or a destination ramp 235. A railcar arrival event at the mixing center is indicated at block 237, following which the railcars are staged at 238 either to an area 239 for mixed loads or a yard 240 for LTD (unmixed) loads that will bypass the mixing center process. The mixed loads are unloaded at block 242 and reloaded at 243 onto railcars after sorting. At block 245, new trains are built from the railcars of newly sorted vehicles and the LTD railcars. A railcar departure event from the mixing center is indicated at block 247, followed after transit time by a railcar arrival event at a destination ramp indicated at block 235. The vehicles are unloaded from the railcars at block 249, and loaded at 250 onto car haulers 251 for transport to a dealer for final delivery at block 252. It should be understood that FIG. 56 shows a simplified version of the delivery network. The actual network includes multiple origin points, mixing centers, destination ramps, and dealers. Trains traveling between mixing centers and destination ramps may stop at a switching point for the addition or subtraction of railcars.

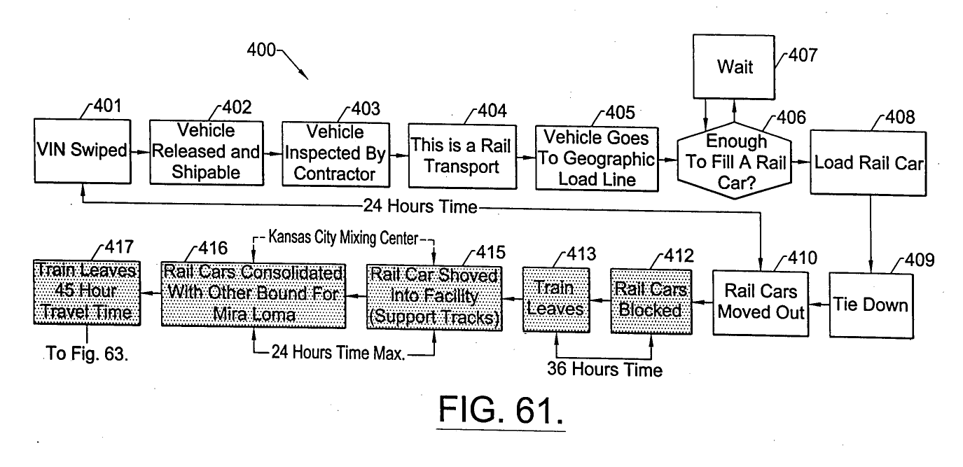

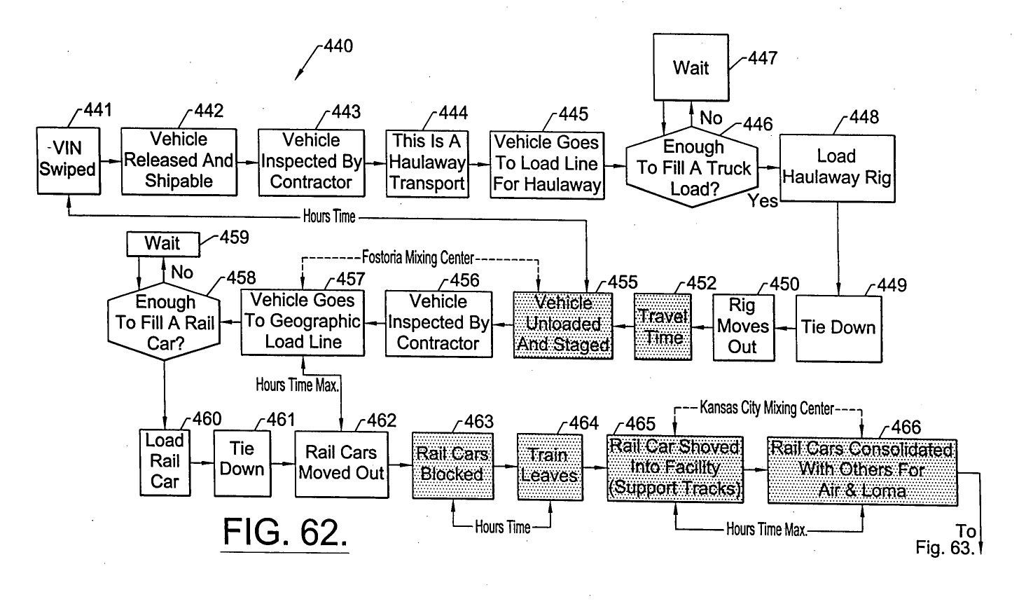

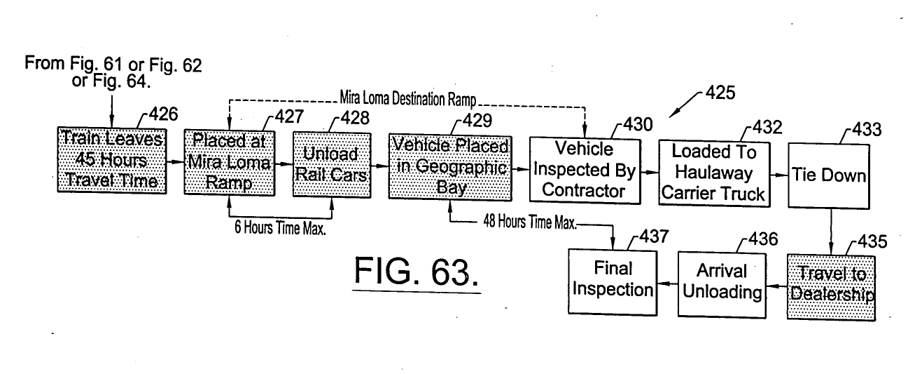

Plant to Dealer Examples. FIGS. 61-65 show vehicle flows for several specific examples using a vehicle delivery system 10 according to the present invention. FIGS. 61 and 63 illustrate the process 400 for transporting vehicles on LTD railcars from a Michigan truck plant to a California (Mira Loma) destination ramp via a Kansas City mixing center. At step 401, a bar code or other encoded symbol on a completed VIN is scanned into the tracking system 34 and at 402 the vehicle is released by the manufacturer as ready for shipment. The vehicle is inspected by a load contractor at 403, found acceptable for rail transportation at 404, and staged by the load contractor in a geographic load line of an outbound rail yard at 405. The VIN is scanned to update its status. The geographic load line may be outside the origin plant, or may be a consolidation hub 25c for consolidating vehicles either produced at multiple plants of the same manufacturer, or commingled from plants of different manufacturers. Until enough vehicles have been released to fill a rail car, at 406, the vehicles in the load line wait at 407, and then they are loaded onto a rail car at 408 and tied down at 409. The VIN identification code is tied in the tracking database 50 with a scanned railcar identification code. The routing plan will assume a standard maximum time of, for example, 24 hours between plant release and scanning of a rail car containing the vehicle upon the rail car moving out of the loading area at 410.

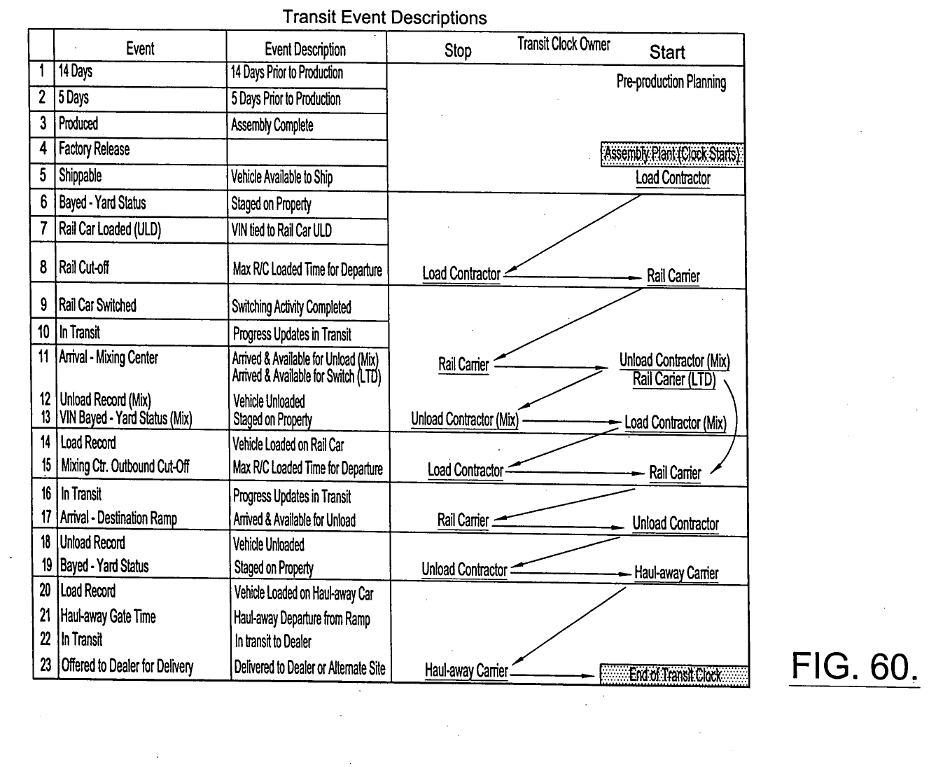

The management team 31 oversees the staging and loading process, utilizing a routing plan for each VIN received on workstations 42. The routing plan detail includes an indication of where each VIN should be staged prior to loading so that the VIN will efficiently begin its proper lane segment according to the routing plan. As key events occur to the VIN, its code is scanned by the management team 31 or personnel under their supervision, and the information is transmitted through the workstations 42 or through the communications interface 40 to update the tracking database 50 The management team 31 also may manually enter status information to the tracking database. The involvement of personnel employed by the carriers and the load/unload contractors is shown diagrammatically in FIG. 60 for typical LTD and mix scenarios.

The management team 31 also may receive an alert concerning a VIN via the workstation 42. For example, if a VIN's status has not been updated to indicate it has been loaded within a planned time from its plant release, the appropriate team member will receive an alert. Based on the alert, the team member will determine the reason for the delay and takes steps to get the VIN back on schedule.

The management team 31 also deals with capacity problems that arise at origin points. For example, if 100 vehicles are held prior to release for a day, and then are released along with the next day's production of 100 vehicles, and the capacity of the origin ramp for loading vehicles is 100 vehicles per day, the members of the management team 31 on site at the origin point will consider options for resolving the problem. They may level the shipment volume by spreading the 100 car backlog over time on a first-in first-out basis, in conjunction with finding additional railcars to handle the increased volume level. A contingency planning group of the management team 31 is notified, and the contingency planning group in turn notifies all affected managers, contractors, and carriers. An equipment control group of the management team 31 also is notified so that they can assist in obtaining additional railcars, as well as dealing with the effect of diverting any of such railcars from other parts of the delivery network. The team members on site might also consider shipping all 200 vehicles on their day of release, but this would create an activity spike at the next operation downstream, overloading capacity there. Also, finding equipment to ship double the usual quantity of vehicles would be more difficult.

The management team 31 uses the following form to guide it through problem analysis:

| | |
|---|---|
| Questions | Your Responses |

What solution(s) do you
propose?
What steps will you follow to
resolve the situation?
Who will you contact?
What alternatives did you
consider?
What makes your solution the
best?

Another example of a capacity problem at an origin point might be a rail equipment shortage. This problem might be dealt with using a car hauler diversion by using existing car hauler capacity to make up for the rail equipment shortage, so long as the diversion of car haulers would not jeopardize planned car hauler shipments. Again, the contingency planning group and equipment control group would be notified. An option of holding vehicles at the origin point probably would be rejected in order to maintain schedule for all the vehicles.

The management team 31 at other locations would deal with problems in a similar way. For example, the team at a mixing center might find that luxury vehicles were damaged in loading, or that some VINs have been mis-routed, or that there is a bottleneck at the next destination point for some VINs, or that there is an unexpected 24 hour delay due to rail congestion. The team at a destination ramp might find that a dealer is not open to receive vehicles that have arrived at the ramp, or that congestion at the ramp makes it impossible to bring in any more vehicles although more are scheduled to arrive, or that there are not enough car haulers to deliver to dealers the vehicles present at the ramp.

Continuing with the vehicle flow of FIG. 61, the loaded rail cars are blocked at 412 by rail carrier personnel to build a train, which leaves the origin point at 413 within 36 hours if the standard schedule time is met. In this example, the train travels directly to the Kansas City mixing center, where the rail car containing the VIN is pushed onto support tracks at 415 by rail carrier personnel (in the case of LTD railcars). The railcar is scanned on departure from the origin point and on arrival at the mixing center. Within a period of time, planned to be no more than 24 hours, the rail car is consolidated by rail carrier personnel at 416 with others bound for the Mira Loma destination ramp as a train is built. At 417 the railcars of the train are scanned, and the train begins its long trip, about 48 hours, to Mira Loma.

Referring now to FIG. 63, the rail car arrives and is scanned at the Mira Loma ramp at 427. Unload contractor employees unload the railcar within 6 hours if on schedule, at 428, and place it in a geographic bay according to dealer location at 429. The vehicle is scanned on arrival at the bay, where the haulaway contractor inspects the VIN at 430 for any damage caused in transit thus far. The contractor loads the VIN onto a car hauler and scans it at 432, ties down the VIN at 433, and drives the car hauler to the dealer at 435. The VIN identification code is tied in the tracking database 50 with a scanned haulaway trailer identification code. The car hauler contractor personnel unload the VIN at the dealership at 436, the dealer gives the VIN a final inspection at 437, and a final scan is done to update the tracking system with an indication of completion of transport and acceptance by the dealer. The scheduled maximum time between arrival at the geographic bay and final inspection is 48 hours.

FIG. 62 shows a vehicle flow for a somewhat different process 440 for transporting vehicles initially on car haulers from a car plant in Michigan to a California (Mira Loma) destination ramp via a two mixing centers. Steps 441 to 443 are identical to steps 401 to 403 described above. However at 444 the VIN is scanned and accepted for haulaway transport and contractor personnel stage the VIN to a load line at 445. When there are enough VINs to fill a truck load as noted at 446 (if not there is a wait at 447), the car hauler personnel load their rig at 448 and tie down at 449. The VIN identification code is tied in the tracking database 50 with a scanned haulaway trailer identification code. The rig moves out at 450 and travels for a time represented by 452 to the Fostoria, Ohio, mixing center where at 455 the VIN is unloaded, scanned, and staged for inspection by an unload contractor. At 456, the unload contractor inspects the VIN and sends it to a geographic load line at 457 for consolidation with other VINs bound for the same destination ramp. When there are sufficient VINs to fill a railcar for that destination as noted at 458 (wait at 459), the contractor loads a rail car at 460, scans the VINS loaded and the rail car, and ties down at 461. Steps 462 to 466 are identical to steps 410 to 416 above, as the train travels to the Kansas City mixing center, the railcars are rebuilt into trains. Then the process continues with the steps of FIG. 62 as described above, culminating in delivery to the dealer.

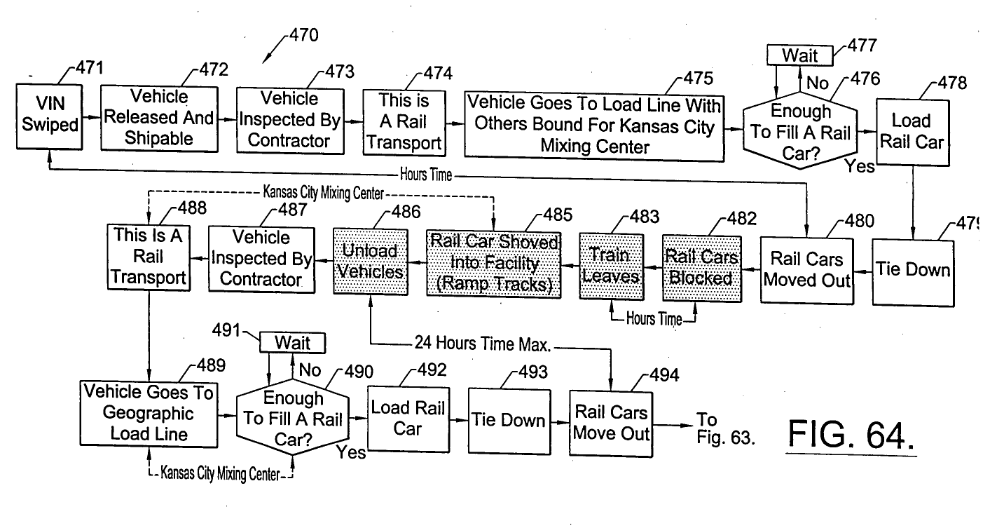

FIG. 64 shows a vehicle flow for a somewhat different process 470 for transporting vehicles on mix railcars from the Michigan truck plant to a Phoenix, Ariz., destination ramp via the Kansas City mixing center. Steps 471 to 474 are identical to steps 401 to 404 described above as the VIN is released and identified for rail transport. At 475, the vehicle is staged at a load line with others bound in mixed loads for the Kansas City mixing center. Steps 476 to 483 are identical to steps 406 to 413 described above as the VIN is loaded onto a railcar and travels by train to the mixing center. The railcar is pushed by rail carrier personnel into ramp tracks at the mixing center at 485, where the VINs are unloaded at 486 by unload contractor personnel, scanned, and inspected by the contractor at 487. The contractor determines that the VIN's next lane segment will be by rail at 488 (using information from the tracking database 50). Steps 489 to 496 are identical to steps 457 to 464 described above, as the VIN is shipped by rail to the destination ramp. The process continues with the steps of FIG. 63 as described above, culminating in delivery to the dealer.

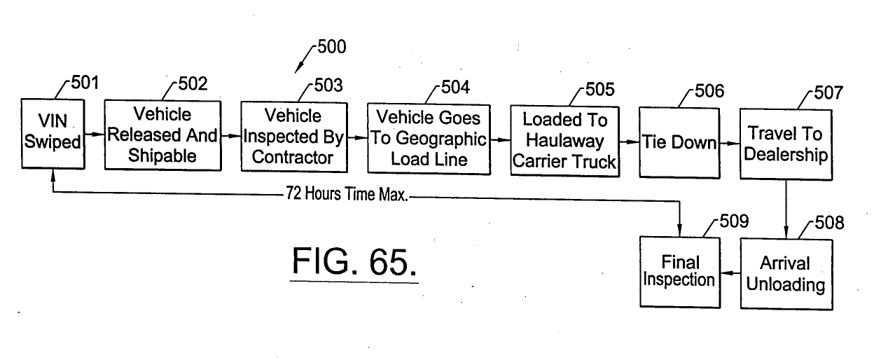

FIG. 65 shows a vehicle flow for a process 500 for direct delivery from origin plant to dealer by car hauler. At step 501, a bar code or other encoded symbol on a completed VIN is scanned into the tracking system 34 and at 502 the vehicle is released by the manufacturer as ready for shipment. The vehicle is inspected by a load contractor at 503, and staged by the load contractor in a geographic load line at 504. The load contractor scans the VIN and loads it onto a haulaway trailer at 505, and ties down at 506. The VIN identification code is tied in the tracking database 50 with a scanned haulaway trailer identification code. Travel to a dealership is indicated at 507, followed by unloading of the VIN, which is scanned on arrival. Final inspection by the dealer and acceptance occurs at 509, and the accepted status of the VIN is sent to the tracking database. A standard time of, for example, 72 hours, is established in the routing plan for this total process.

Management Team

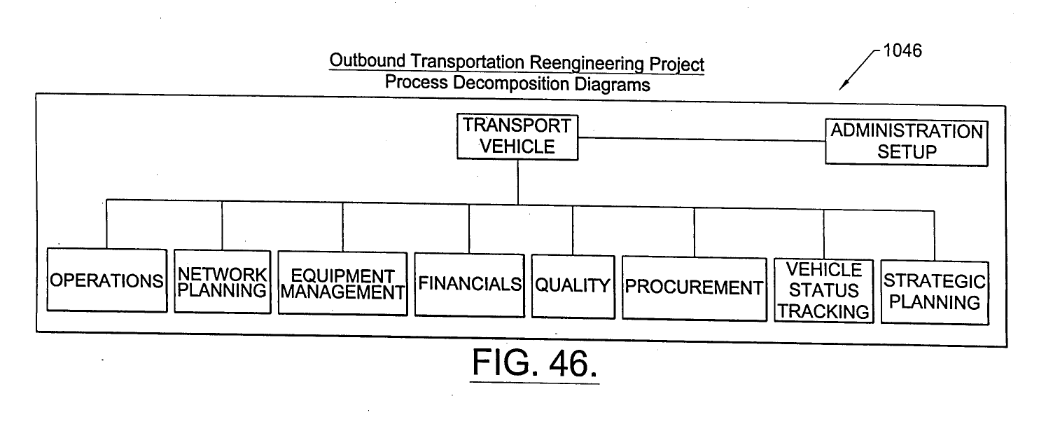

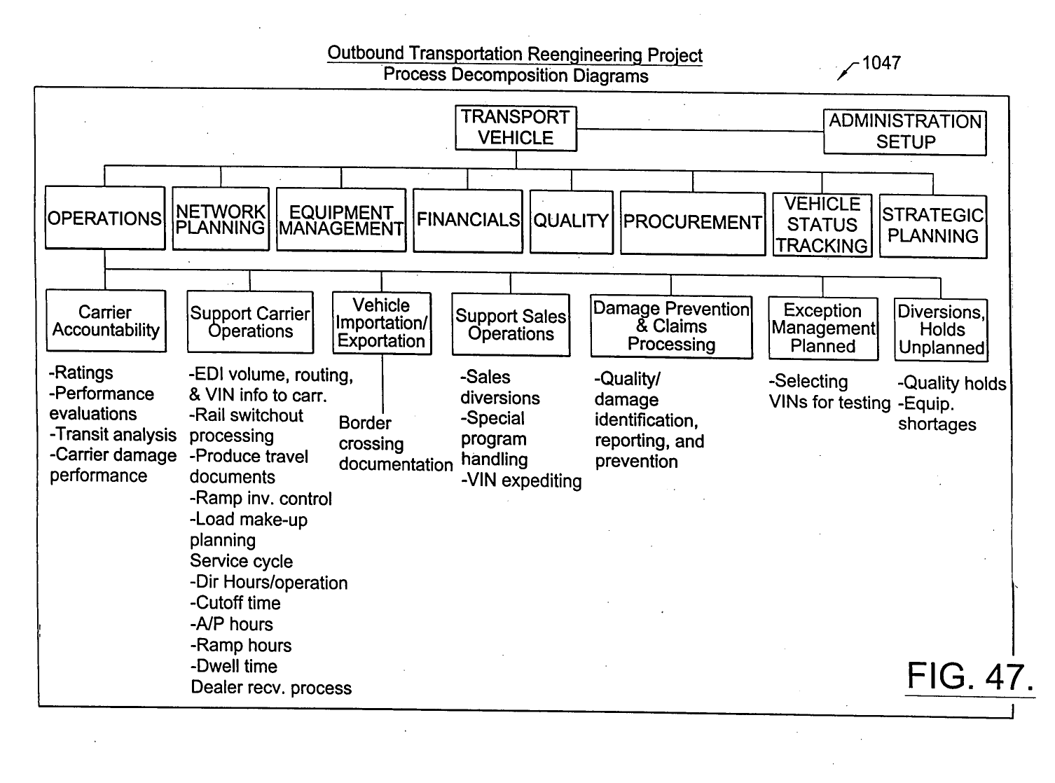

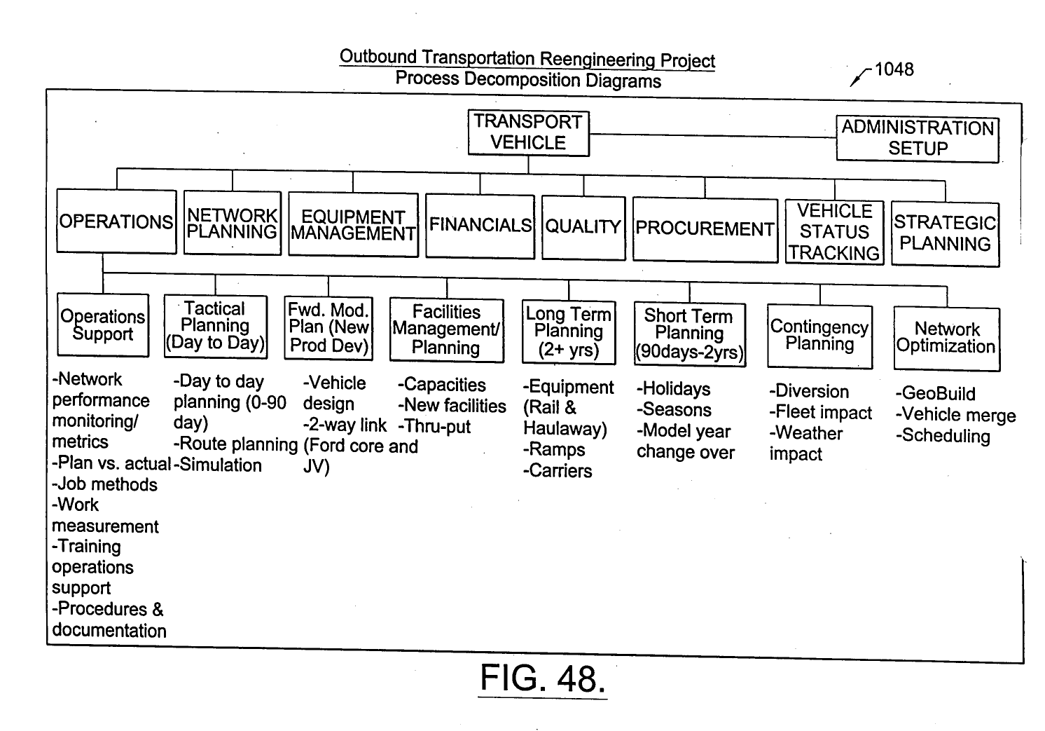

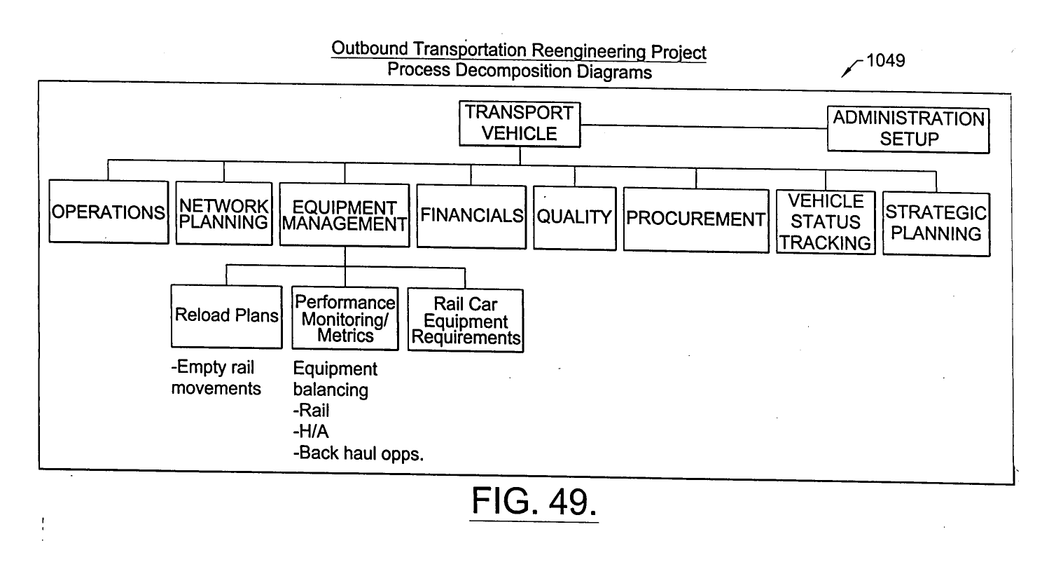

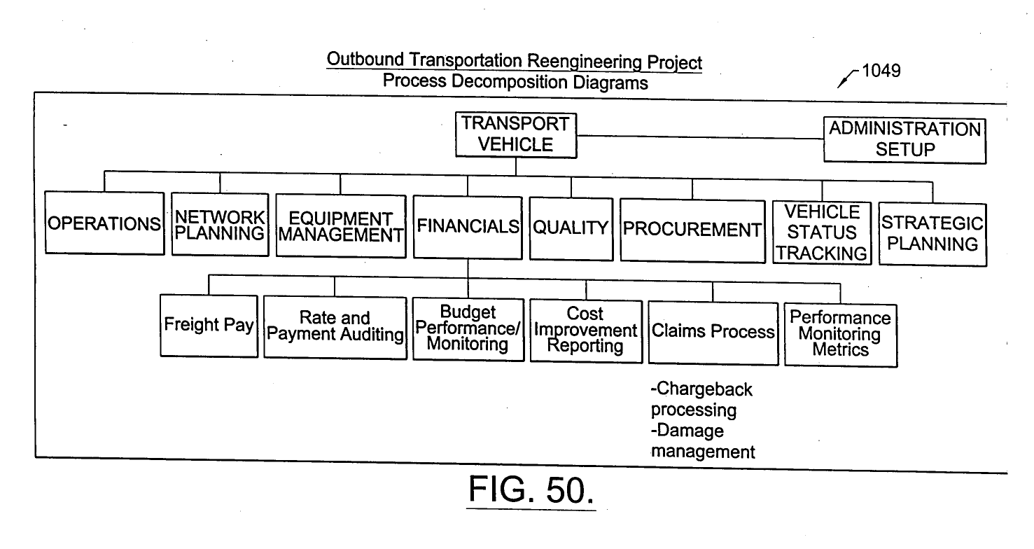

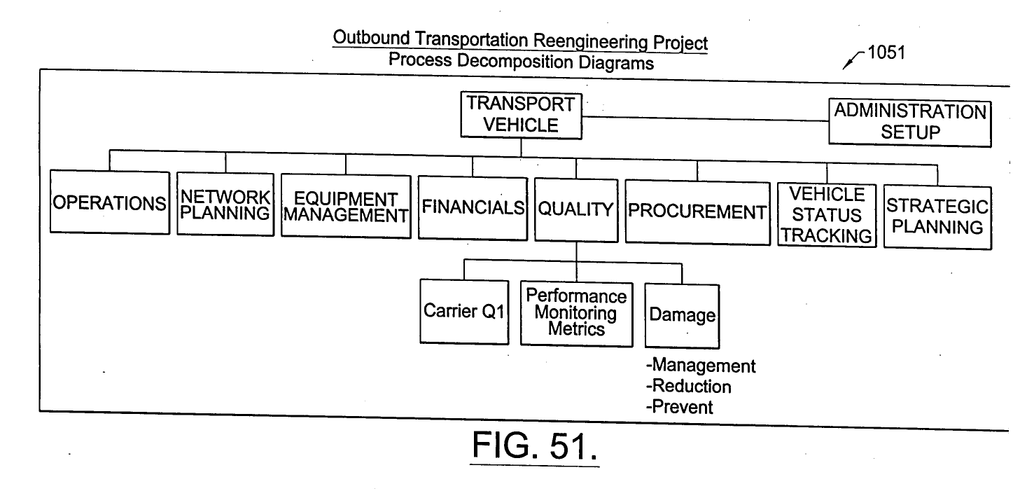

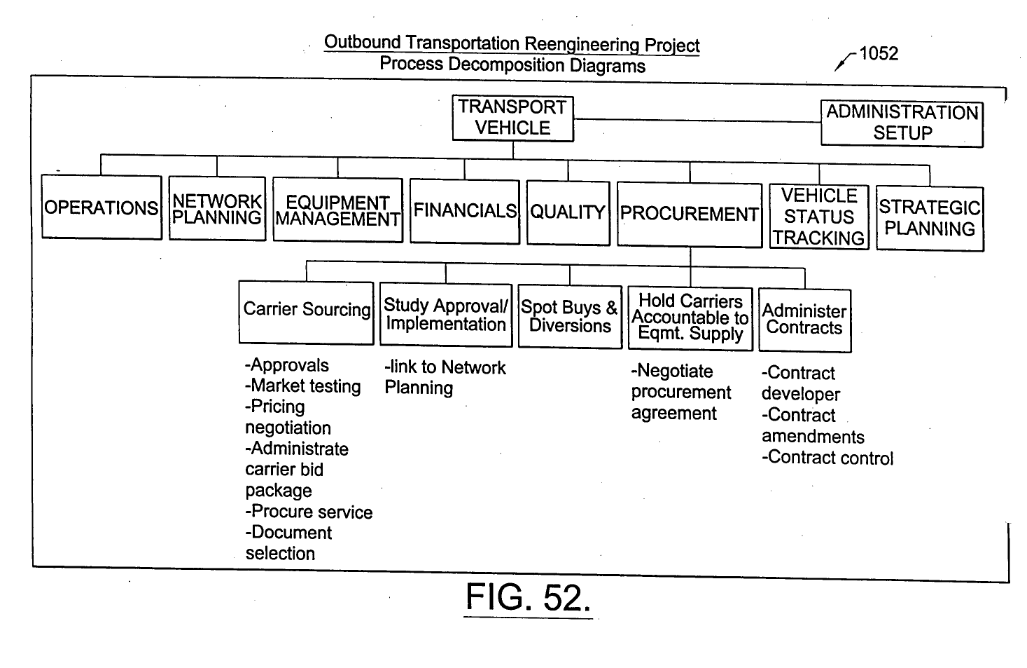

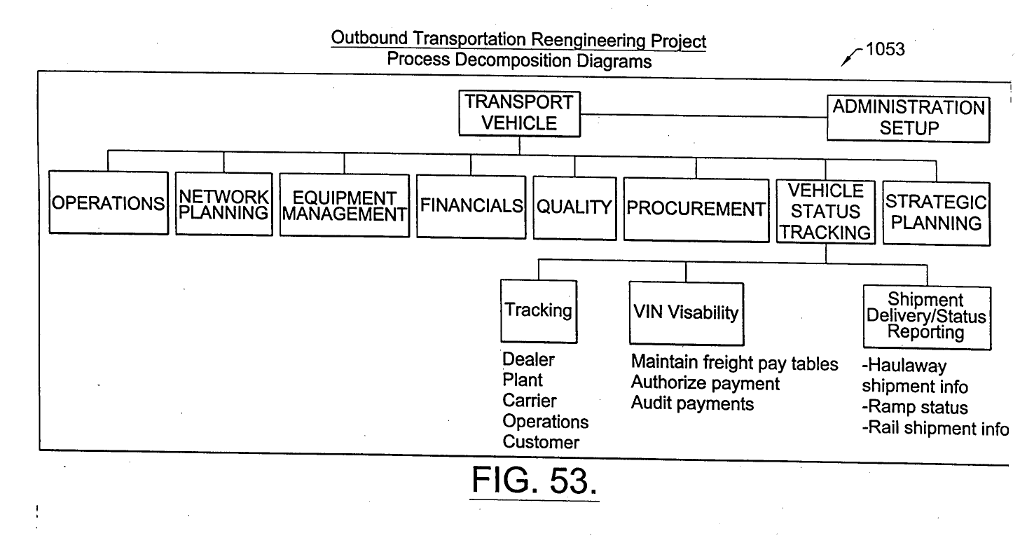

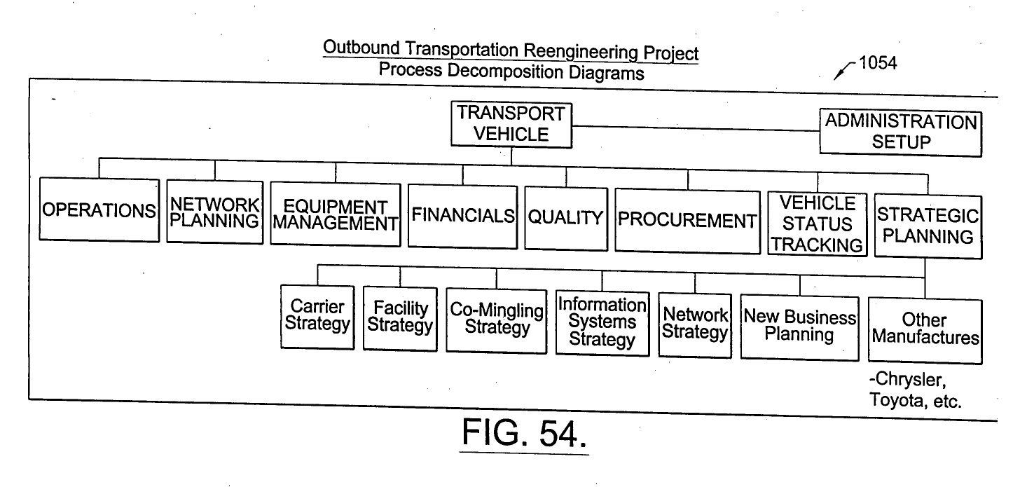

This management structure is responsible, primarily, for the reliable, safe and expeditious delivery of manufactured vehicles from all plants through a distribution network 20 to all dealerships located throughout the United States and Canada. As shown in FIG. 45, this management structure is provided by a management team 31 which consists of a pool of managers which provide on-site and remote management to a plurality of entities, providing a “management layer”. FIG. 45 is a management flow chart showing how the management team 31 provides a “management layer” over (although not necessarily directly supervising) various other entities which may not necessarily be employed by, paid, or salaried employees of the management team 31. These entities include but are not necessarily limited to manufacturer's personnel 33, vehicle loading/unloading contractors 35, car hauler personnel 37 (who operate car haulers 28), rail carrier personnel 41 (who operate trains 23), and dealers 29. It should be understood that the car hauler personnel 37 and rail carrier personnel 41 could be referenced generically herein as “carrier” personnel. It should also be understood that preferably this management is done via contact with the management structure of the above entities. However, it should be understood that the activities and results of those being managed (e.g. hourly workers) will be monitored as many of the management team will be on site. FIGS. 46-54 show other management structure diagrams.

Such a management structure is configured to provide the following in conjunction with other features of the present invention:
a) Providing a network to satisfy suitable business requirements,
b) Delivery to dealerships not to exceed a designated number of transit in any point to point lane or segment days (8 days in on embodiment),
c) Visibility of vehicles as they are transported through the network and,
d) Management of the network provided to facilitate the delivery.

The following discussion describes the plan for managing the network, as well as give an overview of an overall implementation plan, allowing for an effective assumption of those responsibilities as stated above. This incorporates training of the management team, as well as dispatch and positioning in the field, ultimately encompassing the entire North American continent.

The management structure has assumed responsibilities for managing an existing automotive distribution network 20. Under one embodiment of the present invention, the management structure consists of two main groups or functional responsibilities:
1) a Staff and Support group which includes planning, contingency, finance, customer service and relationships, and the like, and
2) an Operations group which is positioned throughout the system managing the vendors responsible for the transporting of the vehicles.

Both of these groups, while being accountable for specific portions of the distribution network 20 management, work closely together to effectively manage the distribution network 20 and improve efficiencies as the network and its management evolve. Assumption of the responsibility of the network is being achieved through a phase-in program designed to assume management of specific areas of the network with each phase *check with client re status*. As each phase is added, areas introduced in prior stages are turned over to the management people responsible for those lanes and segments. Prior to each of the five implementation phases, training workshops will be held with each of the management groups as they are added. Such training can include learning about the vehicle manufacturer, vendor management, business conduct and compliance, railroad and car hauler practices, etc.

Management Method

Before discussing the management techniques, it is first beneficial to understand the concepts and applications utilized during the design phase of the project.

In designing the network, a few basic principles of transportation management were invoked:
1) Work within the system as upstream in the process as possible.
2) Minimize handling of the units.
3) Bypass intermediate sites and facilities wherever possible.
4) Volume creates opportunity. (The larger (the train), the better).

With these principles in mind, a network was plotted after determining North American distribution of the vehicles, the purpose and position of the four mixing centers which happen to exist in the current delivery network, productive and time-definite segments and lanes, and the characteristics of the manufacturing plants: location, product type, manufacturing schedule, and facility constraints.

As a result of these determinations, rather than being treated as stand-alone origins, the plants were theoretically grouped together to create singular origin sites consisting of one, two, up to five plants (in the case of the Michigan Plants), combining their production to be introduced into the network. This concept became an enabler of the application of several of the stated principles, beginning with #4—volume creates opportunity. As the volume levels increase from the combination of multiple sites, the distribution of the production takes on new meaning, forming a larger pool from which to draw like destinations. This in turn provides for the ability to build more direct (bypass) railcars based on average load ratio's, eliminate handles, and begins with the vehicle coming off the assembly line as a finished product ready for transport—Principles 2 and 3.

Prior to actual production, a concept known as Geographic Build is applied. This planning model consists of capturing Sales data, and mathematically scheduling the production to produce level distribution of the product as it enters the network. This schedule reduces/eliminates large daily fluctuations in distribution which occur in the first stages of the network today, causing varying demands on staffing, equipment, and power. Ultimately the intent is to manage the system to the dealer level, which will produce significant production and economic gains to the car haulers 37. This process of setting the manufacturing schedule based on output requirements of the transportation of the product to market satisfies Principle #1 listed above: work as far upstream in the process as possible.

Managing the network is a direct reflection of the approach taken in designing the network. The system is managed utilizing a “Push-Pull” method of accountability and system performance.

Each origin location (grouping) is managed by the management, with on-site personnel. Their responsibility is to effectively and accurately “push” the vehicles out into the distribution network 20, using flow plans and load make-ups incorporated in the design of the network. In addition to the loading of the railcars with specific destinations, these origin management people are responsible for building the trains, in sequence. These trains are built and blocked, based upon a planned system, dependent on the destination of the train.

As this occurs, management people at the destination locations (Mixing Centers, Hubs, and Ramps) are “pulling” the vehicles through the distribution network 20. This pull effect is accomplished through continuous monitoring of the transport mode being utilized as the vehicles progress through the system.

While the vehicles are in transit, the destination management are working with the vendors responsible for final delivery. They are providing information and helping in the planning process for upcoming operations based upon what is flowing through the network, the requirements of the transportation cycle, as well as the reliability, accuracy, and performance of the network while it is being managed.

Between the origin and final destination are the existing Mixing Centers. These facilities are managed on a daily basis. This management group works using its own internal method in opposite fashion: they are in effect “pulling” trains into the Mixing Centers, and then “pushing” them back out again. The change in focus of the Mixing Centers also becomes apparent here. In the design of the network, as stated earlier, by combining plants, the opportunity to create direct rail cars and bypasses increases dramatically. This reduces the amount of mixed volume having to go into the Mixing Centers. As each origin point is implemented, the Mixing Centers evolves from predominantly an unload/reload (of mixed volume) operation, to a large majority of their activity becoming train management. This train management consists of bringing trains in, breaking, switching, and rebuilding them to create pure direct trains to ultimate and final destinations. One should keep in mind here that facilitating the building of these trains at the Mixing Centers is greatly enhanced by the origin point management directing the building and blocking of the trains prior to their departure to the Mixing Centers. The trains from each of the origin locations are integrated into single units with planned routes to destination-hubs and ramps.

Remaining volume, “mixed” volume, is handled through a coordinated effort between multiple plant sites within each grouping and the Mixing Centers. This is accomplished on a daily basis dependent upon the production schedule and destination of the VIN's. Low volume levels (<6 vehicles to a single ramp) dictate that those vehicles are moved to the Mixing Centers for loading and creating direct rail cars. Other, mid range volume levels, suggest that one Plant build a partial railcar for a particular destination, while vehicles to that destination from other plants, even within the same origin grouping, are moved to the Mixing Centers. At this time, those random vehicles would be loaded on to the partial railcar, creating a full load departing the Mixing Center.

Within the management structure, several other groups exist with varied areas of responsibility in support of the Joint Venture and/or the operators in the field:

A) Planning & Systems—Each Zone of Operation has a Planning & Systems group assigned to it. While operating independently and focusing on operations within their respective zones, they are collectively responsible for integrating the entire network into a single operating unit. Each Planning & Systems Group Manager has a Network Planning Manager and Supervisor assigned. These people are responsible for the planning of the operations, both long range and short term, as well as continuously reviewing the network and seeking ways to improve efficiencies. The basic planning model progresses through a 90-, 60-, 14-, and 5-day projection process for production scheduling and determine the system requirements on a daily basis once the vehicles are produced. Currently, 14-day projections are 95% accurate, while 5-day projections to the build order run above a 98% accuracy rate. Geographic Build (as described on Page 5) are determined by this Planning Group.

As the vehicles are released into the distribution network 20, there are two separate groups working behind the scenes. One group, reporting to the West Zone Planning & Systems Division Manager, are responsible for tracking of the vehicles as they flow through the system and monitoring performances as they relate to the Standards Metrics established for each segment and lane. As situations arise, this group is responsible for developing contingency plans to recover lost or delayed transit time while the vehicles are enroute. They communicate with the operators in the field to respond to the contingencies, and manage the required adjustments through the operators and vendors. The second group, reporting to the East Zone Planning & Systems Division Manager, is responsible for tracking and directing the positioning of empty rail equipment. This group works through the appropriate railroads and equipment managers to insure that sufficient railcars for loading are in place at each plant and mixing center.

Completing the responsibilities of the two Planning & Systems Division Managers are Customer Service, reporting to the East Zone, and Systems/IS reporting to the West Zone. The Customer Service people are responsible for maintaining relationships between the management team 31 and all of its customers, both internal and external. All questions, comments, suggestions, etc as they relate to the management team 31 flow through this group. Systems/IS consists of a Manager and two Supervisors. Their responsibilities reflect those of a Help-Desk scenario, where they are available to all users of the vehicle tracking system 34 for system-related problems or questions. Initially they will be staffed for 24-hour coverage; determinations are made as the management team 31 evolves as to the requirement of total coverage and the demands on the people in the performance of this activity. They also serve as a first-pass evaluation of new systems or development requested by management team 31 personnel. Upon their approval, established procedures for software development, hardware purchase, etc follow.

B) Finance—The Finance Group is responsible for all categories associated with expenses, revenue, and accounting for the management team 31. Initially, Freight Payment is conducted by vehicle manufacturer employees working for the management team 31. As systems are developed and merged, payment to the vendors is done electronically, eliminating the need for these people. This plan takes into consideration the eventual assumption of Contract responsibilities by the management team 31 with the vendors. As existing contracts between the vehicle manufacturer and the transportation vendors reach maturity, they are handed over to the management team 31 for negotiation and ownership of the contracts. As in the case of the Freight Payment, in a final embodiment transfer of this to an electronic system controlled by the management team 31 will be in place. Finally, the Finance group is responsible for the effective management of revenues, cost control systems, Business Planning models and completion, buildings and facilities, etc.

C) Railroad Operations, Car Hauler Operations—while constituting two separate and distinct branches within the management structure, the responsibilities of these groups run parallel to each other. Representative management people for each of the major vendors are the liaison between the management team 31 and the vendor corporations. Initial responsibilities include establishing relationships with the vendors, and assisting in the implementation of the new network from the vendor perspective. As the system grows, additional areas of responsibility will be added to this group as they involve the vendors. These responsibilities will include performance reporting and reviews, contract negotiations, business opportunities which are created, etc. This group will in no way influence the expectation that every field operator is expected to develop working relationships with each vendor appropriate to their portion of the network. The partnership approach suggested here will be critical to the success of the network in each of the lanes and segments.

Management Apparatus

The management of the manufacturer's distribution network 20 requires and incorporates several tools and systems. Perhaps the most important of these systems is the tracking system 34. This system will actually provide value and assistance to two separate entities.

The tracking system 34 is a system that provides visibility of the unit to the user. The tracking system 34 will let the inquiring person know the units' location in the pipeline, its' status compared to a planned time in transit at each stage of the transportation, provide for alerts and alarms when units fall behind schedule, and give a view of the network in progress, down to the vehicle level if desired. This has been recognized by the inventors as being critical to assuming responsibility for the manufacturer's distribution network 20. Visibility of the vehicles in transit will be a quantum leap forward towards improving delivery times.

Management Results

Performance of the network are to be reviewed on a daily basis.

Under one embodiment of the invention, daily performance reviews will be conducted with the local vendors by the local-area management people. Along with these reviews are improvement action plans and accountability discussions to satisfy the standards for each destination.

Monthly reviews are planned at a higher level. At this point in time, under one embodiment of the invention, Division and Zone Managers assume responsibility for these sessions with each carrier, at corresponding levels within their organizations. These reviews also include the appropriate Support functions and the management people designated as carrier representatives.

Critical to the success of the time in transit improvements are improvements internal to the manufacturer's organization. These changes include a re-definition of when a vehicle is considered in transit. In today's operation, the vehicle delivery time begins when the unit comes off the assembly line, although it may be placed on hold immediately; sometimes for several days. Another change necessary to accurately assess the performance of vehicle delivery is the expansion of geographic build. This procedure described earlier, based on distribution of build orders, is designed to even the flow of vehicles throughout the system, maximize the utilization of the network, and optimize cost effectiveness of both the vendors and the management team 31.

Additional improvements included flexible dealer delivery schedules, correct geographic sourcing of the production of models or product types based on their final destination, and evaluation of engineering restrictions placed on certain vehicle types for transportation securing devices.

One additional improvement is the use of training sessions and workshops for the management team.

Computer-Implemented Aspects

As will be appreciated by one of ordinary skill in the art, some aspects of the present invention may be embodied as a method, a data processing system, or a computer program product. These aspects may take the form of an entirely hardware embodiment, an entirely software embodiment or an embodiment combining software and hardware aspects. Furthermore, these aspects may take the form of a computer program product on a computer-readable storage medium having computer-readable program code means embodied in the storage medium. Any suitable computer readable storage medium may be utilized including hard disks, CD-ROMs, optical storage devices, or magnetic storage devices.

The present invention is described above with reference to block diagrams and flowchart illustrations of methods, apparatus (i.e., systems) and computer program products according to embodiments of the invention. It will be understood that in appropriate circumstances a block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, when appropriate for full or partial computer implementation, blocks of the block diagrams and flowchart illustrations support combinations of means for performing the specified functions, combinations of steps for performing the specified functions and program instruction means for performing the specified functions. It will also be understood that such blocks of the block diagrams and flowchart illustrations, and combinations of blocks in the block diagrams and flowchart illustrations, can be implemented by special purpose hardware-based computer systems which perform the specified functions or steps, or combinations of special purpose hardware and computer instructions.

### CONCLUSION

Therefore it may be understood that the present invention provides a product delivery system that can move products from manufacturing plant to destination more quickly and reliably. The invention minimizes handling of products, maximizes bypassing of intermediate sites, and moves products in larger volumes or batches. In a vehicle delivery context, these improvements translate into more direct trains, larger trains, and faster delivery from plant to dealer. The present invention provides a novel centralized management organization overseeing a number of separate parts of the network, and provides improved visibility of delivery network to the management organization, as well as improved tools for operating the network. These tools benefit from the information collected on the status of the network. The invention also provides a system that can influence the sequence in which the products are manufactured in a manner that makes operation of the delivery network more efficient.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1-16. (canceled)

17. A method of scheduling, manufacturing, and shipping items via a delivery network, comprising:
gathering a set of parts needed to make a predetermined number of items in a predetermined order;
providing a delivery network comprising a plurality of network facility points, including one or more origin points and mixing center points, and a plurality of termination points;
inserting the items as they are made into the delivery network;
monitoring activity at the network facility points;
projecting relative congestion along a plurality of routes through the delivery network based on the monitored activity in the network and the destinations of the items to be made; and
responsive to the projected relative congestion in the delivery network, altering one or both of the gathered set of parts and the predetermined order of making the items, so as to cause the items to enter the delivery network in an order calculated to improve efficiency of delivery.

18. The method of claim 17, wherein altering one or both of the gathered set of parts and the predetermined order of making the items includes ordering production from the assembled set of parts of items going to the same termination point in sequential order.

19-32. (canceled)

33. A method of transporting items from a plurality of manufacturing plants to a plurality of destination locations via a delivery network, said method comprising the steps of:
A) establishing a relationship with a plurality of independent entities, said plurality of independent entities providing a continuous delivery network from said manufacturing plants to said destination locations;
B) providing at least partial management of each of said entities by the use of on-site delivery network managers having a primary allegiance to a delivery network management company;
C) providing a delivery information network for use by said delivery network managers, said delivery information network comprising:
(1) one or more databases, including:
(a) in transit information describing a location and status of items in the delivery network being delivered from the entry point to a destination location;
(b) network facility information including identification and capacity of a plurality of network facility points, including entry points, intermediate sortation points, termination points, and customer facility points;
(c) carrier information describing capacity, location and status of network transport devices and transport operators;
(d) route information describing transportation routes within the delivery network, capacity of the routes, and cost of delivery of items along the routes;
(e) a delivery Plan including routes for items and planned times for shipment and delivery of items to points along routes; and
(f) measured transit time information including actual times taken for movement of items between points in the network; and
(2) a plurality of access units, the access units being configured to access the one or more databases from a plurality of the network facility points along a route; and being configured to download from one or more of the databases information useful in carrying out a delivery plan implemented via the delivery network;
D) providing said delivery network managers with access to information via said access units; and
E) in response to said information provided in step “D”, directing activities of said plurality of independent entities to facilitate delivery of said items from said manufacturing plants, along said continuous delivery network, and to said destination locations, each of said entities receiving direction regarding at least one of the following activities:
(1) setting staffing levels;
(2) setting work hours;
(3) setting resource levels and allocation of resources;
(4) setting exception handling procedures; or
(5) adjusting tasks in response to measured in transit status, measured transit times, changes in capacity or status of network resources.

34. The method of transporting items as claimed in claim 33, further comprising:
F) providing said delivery network managers with the capability to transfer information to said delivery information network via said access units.

35. The method of transporting vehicles items as claimed in claim 33, further comprising the step of modeling said delivery network and providing delivery plans to said delivery information network.

36. The method of transporting items as claimed in claim 33, wherein step A includes the establishment of a relationship with an item manufacturer, and wherein said step of providing management comprises managing the management of said item manufacturer.

37. The method of transporting items as claimed in claim 33, wherein step A includes the establishment of a relationship with a carrier, and wherein said step of providing management comprises managing the management of said carrier.

38. The method of transporting items as claimed in claim 33, wherein step A includes the establishment of a relationship with a load contractor, and wherein said step of providing management comprises managing the management of said load contractor.

39. The method of transporting items as claimed in claim 33, wherein step A includes the establishment of a relationship with an item retailer, and wherein said step of providing management comprises managing the management of said item retailer.

40. The method of transporting items as claimed in claim 33, wherein said on-site delivery network managers alter said delivery plan in said data information network based at least in part on information accessed in said Step D.

41. The method of transporting items as claimed in claim 33, wherein said Step B of providing at least partial management comprises having said on-site delivery network managers develop alternative delivery plans for said items in anticipation of known bottlenecks.

42. The method of transporting items as claimed in claim 33, wherein said Step B of providing at least partial management comprises having said on-site delivery network managers hire labor in response to said information accessed by said delivery network managers in said Step D.

43. The method of transporting items as claimed in claim 33, wherein said Step B of providing at least partial management comprises having said delivery network managers rent space in response to said information accessed by said delivery network managers in said Step D.

44. The method of transporting items as claimed in claim 33, wherein said Step B of providing at least partial management comprises having said delivery network managers rent equipment in response to said information accessed by said delivery network managers in said Step D.

45. The method of transporting items as claimed in claim 34, wherein said Step F comprises providing said delivery network managers with the ability to place at least one item on hold by transferring information to said delivery information network.

46. The method of transporting items as claimed in claim 34, wherein said Step F comprises providing said delivery network managers with the ability to update an item's status by transferring information to said delivery information network.
